(19) United States
(12) Patent Application Publication
(10) Pub. No.: US 2026/0062434 A1
(43) Pub. Date: Mar. 5, 2026

(54) METALLOCENE COMPOUND, A CATALYST, AN ELECTRON MEDIATOR, AN ELECTROLYTE FOR A REDOX FLOW BATTERY, A MEDICAMENT AND A METHOD FOR PRODUCING THE METALLOCENE COMPOUND

(71) Applicant: OKINAWA INSTITUTE OF SCIENCE AND TECHNOLOGY SCHOOL CORPORATION, Kunigami-gun (JP)

(72) Inventor: Satoshi TAKEBAYASHI, Kunigami-gun (JP)

(73) Assignee: OKINAWA INSTITUTE OF SCIENCE AND TECHNOLOGY SCHOOL CORPORATION, Kunigami-gun (JP)

(21) Appl. No.: 19/315,299

(22) Filed: Aug. 29, 2025

Related U.S. Application Data
(60) Provisional application No. 63/689,799, filed on Sep. 2, 2024.

(51) Int. Cl. C07F 17/02; C25B 1/04; C25B 11/085; H01M 8/18

(52) U.S. Cl. CPC C07F 17/02; C25B 11/085; H01M 8/188; C25B 1/04

(57) ABSTRACT

Provided is a new metallocene compound with a formal electron count of 20 to 22. The metallocene compound may be represented by formula (1). This application also provides methods for producing the compound, which can be used, amongst other things, as a catalyst, an electron mediator, or as an electrolyte in a redox flow battery. The unique electronic structure of these compounds provides for novel and highly tunable redox properties.

### CROSS-REFERENCE TO RELATED APPLICATIONS

This application claims the benefit of U.S. Provisional Application No. 63/689,799, filed on Sep. 2, 2024, the disclosure of which is incorporated herein by reference in its entirety.

### TECHNICAL FIELD

The present disclosure relates to a metallocene compound, a catalyst, an electron mediator an electrolyte for a redox flow battery, a medicament and a method for producing the metallocene compound.

### BACKGROUND

Since the discovery of ferrocene in the 1950s, various derivatives of metallocenes have been synthesized and have played pivotal roles in important discoveries in a variety of fields, including catalysis, materials, energy, and medical sciences. The versatility of metallocenes stems from the ability of the cyclopentadienyl ligand (Cp) and its derivatives to stabilize metals with a wide range of valence electron counts. To date, d-block metallocenes and their derivatives with a formal electron count in the range from 14 to 20, including recently synthesized 16-electron ferrocene dication (NPL 1) and 20-electron cobaltocene anion (NPL 2), have been isolated.

A possible formal 21-electron manganocene derivative, MnCp₂(dmpe) [dmpe: 1,2-bis(di-methylphosphino)ethane](NPL 3) has been reported.

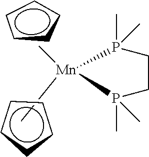

However, the formation of this complex does not follow the expected trend of other metallocenes. Furthermore, as with other manganocene complexes, the coordination mode of the Cp ligands in this complex deviates from the ideal η⁵-coordination because of ring slippage. This anomalous behavior of manganocene complexes is attributed to the primarily electrostatic character of the Mn—C(Cp) interactions, and the observed coordination modes are mainly controlled by the steric factor of the ligands. The solid-state zigzag chain structure of MnCp₂ is a vivid example of the anomalous coordination chemistry of manganocene complexes. Therefore, according to the available literature data, the formal electron count of MnCp₂(dmpe) cannot be conclusively described.

The electrochemical reduction of NiCp₂ has been reported and the formation of formal 21-electron NiCp₂-based on cyclic voltammetry (CV) has been proposed (NPL 4). However, since this complex is thermally unstable and cannot be isolated, the possibilities for its characterization are limited.

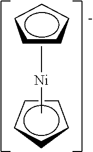

The 18-electron rule works best for the complexes with strong R-accepting ligands (NPL 5). The existence of formal 14- to 20-electron metallocenes clearly shows that the 18-electron rule is only loosely applicable to metallocene complexes, especially paramagnetic ones. Furthermore, it is worth nothing to point out that a bonding model based on sdn hybridization and 3c-4e hypervalent bonding indicates the possible formation of formal 21-electron metallocene derivatives by exploiting weaker attractive interactions such as higher multicenter donoracceptor interactions, long-range electrostatics, London dispersion, and/or entropically favorable interstitial vacancies.

Nevertheless, the isolation of well-defined d-block metallocenes or their derivatives with more than a formal 20-electron count has remained elusive. The difficulty in synthesizing formal 20 to 22-electron complexes lies in the fact that increasing deviation from the stable 18-electron configuration destabilizes metal-C(Cp) interactions and promotes the change of hapticity of Cp ligands (NPL 6) or decomposition of the complexes (NPL 4).

### CITATION LIST

### Non-Patent Literature

NPL 1: Malischewski, M., Adelhardt, M., Sutter, J., Meyer, K. & Seppelt, K. Isolation and structural and electronic characterization of salts of the decamethylferrocene dication. Science 353, 678-682, doi:10.1126/science.aaf6362 (2016).
NPL 2: Goodwin, C. A. P. et al. Isolation and electronic structures of derivatized manganocene, ferrocene and cobaltocene anions. Nat. Chem. 13, 243-248, doi:10.1038/s41557-020-00595-w (2021).
NPL 3: Howard, C. G., Girolami, G. S., Wilkinson, G., Thornton-Pett, M. & Hursthouse, M. B. Tertiary phosphine adducts of manganese(II) dicyclopentadienide. Magnetic studies and structural characterization of tilted cyclopentadienyl rings. J. Am. Chem. Soc. 106, 2033-2040, doi:10.1021/ja00319a022 (1984).
NPL 4: Bard, A. J., Garcia, E., Kukharenko, S. & Strelets, V. V. Electrochemistry of metallocenes at very negative and very positive potentials. Electrogeneration of 17-electron Cp₂Co²⁺, 21-electron Cp₂Co²—, and 22-electron Cp₂Ni²⁻ species. Inorg. Chem. 32, 3528-3531, doi:10.1021/ic00068a024 (1993).
NPL 5: Rasmussen, S. C. The 18-electron rule and electron counting in transition metal compounds: theory and application. ChemTexts 1, 10, doi:10.1007/s40828-015-0010-4 (2015).
NPL 6: O'Connor, J. M. & Casey, C. P. Ring-slippage chemistry of transition metal cyclopentadienyl and indenyl complexes. Chem. Rev. 87, 307-318, doi:10.1021/cr00078a002 (1987).

### SUMMARY

### Technical Problem

There is a need to develop metallocene compounds with a formal electron count of 20 to 22.

One object of the application is to provide a new metallocene compound with a formal electron count of 20 to 22, in particular, a new cobaltocene compound with a formal electron count of 21, as well as a new ferrocene compound with a formal electron count of 20.

### Solution to Problem

As a result of intensive study, the present inventor has found a new metallocene compound with a formal electron count of 20 to 22 and its production method.

The gist of certain implementations of the application is as follows:

[1] A metallocene compound represented by formula (1):

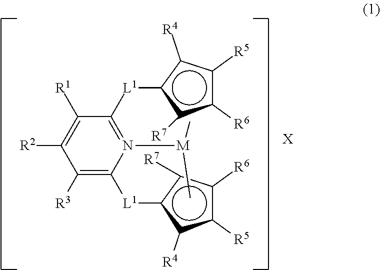

wherein,
R¹ to R⁷ are independently selected from a hydrogen atom, a halogen atom, a hydrocarbon group, and a heteroatom-containing group,
or any one of R⁴ to R⁷ attached to one of the two cyclopentadienyl rings and any one of R⁴ to R⁷ attached to the other cyclopentadienyl ring may together form a linking group, or any adjacent two of R⁴ to R⁷ may form a ring together with the carbon atoms to which they are attached;
L¹ is a linking group;
M is selected from Co, Ni, and Fe; and
X is not present when M has an oxidation state of 2, and
X is a counter anion when M has an oxidation state of 3 or 4.
   [2] The metallocene compound according to [1] represented by formula (1-1):

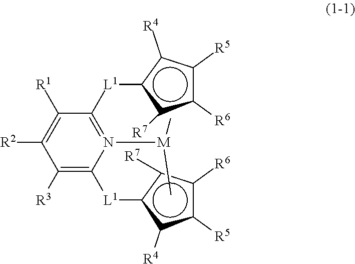

wherein,
R¹ to R⁷, L¹, and M are as defined in claim 1, and
M has an oxidation state of 2.
   [3] The metallocene compound according to [1] represented by formula (1-2):

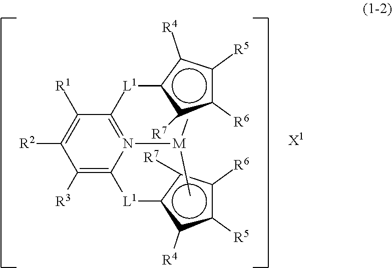

wherein
R¹ to R⁷, L¹, and M are as defined in claim 1,
M has an oxidation state of 3,
and X¹ is An₁⁻ or ½An₂²⁻, wherein An₁⁻ is a monovalent anion and An₂²⁻ is a divalent anion,
   [4] The metallocene compound according to [1] represented by formula (1-3):

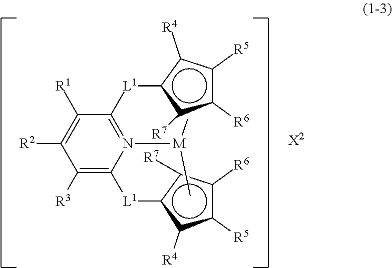

wherein,
R¹ to R⁷, L¹, and M are as defined in claim 1,
M has an oxidation state of 4,
and X² is 2An₁⁻ or An₂²⁻, wherein An₁⁻ is a monovalent anion and An₂²⁻ is a divalent anion.
   [5] The metallocene compound according to any one of [1] to [4],
wherein each of R¹ and R³ is a hydrogen atom; and
R² is selected from a hydrogen atom, a halogen atom, a hydrocarbon group, and a heteroatom-containing group.
   [6] The metallocene compound according to [1] to [5],
wherein each of R⁴, R⁶, and R⁷ is hydrogen atom; and
R⁵ is independently selected from a hydrogen atom, a halogen atom, a hydrocarbon group, and a heteroatom-containing group.
   [7] The metallocene compound according to [1] to [6],
wherein each of R¹ to R⁷ is a hydrogen atom.
   [8] A catalyst comprising the metallocene compound according to [1] to [7].
   [9] An electron mediator comprising the metallocene compound according to [1] to [6].
   [10] An electrolyte for a redox flow battery comprising the metallocene compound according to [1] to [6].
   [11] A medicament comprising the metallocene compound according to [1] to [6] as an active ingredient.
   [12] A method for producing a metallocene compound comprising reacting a compound represented by formula (2) with a cyclopentadienyl salt represented by formula (3) to obtain a compound represented by formula (4), and then reacting the compound represented by formula (4) with a compound represented by formula (5) to obtain the metallocene compound represented by formula (1) as recited in claim 1, and wherein

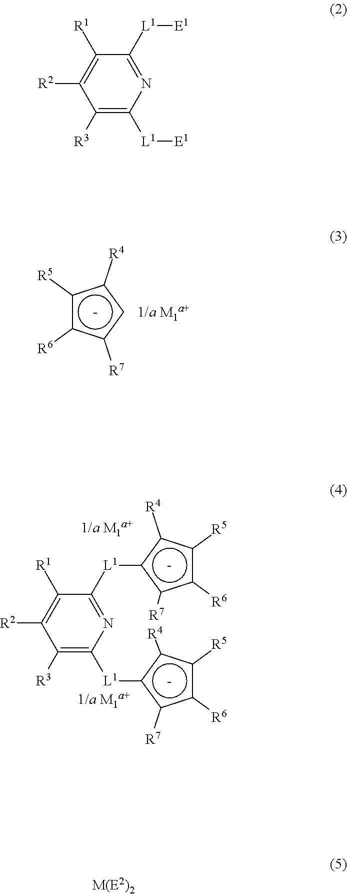

R¹ to R⁷ are independently selected from a hydrogen atom, a halogen atom, a hydrocarbon group, and a heteroatom-containing group;
M is selected from Co, Ni, and Fe;
E¹ is a leaving group;
M₁ is an alkaline metal or alkaline earth metal;
a is 1 when M₁ is an alkali metal, and 2 when M₁ is an alkaline earth metal; and
E² is a leaving group.
   [13] A metallocene compound represented by formula (1′):

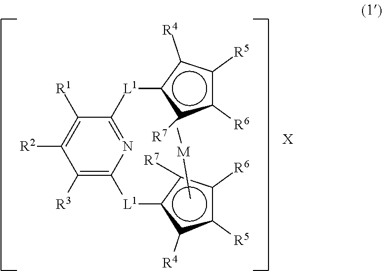

wherein,
R¹ to R⁷ are independently selected from a hydrogen atom, a halogen atom, a hydrocarbon group, and a heteroatom-containing group, or any one of R⁴ to R⁷ attached to one of the two cyclopentadienyl rings and any one of R⁴ to R⁷ attached to the other cyclopentadienyl ring may together form a linking group;
L¹ is a linking group;
M is selected from Co, Ni, and Fe; and
X is not present when M has an oxidation state of 2, and
X is a counter anion when M has an oxidation state of 3 or 4.

### Advantageous Effects

This disclosure provides a new class of metallocene compounds that successfully achieve a formal electron count of 20 to 22, a range that has historically been highly unstable and difficult to isolate. A primary advantage of these compounds is their unexpected stability and unique, tunable redox properties, which overcome significant limitations of conventional 18-electron metallocenes. Specifically, the iron-based embodiments of this application can exhibit an unprecedented, stable, and reversible two-electron oxidation capability, allowing access to Fe(III) and Fe(IV) states at exceptionally low potentials. This is a substantial improvement over standard ferrocene derivatives, where oxidation to the Fe(IV) state is typically hindered by prohibitively high potentials. This novel electrochemical behavior expands the utility of ferrocene chemistry, making these compounds highly effective for a wide range of advanced applications, including as superior catalysts, next-generation electron mediators, and high-performance electrolytes for redox flow batteries.

### BRIEF DESCRIPTION OF THE DRAWINGS

In the accompanying drawings:

FIG. 1: an idea for an electrocatalyst.

FIG. 2: an idea for a medicine

FIG. 3: an idea for a redox flow battery

FIG. 4: an idea for a solar cell.

FIG. 5: ¹H NMR spectrum (400.15 MHz, C₆D₆, 298 K) of 1.

FIG. 6: Proton coupled ¹³C NMR spectrum (125.76 MHz, C₆D₆, 298 K) of 1.

FIG. 7: ¹H-¹H COSY NMR spectrum (400.13 MHz, C₆D₆, 298 K) of 1.

FIG. 8: ¹H-¹³C HSQC NMR spectrum (C₆D₆, 298 K) of 1.

FIG. 9: FTIR spectrum (thin film) of 1.

FIG. 10: Preparation of 21-electron metallocene derivatives.
a Selected examples of metallocenes and their applications.
b Previously proposed 21-electron metallocene derivatives.
c Synthetic route to the 21-electron cobaltocene derivative, complex 1. THF: tetrahydrofuran.
d Oak Ridge Thermal Ellipsoid Plot (ORTEP) of 1 at the 80% probability level according to high-resolution single-crystal X-ray diffraction (SC-XRD). Green ellipsoids: hydrogen atoms. e Comparison of M-Cnt(Cp), Δ, and Ψ values. M: metal. DFT: density functional theory. dmpe: 1,2-bis(dimethyl-phosphino)ethane. Cp: cyclopentadienyl.

FIG. 11: Characterization of complex 1.
a ¹H NMR (400.15 MHz, 298 K, in C₆D₆) spectrum of 1 and signal assignments (a-e). *: signals from residual THF. #: a signal from residual C₆D₅H.
b Experimental (4.2 K, toluene glass) and simulated X-band EPR spectra of 1 using fictitious S=½. g: effective g-values. A(⁵⁹Co): ⁵⁹Co hyperfine coupling constants.
c Four-pulse HYSCORE spectrum of 1 observed at 320 mT (4 K, toluene-d₈ glass). d CV of 1 and cobaltocene recorded with a glassy carbon electrode (3 mm diameter) from −1.6 to −1 V range with a scan rate of 0.01 V s⁻¹, in 0.1 M [Bu₄N]PF₆ THF at 25° C., and reported vs. FeCp₂^{+/0}. The starting point (open circuit potential) and direction of scans are indicated by arrows.

FIG. 12: Quantum chemical topology of 1. Experimental maps based on SC-XRD data (left) and theoretical maps based on gas-phase DFT calculations (right) are compared. Map planes pass through the atoms Co1, N1, and C2.
a Contour maps of ∇²ρ(r).
b Superposition of the zero-flux boundaries of ρ-basins and yes-basins in the gradient vector fields ∇ρ(r) and ∇φes(r).

FIG. 13: ¹H NMR spectrum (500.13 MHz, CD₃CN, 298 K) of 3.

FIG. 14: ¹³C{¹H} NMR spectrum (125.76 MHz, CD₃CN, 298 K) of 3.

FIG. 15: ¹H-¹⁵N HMBC NMR spectrum (CD₃CN, 298 K) of 3.

FIG. 16: ¹⁹F NMR spectrum (376.52 MHz, CD₃CN, 298 K) of 3.

FIG. 17: ¹¹B NMR spectrum (128.38 MHz, CD₃CN, 298 K) of 3.

FIG. 18: FTIR spectrum (thin film) of 3.

FIG. 19: Variable temperature ¹H NMR spectra (500.13 MHz, CD₃CN) of 3.

FIG. 20: Comparison of MO diagram of cobaltocene, 1′, and 1. Inset: canonical KSQROs (isovalues at 0.05-0.13 a.u.), white lobes: positive phases, black lobes: negative phases.
LUMO: lowest unoccupied molecular orbital. SOMO: singly occupied molecular orbital.
SOMO-1: a molecular orbital at one energy level below SOMO.
SOMO-7: a molecular orbital at seven energy level below SOMO1.
npy: nitrogen lone pair electrons.

FIG. 21: ¹H NMR spectra (Toluene-d₈, 500.13 MHz) of 1-H. (a) At 233 K. (b) At 423 K, under 5 bar N₂.

FIG. 22: Variable temperature ¹H NMR spectra (Toluene-d₈, 500.13 MHz, 233 to 423 K) of 1-H.

FIG. 23: ¹³C{¹H} NMR spectrum (Toluene-d₈, 125.76 MHz, 233 K) of 1-H.

FIG. 24: ¹H-¹⁵N HMBC NMR spectrum (Toluene-d₈, 500.13 MHz, 233 K) of 1-H.

FIG. 25: FTIR spectrum (thin film) of 1-H.

FIG. 26: XT vs. T plot based on VSM measurement of a bulk solid of 1-H at 2-300 K under 1000 Oe.

FIG. 27: UV-Vis spectra (0.1 mM in THF, 295 K) of an equilibrium mixture of 1-X and 2-X.

FIG. 28: Synthesis and SC-XRD structures of complex 1-X and 2-X.
a Synthetic route to complexes 1-X and 2-X (X=H, Cl, OMe, and NMe₂). Me: methyl.
b X-ray molecular structure of 1-H with thermal ellipsoids at the 60% probability level; plain circles represent hydrogen atoms.
c X-ray molecular structure of 2-NMe₂ with thermal ellipsoids at the 60% probability level.
d Geometrical definition of Cp ring slip parameters Δ and ψ with respect to the Cp ring centroid (Cpc).

FIG. 29: Characterization of 1-X and 2-X.
a ⁵⁷Fe Mossbauer spectrum of 1-H recorded at 77 K.
b ⁵⁷Fe Mossbauer spectrum of 2-NMe₂ recorded at 77 K.
c Fitting parameters for the ⁵⁷Fe Mossbauer spectra of 1-X and 2-X at 77 K and ferrocene (FeCp₂) at 90 K35.
d ¹H NMR spectra (500.13 MHz, −40° C.) of an equilibrium mixture of 1-NMe₂ and 2-NMe₂ in toluene-d₈, as well as corresponding signal assignments (a-e and a′-e′). Two separate spectra recorded between 380 ppm to −20 ppm and between 20 ppm to −380 ppm were combined to show the entire region with accurate baseline corrections and integration values. s: Residual solvent signals from toluene-d₈.

FIG. 30: Comparison of MO diagrams of ferrocene (FeCp₂), 1-NMe₂, and 2-NMₑ₂.

The calculations were carried out at the TPSSh-D4/def2-QZVPP/TPSS-D4/def2-TZVPP level of theory. Inset: canonical KS-MOs (isovalues are at 0.05-0.07 a.u.),
white lobes: positive phases, and black lobes: negative phases. For a detailed MO diagram and KS-MOs, HOMO highest occupied MO, LUMO lowest unoccupied MO, SOMO singly occupied MO, SOMO1-6 an MO at six energy levels below SOMO1, npy nitrogen lone pair.

FIG. 31: Quantum chemical topology of 1-NMe₂ and 2-NMe₂. Superpositions of the zero-flux surfaces determined in Fes(r) (U), Fk(r) (P), and ∇ρ(r) (S) for a 1-NMe₂ and b 2-NMe₂, based on theoretical data.

Contour maps of ∇2ρ(r) for c 1-NMe₂ and d 2-NMe₂ are depicted using a logarithmic scale of ±1×10n, ±2×10n, ±4×10n, and ±8×10n a.u. (−2≤n≤3). The distance between adjacent axis tick marks is 1 angstrom.

FIG. 32: (a)¹H NMR (CD₃CN, 400.15 MHz, 298 K) and (b) X-band EPR (toluene/acetone glass, 77 K) spectra of 3-NMe₂.

FIG. 33: NMR spectra (CD₃NO₂, 298 K) of 4-NMe₂. (a) ¹H NMR (500.13 MHz). (b) ¹³C{¹H} NMR (125.76 MHz).

FIG. 34: Electrochemical studies.
a CVs (vs FeCp₂^{0/+}) of 2.5 mM equilibrium mixtures of 1-X and 2-X in 0.2 M NBu₄PF⁶ in THF at 23° C., recorded at a scan rate of 0.1 V s⁻¹.
b A list of the half-wave potentials; †values obtained in SO₂ at −40° C. FeCp₂: ferrocene, FeCp*₂: decamethylferrocene.
c Schematic representation of the chemical oxidation of 1-X and 2-X.
d X-band EPR spectrum of 3-Cl, recorded in a 1:1 toluene/acetone glass at 77 K. g: effective g-values, A(¹⁴N): ¹⁴N hyperfine splitting constants.
e X-ray structure of 4-H with thermal ellipsoids at the 60% probability level; plain circles represent hydrogen atoms.

### DETAILED DESCRIPTION

The presently disclosed techniques will be described in detail below.

### <A Metallocene Compound>

Certain implementations of this application relate to a metallocene compound represented by formula (1):

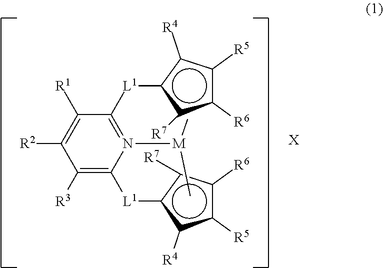

wherein,
R¹ to R⁷ are independently selected from a hydrogen atom, a halogen atom, a hydrocarbon group, and a heteroatom-containing group,
or any one of R⁴ to R⁷ attached to one of the two cyclopentadienyl rings and any one of R⁴ to R⁷ attached to the other cyclopentadienyl ring may together form a linking group,
or any adjacent two of R⁴ to R⁷ may form a ring together with the carbon atoms to which they are attached.
L¹ is a linking group;
M is selected from Co, Ni, and Fe; and
X is not present when M has an oxidation state of 2, and
X is a counter anion when M has an oxidation state of 3 or 4.

In the formula (1), R¹ to R⁷ are independently selected from a hydrogen atom, a halogen atom, a hydrocarbon group, and a heteroatom-containing group. Any one of R⁴ to R⁷ attached to one of the two cyclopentadienyl rings and any one of R⁴ to R⁷ attached to the other cyclopentadienyl ring may together form a linking group. Any two of R⁴ to R⁷ may form a ring together with the carbon atoms to which they are attached.

As to R¹ to R⁷, a halogen atom includes a fluorine atom, a chlorine atom, a bromine atom and an iodine atom, and preferably, a chlorine atom.

As to R¹ to R⁷, a hydrocarbon group is not particularly limited, and may, for example, be an aliphatic hydrocarbon group or an aromatic hydrocarbon group.

The aliphatic hydrocarbon group may include an alkyl group, an alkenyl group, and an alkynyl group. The alkyl group may be linear, branched, or cyclic and the number of carbon atoms may be 1 to 20, preferably 1 to 10, and more preferably 1 to 6. Examples of the alkyl group include methyl, ethyl, n-propyl, isopropyl, n-butyl, sec-butyl, tert-butyl, n-pentyl, sec-pentyl, tert-pentyl, neopentyl, amyl, hexyl, heptyl, octyl, nonyl, decyl, undecyl, dodecyl, cyclopentyl, cyclohexyl, etc. The alkyl group may be substituted. Examples of the alkyl group with a substituent include the alkyl group substituted with an aryl group such as benzyl.

The alkenyl group may be linear, branched or cyclic, and the number of carbon atoms may be 2 to 20, preferably 1 to 10, and more preferably 1 to 6. Examples of the alkenyl group include vinyl, allyl, butenyl, etc. The alkenyl group may be substituted, for example, by an aryl group.

The alkynyl group may be linear, branched or cyclic, and the number of carbon atoms may be 2 to 20, preferably 1 to 10, and more preferably 1 to 6. Examples of the alkynyl group include ethynyl, propargyl, butynyl, etc. The alkynyl group may be substituted, for example, by an aryl group.

Of these, methyl, ethyl, isopropyl, tert-butyl, vinyl, ethynyl, allyl are preferred.

The aromatic hydrocarbon group includes an aryl group. The number of carbon atoms may be 6 to 20, and preferably 6 to 10. Examples of the aryl group include phenyl, tolyl, naphthyl, biphenyl, phenanthryl, mesityl, etc. Of these, phenyl, tolyl are preferred.

As to R¹ to R⁷, a heteroatom-containing group is a group that may contain one or more heteroatoms. The heteroatom-containing group may be composed of a heteroatom(s) and at least one of a carbon atom and a hydrogen atom, or may be composed of only of heteroatoms.

The heteroatom is not particularly limited, and examples of the heteroatom include a nitrogen atom, an oxygen atom, a sulfur atom, a halogen atom, a phosphorous atom, and preferably a nitrogen atom, an oxygen atom. In case the heteroatom-containing group contains two or more heteroatoms, they may be the same or different.

Examples of the heteroatom-containing group include a hydroxy group, an alkoxy group, an aryloxy group, an unsubstituted or substituted amino group, a heteroaryl group.

The alkoxy group may be a group expressed as an alkyl-O—, and the description of the alkyl group above applies to the alkyl moiety. Examples of the alkoxy group include methoxy, ethoxy, propoxy, isopropoxy, n-butoxy, sec-butoxy, tert-butoxy, etc. Of these, and methoxy, ethoxy, isopropoxy are preferred.

The aryloxy group may be a group expressed as an aryl-O—, and the description of the aryl group above applies to the aryl moiety. Examples of the aryloxy group include phenoxy, naphthoxy, etc. Of these, phenoxy, napthoxy are preferred.

The unsubstituted or substituted amino group includes a group expressed as —NR^{a}R^{b}, wherein R^{a} and R^{b} are independently selected from a hydrogen atom, an alkyl group, an aryl group. The description of the alkyl group and the aryl group above apply to the alkyl moiety and the aryl moiety. Examples of the unsubstituted or substituted amino group include an unsubstituted amino (—NH₂), a dimethylamino (—NMe₂), pyrrolidinyl, diphenyl amino (—NPh₂). Of these a dimethylamino (—NMe₂), is preferred.

The heteroaryl group is a monovalent aromatic heterocyclic group, and the number of ring atoms may be 4 to 10. Examples of the heteroaryl group include pyridinyl, furanyl, thiophenyl, pyrrolyl, carbazolyl, acridinyl, etc.

In the metallocene compound represented by the formula (1), any one of R⁴ to R⁷ attached to one of the two cyclopentadienyl rings and any one of R⁴ to R⁷ attached to the other cyclopentadienyl ring may together form a linking group.

In the metallocene compound represented by the formula (1), any adjacent two of R⁴ to R⁷ may form a ring together with the carbon atoms to which they are attached. The ring formed may have ring member atoms of 5 to 20, preferably 6 to 10. Examples of the ring include benzene, etc.

In the metallocene compound represented by the formula (1), preferably, each of R¹ and R³ is a hydrogen atom, and R² is selected from a hydrogen atom, a halogen atom, a hydrocarbon group, and a heteroatom-containing group.

In the metallocene compound represented by the formula (1), preferably, each of R⁴, R⁶, and R⁷ is a hydrogen atom; and R⁵ is independently selected from a hydrogen atom, a halogen atom, a hydrocarbon group, and a heteroatom-containing group.

The metallocene compound represented by the formula (1), wherein each of R¹ to R⁷ is a hydrogen atom, is preferred.

The metallocene compound represented by the formula (1), wherein each of R¹, R³ to R⁷ is a hydrogen atom, and R² is selected from a halogen atom, a hydrocarbon group, and a heteroatom-containing group, is preferred.

In the formula (1), L¹ is a linking group. Examples of the linking group include an unsubstituted or substituted methylene group, an ether group (—O—), a thioether group (—S—), unsubstituted or substituted amino group (for example, —NR^{c}—, wherein R^{c} is hydrogen, an alkyl group, or an aryl group), etc.

The unsubstituted or substituted methylene group includes a group expressed as —CR^{d}R^{e}—, wherein R^{d} and R^{e} are independently selected from a hydrogen atom, an alkyl group, an aryl group. The description of the alkyl group and the aryl group above apply to the alkyl moiety and the alkyl moiety. Examples of the unsubstituted or substituted methylene group include an unsubstituted methylene (—CH₂—), —CH(CH₃)—, —C(CH₃)₂—.

The metallocene compound represented by the formula (1), wherein L¹ is an unsubstituted methylene (—CH₂—), is preferred.

In the formula (1), M is selected from Co, Ni, and Fe. M may have an oxidation state of 2 to 4. X is not present when M has an oxidation state of 2, and X is a counter anion when M has an oxidation state of 3 or 4.

In the formula (1), X is not present when M has an oxidation state of 2. Such a metallocene compound may be represented by the formula (1-1):

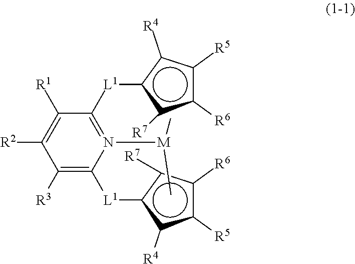

wherein,
R¹ to R⁷, L¹, and M are as defined in formula (1), and preferences are the same as in formula (1).

Examples of the metallocene compound represented by the formula (1) include the compound represented by the following formula:

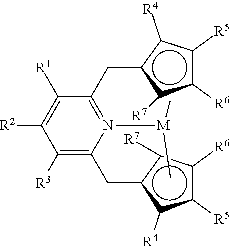

wherein,
R¹ to R⁷, and M are as defined in formula (1), and preferences are the same as in formula (1).

The metallocene compound represented by the following formulae may be mentioned.

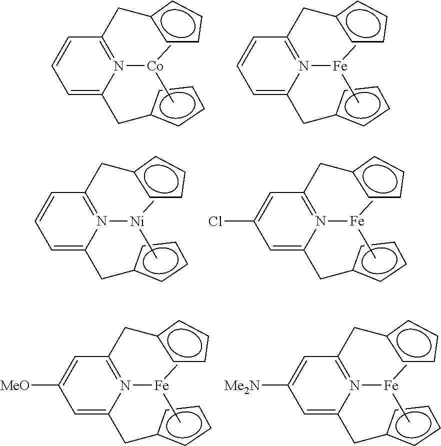

In the formula (1), X is a counter anion when M has an oxidation state of 3. Such a metallocene compound may be represented by the formula (1-2):

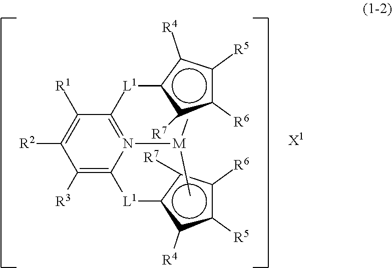

wherein,
R¹ to R⁷, L¹, and M are as defined in formula (1), and preferences are the same as in formula (1), and
X¹ is An₁⁻ or ½An₂²⁻, wherein An₁⁻ is a monovalent anion and An₂²⁻ is a divalent anion.

In the formula (1-2), X¹ is An₁⁻ or ½An₂²⁻, wherein An₁⁻ is a monovalent anion and An₂²⁻ is a divalent anion.

Examples of An₁⁻ include a monovalent anion such as halide ion (F⁻, Cl⁻, Br⁻, I⁻), NO₃⁻, SbF₆⁻, PF₆⁻, BF₄⁻, B(C₆F₅)₄⁻, HO⁻, CH₃O⁻, CH₃COO⁻, CF₃COO⁻, CF₃SO₃⁻, (CF₃SO₂)₂N⁻.

Examples of An₂²⁻ include a divalent anion such as SO₄²⁻, SO₃²⁻, CO₃²⁻, FeCl₄²⁻.

Of these, SbF₆⁻ and PF₆⁻ are preferred in terms of stability.

The metallocene compound represented by the following formulae may be mentioned.

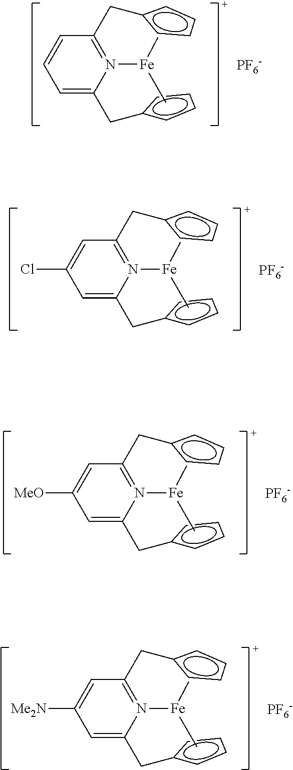

In the formula (1), X is a counter anion when M has an oxidation state of 4. Such a metallocene compound may be represented by the formula (1-3):

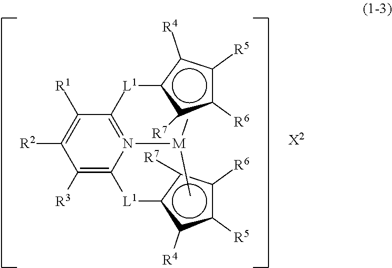

wherein,
R¹ to R⁷, L¹, and M are as defined in formula (1), and preferences are the same as in formula (1), and
X² is 2An₁⁻ or An₂²⁻, wherein An₁⁻ is a monovalent anion and An₂²⁻ is a divalent anion.

In the formula (1-3), X² is 2An₁⁻ or An₂²⁻, wherein An₁⁻ is a monovalent anion and An₂²⁻ is a divalent anion.

Examples of An₁⁻ include a monovalent anion such as halide ion (F⁻, Cl⁻, Br⁻, I⁻), NO₃⁻, SbF₆⁻, PF₆⁻, BF₄⁻, B(C₆F₅)₄⁻, HO⁻, CH₃O⁻, CH₃COO⁻, CF₃COO⁻, CF₃SO₃⁻, (CF₃SO₂)₂N⁻.

Examples of An₂²⁻ include a divalent anion such as SO₄²⁻, SO₃²⁻, CO₃²⁻, FeCl₄²⁻.

Of these, SbF₆⁻ and PF₆⁻ are preferred in terms of stability.

The metallocene compound represented by the following formulae may be mentioned.

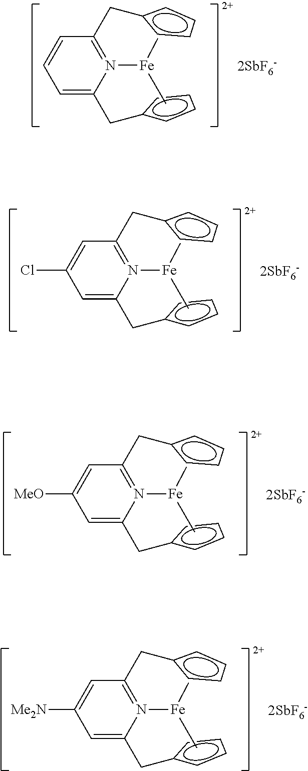

### <A Method for Producing a Metallocene Compound>

Certain implementations of this application also relate to a method for producing the metallocene compound comprising reacting a compound represented by formula (2) with a cyclopentadienyl salt represented by formula (3) to obtain a compound represented by formula (4), and then reacting the compound represented by formula (4) with a compound represented by formula (5). The compound represented by formula (1) may be prepared using this method.

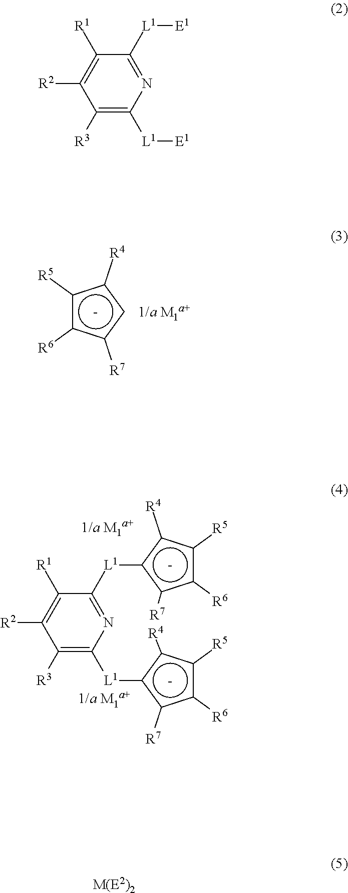

R¹ to R⁷ are independently selected from a hydrogen atom, a halogen atom, a hydrocarbon group, and a heteroatom-containing group;
M is selected from Co, Ni, and Fe;
E¹ is a leaving group;
M¹ is an alkaline metal or alkaline earth metal;
a is 1 when M₁ is an alkali metal, and 2 when M₁ is an alkaline earth metal; and
E² is a leaving group.

Examples and preferences of R¹ to R⁷ are the same as mentioned in connection with the metallocene compound represented by formula (1).

E¹ is a leaving group. The leaving group is not particularly limited, and examples of the leaving group include a halogen atom such as a fluorine atom, a chlorine atom, a bromine atom, an iodine atom; an alkoxy group such as methoxy, phenoxy; an alkylsulfonyl group such as a methylsulfonyl group, a trifluoromethylsulfonyl group; an arylsulfonyl group such as a p-toluenesulfonyl group. Of these, the halogen atom, methylsulfonyl group, p-toluenesulfonyl group are preferred in terms of reactivity.

M¹ is an alkaline metal such as lithium, sodium, potassium, rubidium, cesium, or an alkaline earth metal such as beryllium, magnesium, calcium, strontium, barium. a is 1 when M₁ is an alkali metal, and 2 when M₁ is an alkaline earth metal. Of these, lithium, sodium and potassium are preferred in terms of commercial availability.

E² is a leaving group. The leaving group is not particularly limited, and examples of the leaving group include a halogen atom such as a fluorine atom, a chlorine atom, a bromine atom, an iodine atom; an alkoxy group such as methoxy, phenoxy; an alkylsulfonyl group such as a methylsulfonyl group, a trifluoromethylsulfonyl group; an arylsulfonyl group such as a p-toluenesulfonyl group; a carboxyl group such as acetate, trifluoroacetate; a carbonyl group such as acetylacetonate. Of these, the halogen atom, is preferred in terms of solubility.

The present method includes a step of reacting a compound represented by formula (2) with a cyclopentadienyl salt represented by formula (3) to obtain a compound represented by formula (4). The reaction may be carried out with reference to the following literature:
Paolucci, G. et al. New dinuclear bis(cyclopentadienyl)lanthanoid chlorides containing η⁵-C₅H₄ ligands linked by a metal-coordinated 2,6-dimethylenepyridyl unit. J. Organomet. Chem. 471, 97-104, doi: 10.1016/0022-328X(94)88112-X (1994).

In the reaction, the cyclopentadienyl salt of formula (3) may be used in an amount of 2 moles or more per mole of the leaving group in the compound of formula (2), and preferably 2 to 2.2 moles in terms of ease of purification of the product.

The reaction may be carried out in a solvent, preferably in an aprotic polar solvent. Examples of the aprotic polar solvent include ethers such as diethyl ether, tetrahydrofuran; nitriles such as acetonitrile; esters such as ethyl acetate, ethyl acetate, butyl acetate, isobutyl acetate, propyl acetate; sulfones such as dimethyl sulfone, sulfolane, 3-methylsulfolane; sulphoxides such as dimethyl sulphoxide (DMSO); amides such as formamide, N-methylformamide, N,N-dimethylformamide, N-methylpyrrolidone, acetamide, N-methylcaprolactam. Of these, tetrahydrofuran and acetonitrile are preferred in terms of solubility of the starting materials and boiling point. The solvent may be used alone or in combination of two or more.

The reaction may be carried out at −40 to 60° C. It may be carried out at room temperature. The reaction may be carried out at atmospheric pressure. The reaction time is not particularly limited, and may be 0.5 to 48 hours.

The reaction may be carried out in the presence of a strong base containing an alkaline metal such as sodium hydride, sodium amide, sodium alkoxide, potassium hydride, n-butyl lithium. The strong base may be used in an amount of 1 moles or more per mole of the leaving group in the compound of formula (2). In this case, the amount of the cyclopentadienyl salt of formula (3) may be reduced. For example, the cyclopentadienyl salt of formula (3) may be used in an amount of 1 moles or more per mole of the leaving group in the compound of formula (2), and preferably 1 to 1.1 moles in terms of ease of purification of the product.

The resulting compound of formula (4) may be separated from the reaction product and subjected to the next process.

Certain methods include a step of reacting the compound of formula (4) obtained with a compound represented by formula (5).

In the reaction, the compound of formula (5) may be used in an amount of 1 moles or more per mole of the compound of formula (4), and preferably 1 to 1.5 moles in terms of ease of product yield.

The reaction may be carried out in a solvent, preferably in an aprotic polar solvent. Examples of the aprotic polar solvent include ethers such as diethyl ether, tetrahydrofuran; nitriles such as acetonitrile; esters such as ethyl acetate, ethyl acetate, butyl acetate, isobutyl acetate, propyl acetate; sulfones such as dimethyl sulfone, sulfolane, 3-methylsulfolane; sulphoxides such as dimethyl sulphoxide (DMSO); amides such as formamide, N-methylformamide, N,N-dimethylformamide, N-methylpyrrolidone, acetamide, N-methylcaprolactam. Of these, tetrahydrofuran are preferred in terms of product yield. The solvent may be used alone or in combination of two or more.

The reaction may be carried out at −40 to 60° C. It may be carried out at room temperature. The reaction may be carried out at atmospheric pressure. The reaction time is not particularly limited, and may be 5 minutes to 24 hours.

The compound of formula (1-1) may be obtained by the reaction. The compound is obtained as a mixture with a compound represented by formula (1-1′).

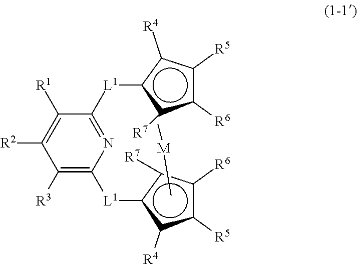

wherein,
R¹ to R⁷, L¹, and M are as defined in formula (1-1), and preferences are the same as in formula (1-1).

In case of M is iron, for example, it is as follows:

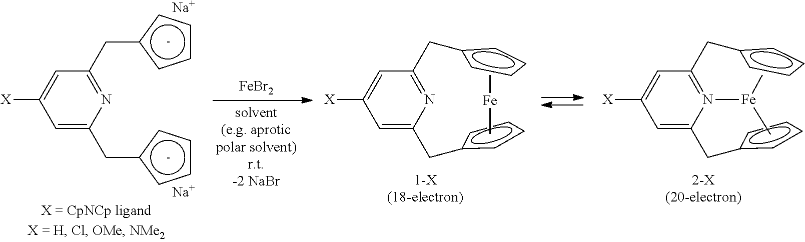

By oxidizing the reaction product of the compound of formula (4) and the compound of formula (5), a compound of formula (1-2) or (1-3) may be obtained.

In case of M is iron, for example, it is as follows:

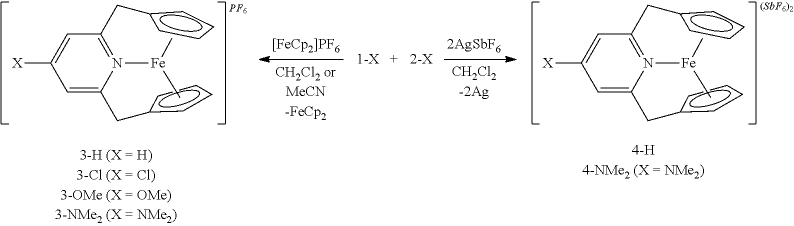

For example, the reaction conditions for obtaining the compound of formula (1-2) are as follows:

The reaction may be carried out using a single electron oxidizing agent, for example, [FeCp₂]PF₆, etc. An oxidizing agent having an oxidation potential of −0.7 V (vs. ferrocene^{0/+}) or higher is preferred. The molar ratio of the oxidizing agent to the raw compound is preferably around 1:1. The reaction may be carried out in a solvent. A polar solvent is preferred because it easily dissolves the oxidizing agent and the reaction product. The reaction can be carried out at room temperature.

For example, the reaction conditions for obtaining the compound of formula (1-3) are as follows:

The reaction may be carried out using a single electron oxidizing agent, for example, AgSbF₆, etc. An oxidizing agent having an oxidation potential of 0.2V (vs. ferrocene °/+) or higher is preferred. The molar ratio of the oxidizing agent to the raw compound is preferably around 1:2. The reaction may be carried out in a solvent. The solvent such as nitromethane, dichloromethane, etc. is preferred because it easily dissolves the oxidizing agent and the reaction product. The reaction can be carried out at room temperature.

Alternatively, a compound represented by formula (1-2′) or (1-3′) may be obtained by oxidizing the reaction product of the compound of formula (4) and the compound of formula (5).

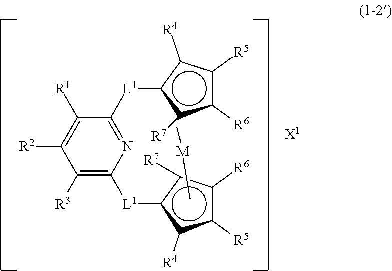

wherein,
R¹ to R⁷, L¹, M, X¹ are as defined in formula (1-2), and preferences are the same as in formula (1-2).

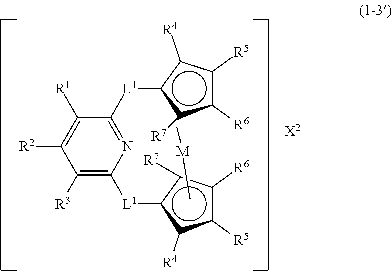

wherein,
R¹ to R⁷, L¹, M, X² are as defined in formula (1-3), and preferences are the same as in formula (1-3).

In case of M is cobalt, for example, it is as follows:

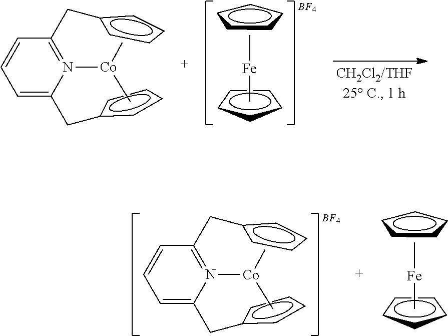

Certain implementations of this application also relate to a metallocene compound represented by formula (1′):

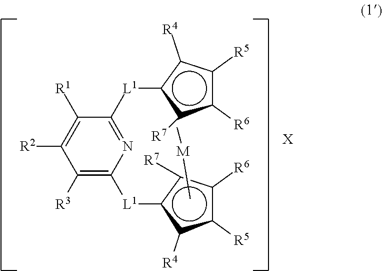

wherein, R¹ to R⁷, L¹, M, X are as defined in formula (1), and preferences are the same as in formula (1).

### <Applications>

The metallocene compound according to certain implementations of this application may be used in a variety of fields, including catalysis, materials, energy, and medical sciences.

One of the most important properties of the present metallocene compound is its stable reversible redox property. For example, commercial glucometer uses reversible redox property of 18-electron ferrocene derivatives, and more recently, reversible redox property of 19-electron cobaltocene derivatives are utilized to mediate electrochemical synthesis. Thus, electron chemical properties of the present metallocene compound are expected to be applicable to electrochemical applications.

For example, the unique reversible two-electron redox property of Fe(CpNCp) complexes can be utilized for a redox detection application, and the presence of basic pyridine nitrogen at the vicinity of cobalt center in Co(CpNCp) complex will facilitate transfer of electron and proton for electrochemical synthesis applications.

The presence of basic pyridine nitrogen groups at the vicinity of redox-active metal (M) centers in M(CpNCp) complex will facilitate the transfer of electrons and protons via reduction of metal center and protonation of nitrogen group to catalyze electrochemical hydrogen atom transfer to small important molecules such as nitrogen, oxygen, and carbon dioxide molecules, and complex organic molecules such as pharmaceutical intermediates, to synthesize ammonia, hydrogen peroxide, methanol, and pharmaceutical compounds, respectively.

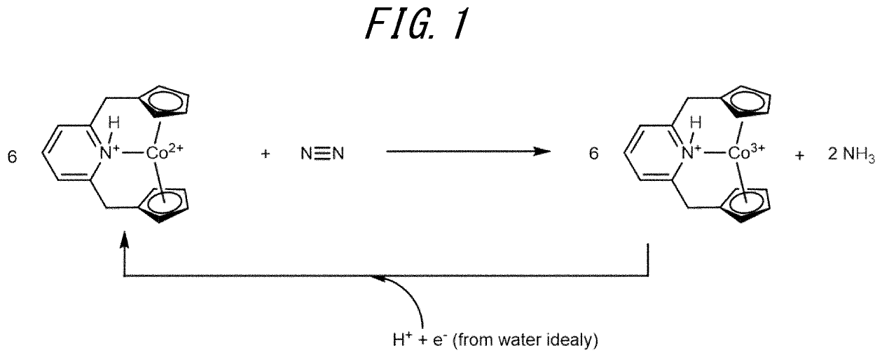

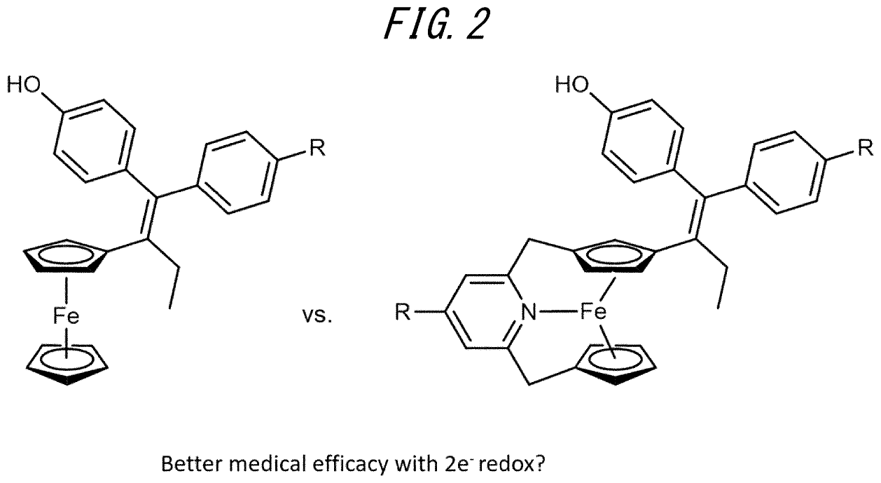

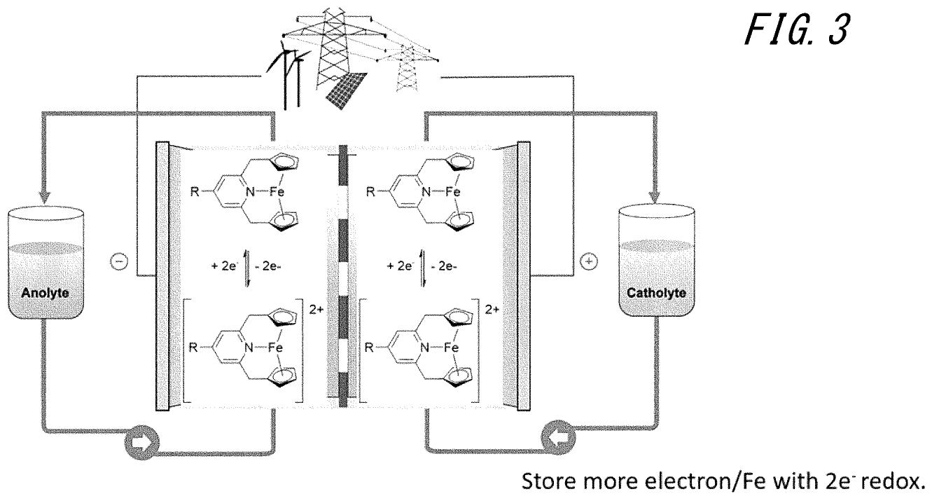

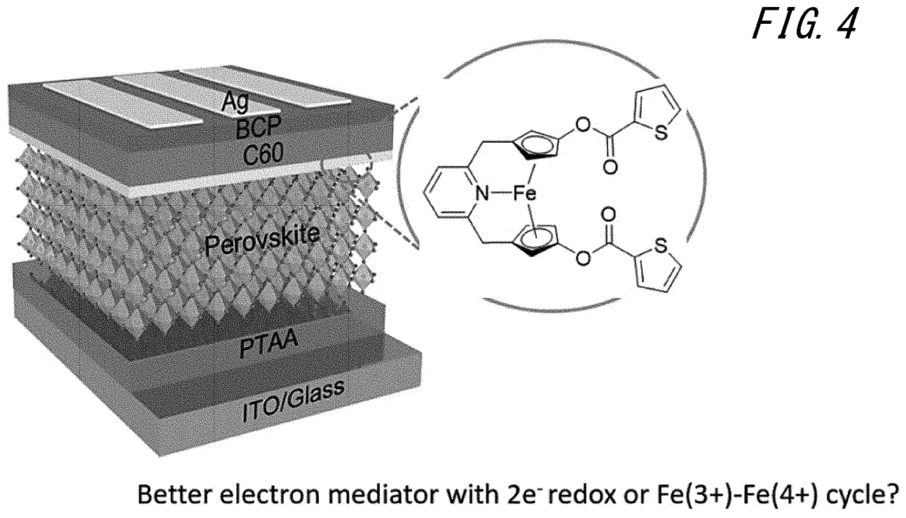

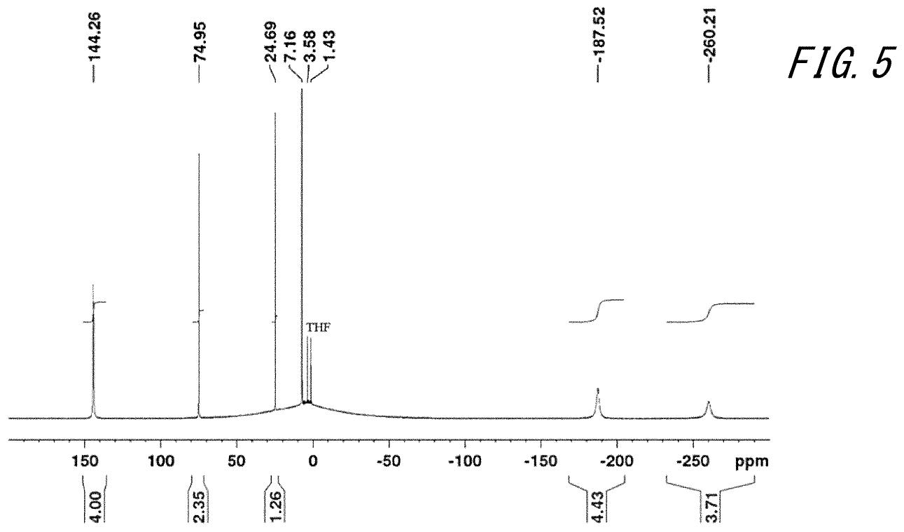

For example, FIG. 1 shows an idea for an electrocatalyst, FIG. 2 shows an idea for a medicine, FIG. 3 shows an idea for a redox flow battery, and FIG. 4 shows an idea for a solar cell.

Certain implementations of this application also relate to a catalyst comprising the present metallocene compound, an electron mediator comprising the present metallocene compound, an electrolyte for a redox flow battery comprising the present metallocene compound, and a medicament comprising the present metallocene compound as an active ingredient.

### EXAMPLES

The following provides a more specific description of the present disclosure based on examples.

The materials and analytical methods used in the experiments are as follows.

### <General Considerations and Materials>

All reactions were carried out under an N₂ atmosphere using an MBRAUN glovebox, UNILAB Plus SP, equipped with an MB-20-G gas purifier, an MB-LMF-2/40-REG regenerable solvent trap, and an MB-GS-35 −35° C. freezer. All glasswares were dried overnight at 170° C. and cooled down under vacuum in the glovebox antechamber. All solvents were reagent grade or higher. n-Pentane (≥99.0%), hexane (≥95.0%, n-hexane with minor amounts of isomers of methylpentane and methylcyclopentane), n-heptane (≥99.0%), dichloromethane (≥99.5%), benzene (≥99.7%), toluene (≥99.8%), acetonitrile (≥99.8%), methanol (≥99.8%), tetrahydrofuran (Sigma-Aldrich 401757-1 L, anhydrous, ≥99.9%, inhibitor-free), diethyl ether (≥99.8%, inhibitor-free), hexamethyldisiloxane (Sigma-Aldrich 205389-500 ML, ≥98%), and dimethylformamide (DMF, ≥99.0%) were dried over MS3A (dried overnight in a 200° C. oven and cooled overnight under vacuum in the glovebox antechamber) in the glovebox for more than 2 days and stored in the glovebox. Common chemicals were purchased, kept in the glovebox, and used as received unless stated otherwise. Anhydrous CoBr₂ (green powder, >97%) was purchased from Fujifilm Wako Chemicals. NiCl₂(DME) (yellow powder, 98%) was purchased from Sigma Aldrich. MnBr₂ (pink powder, 99%) was purchased from Acros Organics. Celite filtration was carried out using a pipet, cotton wool, and Celite (registered trademark) 545, which was dried overnight in a 170° C. oven, cooled down overnight under vacuum in the glovebox antechamber, and kept in the glovebox. The dimensions of the 20 mL vial are 60 mm in height, 28 mm in outer diameter, and the Teflon-coated stirring bar is 15 mm long and 5 mm in diameter.

### <Instrumental Analysis Methods>

### (NMR Spectroscopy)

All deuterated solvents were purchased and dried over MS3A in the glovebox for more than 2 days and kept in the glovebox. NMR spectra were recorded using a Bruker Avance III-400N spectrometer and an Avance III NEO 500 spectrometer equipped with a cryoprobe. ¹H and ¹³C NMR chemical shifts are reported in parts per million (6) relative to TMS (0 ppm) with the residual solvent signal (CDCl₃: 7.26 (1H) and 77.16 (¹³C) ppm, C₆D₆: 7.16 (¹H) and 128.06 (¹³C) ppm, THF-d₈: 1.72 (¹H) and 25.31 (¹³C) ppm, toluene-d₈: 2.08 (¹H) and 20.43 (¹³C) ppm, DMSO-d₆: 2.50 (¹H) and 39.52 (¹³C) ppm, methanol-d₄: 3.31 (¹H) and 49.00 (¹³C) ppm, CD₃CN: 1.94 (¹H) and 118.26 (¹³C) ppm) as the internal references ²H NMR chemical shifts are reported in parts per million (δ) relative to residual solvent signal as the internal reference. ¹¹B, ⁵N, and 19F NMR chemical shifts are reported in parts per million (6) relative to BF₃·OEt₂ in CDCl₃ (0 ppm), NH₃(liquid) (0 ppm), and CFCl₃ (0 ppm), respectively, as external references.

NMR peak assignments of diamagnetic compounds were made using ¹H-¹H-gCOSY, ¹H-¹³C-HSQC, and ¹H-¹³C-HMBC NMR experiments.

Abbreviations for NMR spectra are s (singlet), d (doublet), t (triplet), q (quartet), quint (quintet), sep (septet), dd (doublet of doublet), td (doublet of triplet), dq (doublet of quartet), m (multiplet), and br (broad). ¹H NMR signals of paramagnetic complexes are reported with chemical shift (δ) and line width at half-height (Δv^{1/2}). Air-sensitive NMR samples were prepared in the nitrogen glovebox using a J. Young NMR tube or a standard NMR tube sealed with a septa and parafilm.

### (NMR Measurement of Paramagnetic Complexes)

¹H NMR of para-magnetic complexes (typically 20 mM solution) was measured with delay time (d1) of 0.1 s, time domain data points (td) of 128k, and scan number (ns) of 1 to 128, and spectral width (sw) of 200 to 600 ppm.

Proton-coupled ¹³C NMR experiments were carried out using an Avance III NEO 500 spectrometer equipped with a cryoprobe. For proton coupled ¹³C NMR experiments, a delay time (d1) of 0.1 s, a time domain data points (td) of 64k, a scan number (ns) of 64k, and a spectral width (sw) of 1100 ppm were used.

### (Measurement of Effective Magnetic Moment by Evans' Method)

Measurement of the effective magnetic moment by Evans' method was carried out using glass capillaries containing C₆D₆ (measurement in C₆D₆) as external standards.

### (Single-Crystal X-Ray Diffraction (SC-XRD))

The X-ray diffraction experiments were performed on a Bruker D8 Venture diffractometer equipped with a PHOTON II CPAD detector and an IμS 3.0 microfocus X-ray source (Mo Kα radiation). The X-ray diffraction data for the single crystal were collected on a Rigaku XtaLab PRO instrument equipped with a PILATUS3 R 200 K hybrid pixel array detector and a MicroMax™-003 microfocus X-ray tube (Mo Kα). Data were collected at 100 K according to recommended strategies, then processed and corrected. All structures were solved using SHELXT. Structures were refined by the full-matrix least-squares using SHELXL. Non-hydrogen atoms were refined anisotropically.

### (VSM Measurement)

The VSM measurement was carried out using the Quantum Design PPMS DynaCool VSM module. VSM powder sample holders (part #: 4096-388) were weighed outside the glovebox using a microbalance and placed inside in the glovebox. All powdered samples were packed and sealed in the sample holders in the nitrogen glovebox. The sealed samples were weighed outside the glovebox using microbalance to calculate the weight of the samples.

### (FTIR Spectroscopy)

IR spectra were recorded using a Nicolet iS5 FT-IR spectrophotometer and are reported in absorption frequency (cm⁻¹). Abbreviations for FT-IR spectra are s (strong), m (medium), and w (weak).

### (High-Resolution Mass Spectrometry (HRMS))

HRMS data were recorded on a Thermo Scientific LTQ-Orbitrap mass spectrometer, using electrospray ionization (ESI) mode.

### (Elemental Analyses)

Elemental analyses were conducted using an Exeter Analytical CE-440 elemental analyzer. Empty tin cups were weighed outside the glovebox using a microbalance and brought in the glovebox. All samples were weighed and sealed in the tin cups in the nitrogen glovebox. The sealed samples were weighed outside the glovebox using microbalance to calculate weight of the samples. The N₂ gas in the tin cups was replaced by argon through three vacuum-argon refill cycles. All the samples were analyzed using an autosampler under a He atmosphere.

### (Cyclic Voltammetry (CV))

CV was measured inside the nitrogen glovebox using an ECstat-301WL potentiostat equipped with a glassy carbon working electrode (3.0 mm diameter), a platinum wire counter electrode (0.5 mm diameter), and an Ag/Ag⁺ reference electrode (Ag wire in 0.01 M AgNO₃ in 0.1 M [Bu₄N]PF₆ MeCN solution). The sample solution was prepared by dissolving an appropriate sample in 0.1 M [Bu₄N]NPF₆ THF solution. All potentials are reported using the FeCp₂^{0/+} couple (0 mV) as an external reference.

### (Computational Methods)

DFT computations were performed with the ORCA software package (versions 5.0.0, 5.0.1, 5.0.3) unless otherwise noted. For structure optimizations and harmonic vibrational frequencies, we employed the TPSS meta-GGA functional. Additionally, we utilized Grimme's latest additive dispersion correction D4 and an Ahlrichs-type basis set with triple-zeta quality (def2-TZVPP). Minima on the potential energy surface were confirmed by the absence of imaginary frequencies. For accurate electronic energies and quasi-restricted orbitals (QROs) we used the hybrid variant of this functional, i.e., TPSSh, together with the quadruple-zeta quality basis set (def2-QZVPP). We tested the influence of relativistic effects by incorporating the zerothorder regular approximation (ZORA) at the scalar spin-free level of the theory. As recommended, these calculations use a relativistically recontracted basis set (ZORA-def2-XVP) and a decontracted auxiliary basis set (SARC/J). Unless noted otherwise, the resolution of identity (RI) and chain-of-spheres (RIJCOSX) approximations, as implemented in ORCA, were used for (meta)-GGA and hybrid functionals, respectively, together with the appropriate auxiliary basis set (def2/J). All computations performed with ORCA utilized the tight SCF convergence criteria and the default integration grid (defgrid2).

Wiberg bond indices were determined in the framework of natural bond orbital (NBO 7.0.10) analysis. The topological analysis of the theoretical electron density ρ(r) and electrostatic potential φes(r) was performed with Multiwfn 3.8(dev). For this purpose, we carried out single-point energy computations at TPSSh/def2-QZVPP level using the Gaussian16 software package (revision C.01) to generate a Gaussian checkpoint file as input (tight SCF convergence criteria, ultrafine integration grid). The electrostatic potential φes(r) was evaluated using the built-in code. The protocol for generating superposition maps of the zero-flux surfaces defined in the gradient vector fields ∇ρ(r) and ∇φes(r) was described in detail earlier.

### (Quantum Crystallography)

The X-ray diffraction data were collected at 100 K with a reciprocal resolution sin(θₘₐₓ=λ) of 1.26 angstrom⁻¹. The multipole refinement was performed within the Hansen-Coppens formalism as implemented in MoPro. The anharmonic atomic motion of Co was modeled using the Gram-Charlier expansion of the temperature factors. A block refinement of the charge density parameters and the Gram-Charlier coefficients was applied analogously to the procedure described earlier.

The analysis of the multipole-derived electron density ρ(r) and electrostatic potential φes(r) was performed in WinXPRO analogous to the published procedures. The energy density h(r) was approximated according to Kirzhnits.

### Example 1

### Preparation of the Paramagnetic Complex 1

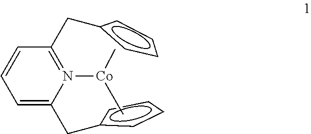

The paramagnetic complex 1 was prepared as follows, and in order to unambiguously show the bonding situation and formal electron count of 1, the paramagnetic complex 1 was characterized by a number of methods, including high-resolution single-crystal X-ray diffraction (SC-XRD), ¹H, ¹³C, and ²H nuclear magnetic resonance (NMR) spectroscopies, electron paramagnetic resonance (EPR) spectroscopy, vibrating sample magnetometry (VSM), electrospray ionization mass spectrometry (ESI-MS), elemental analysis, and density functional theory (DFT) calculations at the TPSSh-D4/def2-QZVPP/TPSS-D4/def2-TZVPP level of theory.

### Preparation of 2,6-bis(methylenecyclopentadienyl)pyridine disodium salt (Na₂CpNCp)

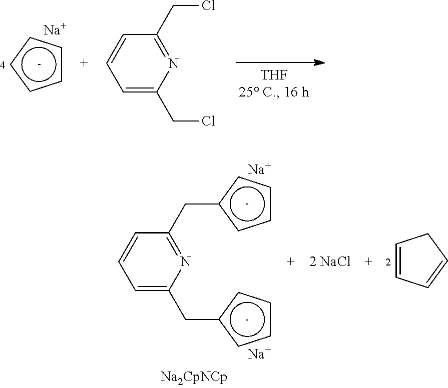

A 20 mL vial equipped with a Teflon coated stirring bar was charged with NaCp (5.37 mL, 1.49 M THF solution, 8.00 mmol). 2,6-bis(chloromethyl)pyridine (352.0 mg, 2.00 mmol) in 4 mL THF was added to the vial dropwise for about 5 min. The solution warmed up to about 50° C. due to the exothermic reaction and white precipitate of NaCl formed. The mixture was stirred for 17 h at 25° C. The resulting yellow solution and white precipitate was filtered using a plug of Celite. The Celite was washed three times with 1 mL each of THF, and the filtered yellow solution was concentrated under vacuum. White crystalline solid of the product formed on the glass wall upon concentration to about 2 mL. More product precipitated from the concentrated solution upon storing the solution at −35° C. for overnight. The red-orange supernatant was decanted and the remaining solid was washed three times with cold diethyl ether to remove unreacted NaCp and orange colored material. The resulting white solid was dried overnight under high vacuum (<0.2 mmHg) to remove coordinated THF molecules. More product was obtained by repeating the precipitation procedure using the concentrated supernatant liquid. Total yield: 349.7 mg, 63%. ¹H NMR data in THF-d₈ agrees with the previous reports. Previously not reported ¹³C{¹H}, and ¹⁵N NMR data and ¹H NMR data in CD₃CN and in THF-d₈ are reported. ¹H and ¹³C{¹H} NMR spectrum in CD₃CN showed signals due to partial deuteration of cyclopentadienyl protons during NMR data collection, thus only ¹³C{¹H} NMR chemical shifts of the major isotopologue are reported in CD₃CN.

### The Data for Na₂CpNCp:

¹H NMR (500.13 MHz, CD₃CN, 298 K): δ 3.91 (4H, s, 2CH₂), 5.25 (4H, m, 2,5-position of C₅H₄ groups), 5.46 (4H, m, 3,4-position of C₅H₄ groups), 6.97 (2H, d, ³J_{HH}, =7.6 Hz, 3,5-position of pyridine ring), 7.49 (1H, d, ³J_{HH}, =7.6 Hz, 4-position of pyridine ring).

¹H NMR (500.13 MHz, THF-d₈, 298 K): δ 3.93 (4H, s, 2CH₂), 5.34 (4H, pseudo t, 2,5-position of C₅H₄ groups), 5.52 (4H, pseudo t, 3,4-position of C₅H₄ groups), 6.89 (2H, d, ³J_{HH}, =7.5 Hz, 3,5-position of pyridine ring), 7.40 (1H, d, ³J_{HH}, =7.5 Hz, 4-position of pyridine ring).

¹³C{¹H} NMR (125.76 MHz, CD₃CN, 298 K): δ 39.5 (s, CH₂), 103.7 (s, 3,4-position of C₅H₄ groups), 104.5 (s, 2,5-position of C₅H₄ groups), 116.2 (s, 1-position of C₅H₄ groups), 119.9 (s, 3,5-position of pyridine ring), 136.9 (s, 4-position of pyridine ring), 166.4 (s, 2,6-position of pyridine ring).

¹³C{¹H} NMR (125.76 MHz, THF-d₈, 298 K): δ 39.7 (s, CH₂), 103.2 (s, 3,4-position of C₅H₄ groups), 104.3 (s, 2,5-position of C₅H₄ groups), 115.3 (s, 1-position of C₅H₄ groups), 119.6 (s, 3,5-position of pyridine ring), 136.2 (s, 4-position of pyridine ring), 166.1 (s, 2,6-position of pyridine ring).

¹⁵N NMR (50.68 MHz, CD₃CN, 298 K, detected using ¹H-¹⁵N HMBC): δ 297.5 (s).

¹⁵N NMR (50.68 MHz, THF-d₈, 298 K, detected using ¹H-¹⁵N HMBC): δ 297.3 (s).

### Preparation of [Co(CpNCp)] (1)

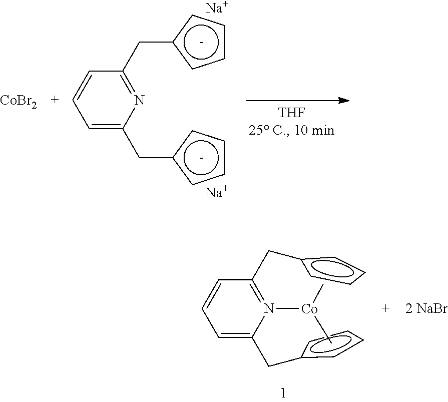

In a nitrogen glovebox, a 20 mL vial equipped with a Teflon coated stirring bar was charged with CoBr₂ (245.3 mg, 1.12 mmol) and 4 mL THF. The solution was stirred at 25° C. until clear blue solution was obtained. To the solution was then added a solid of Na₂CpNCp (250.4 mg, 0.897 mmol) portionwise for ca. 2 min. As soon as addition of Na₂CpNCp was completed, 10 mL n-pentane was added to the solution to precipitate purple solid of byproducts, and the red-orange solution was filtered using plug of Celite, and the Celite was washed by 1:1 THF:pentane mixture. Concentration of combined solution gave red-orange crystals of 1. Yield: 88.3 mg, 34%. This procedure was repeated another time using CoBr₂ (253.6 mg, 1.16 mmol) and Na₂(CpNCp), (247.1 mg, 0.885 mmol), and 88.9 mg of 1 (34% yield) was obtained.

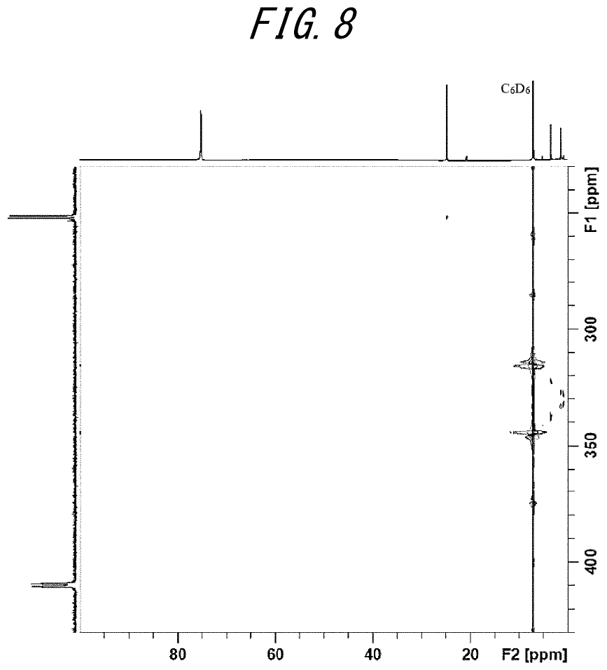

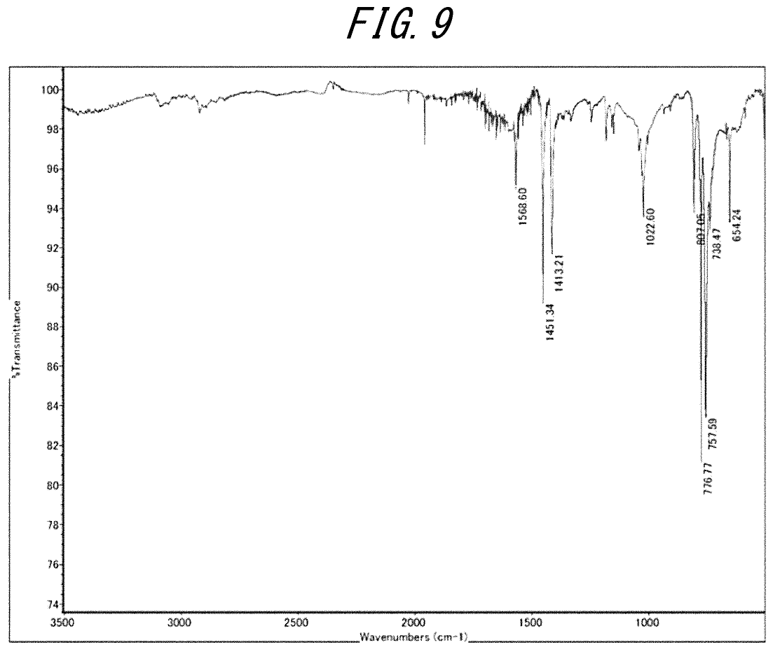

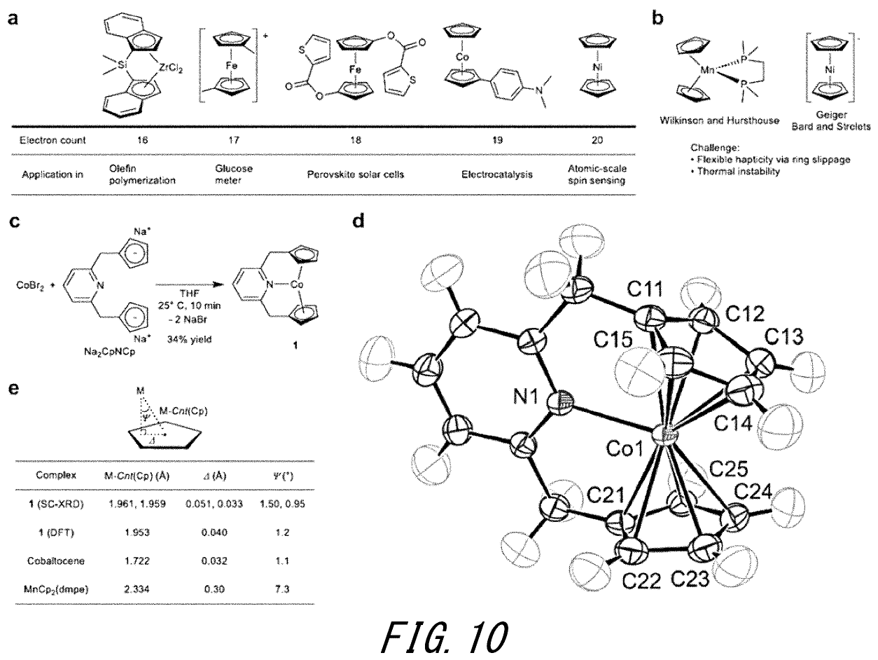

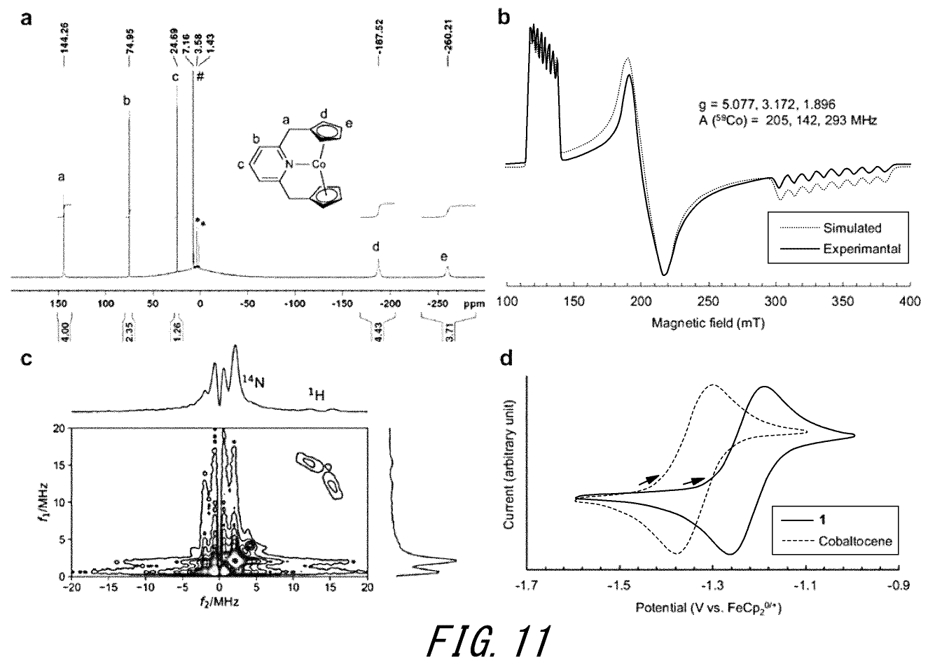

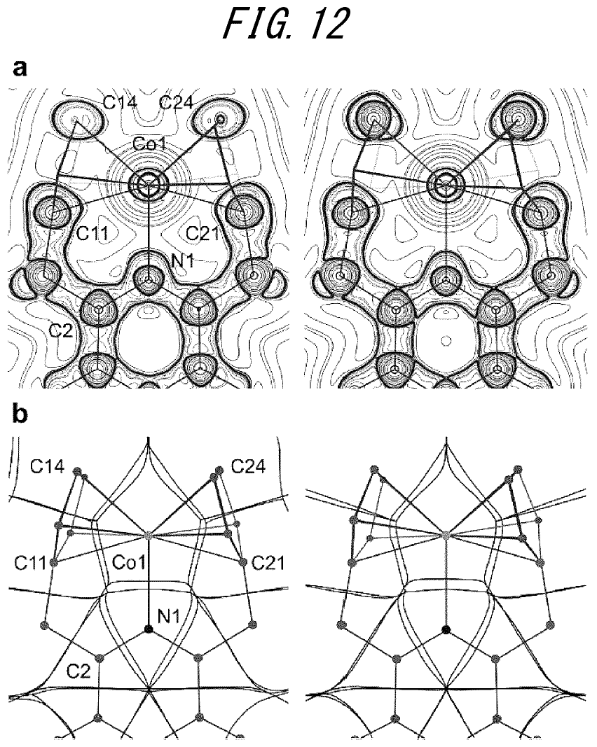

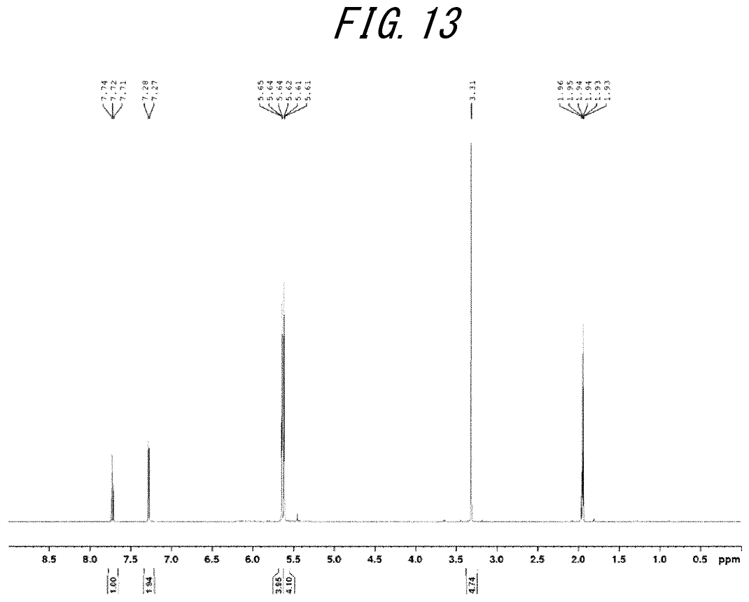

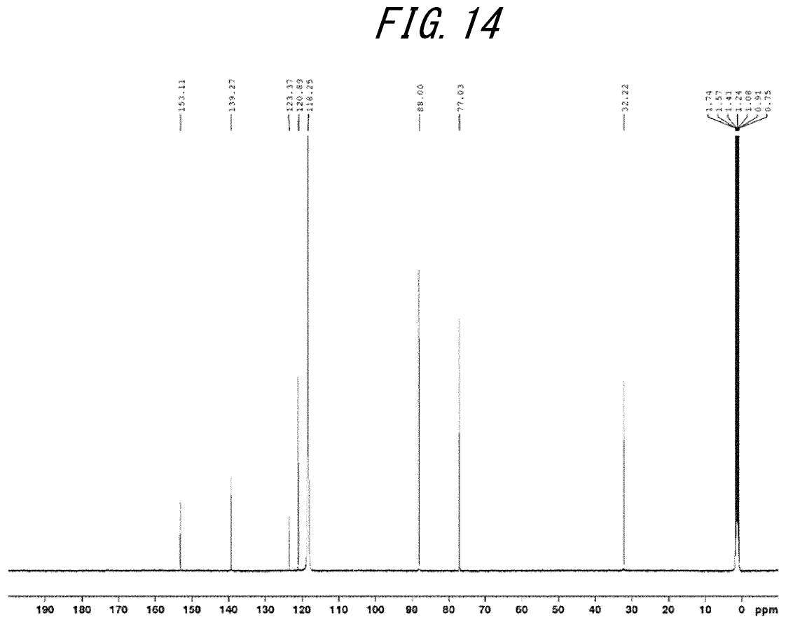

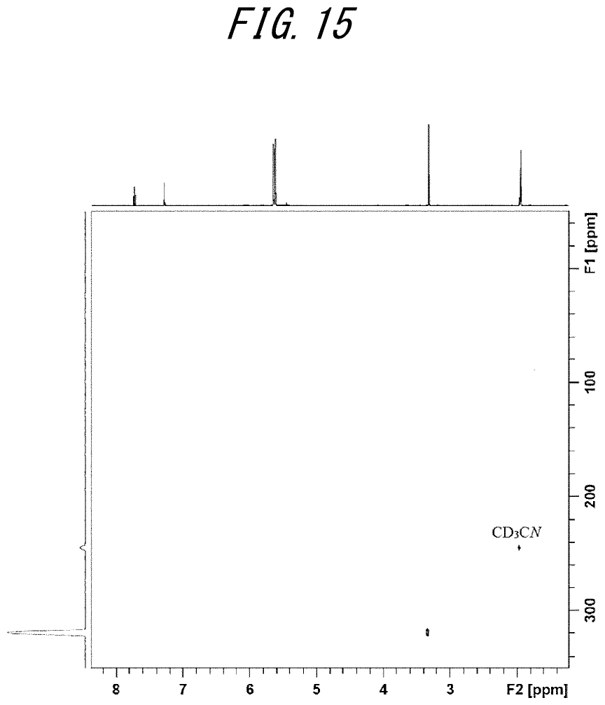

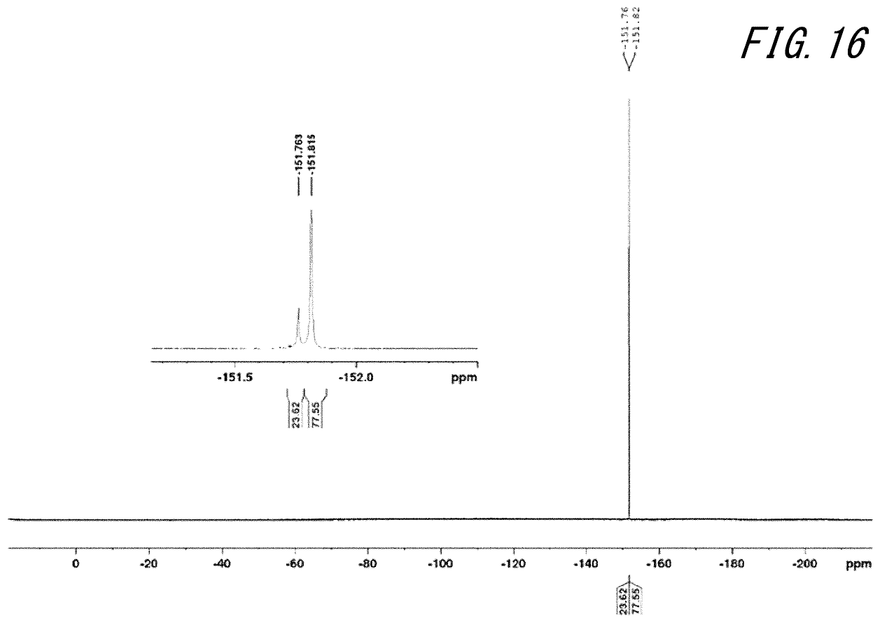

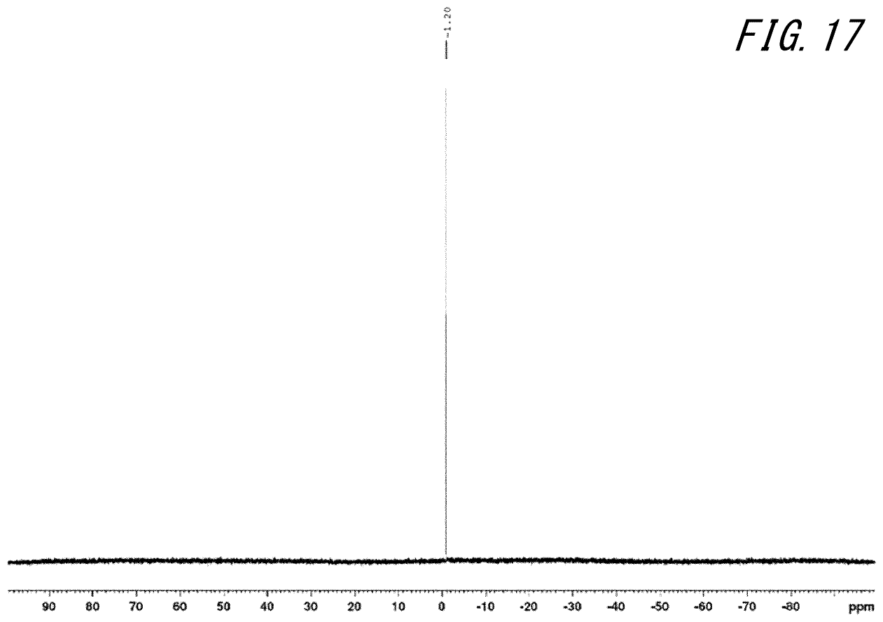

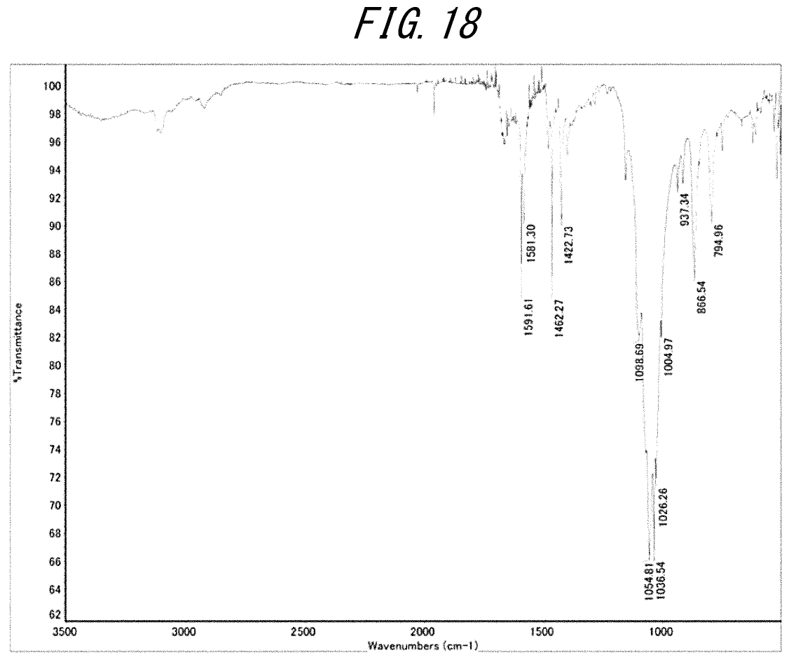

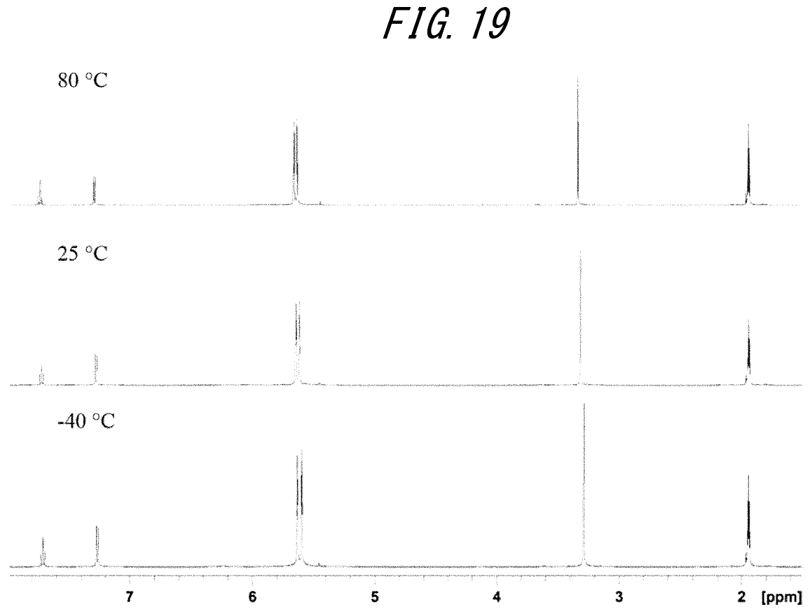

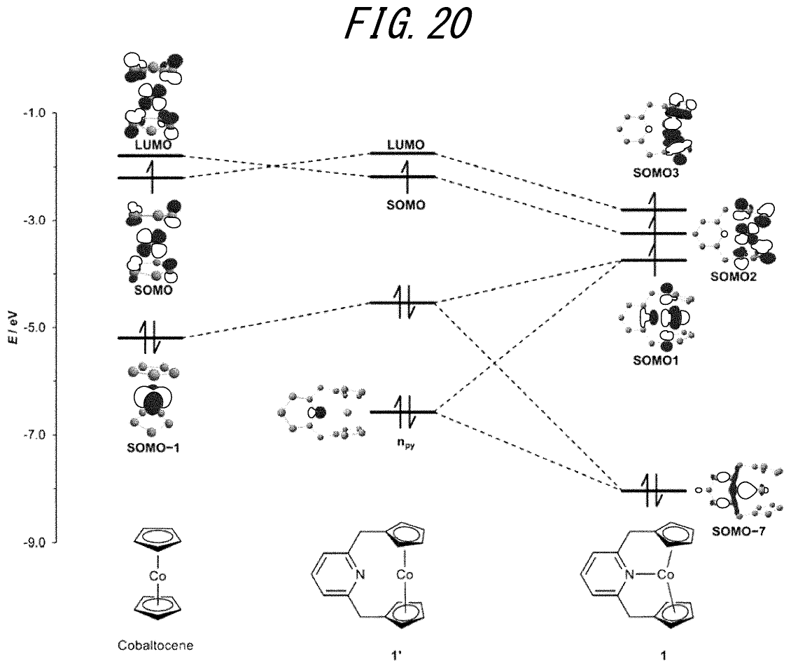

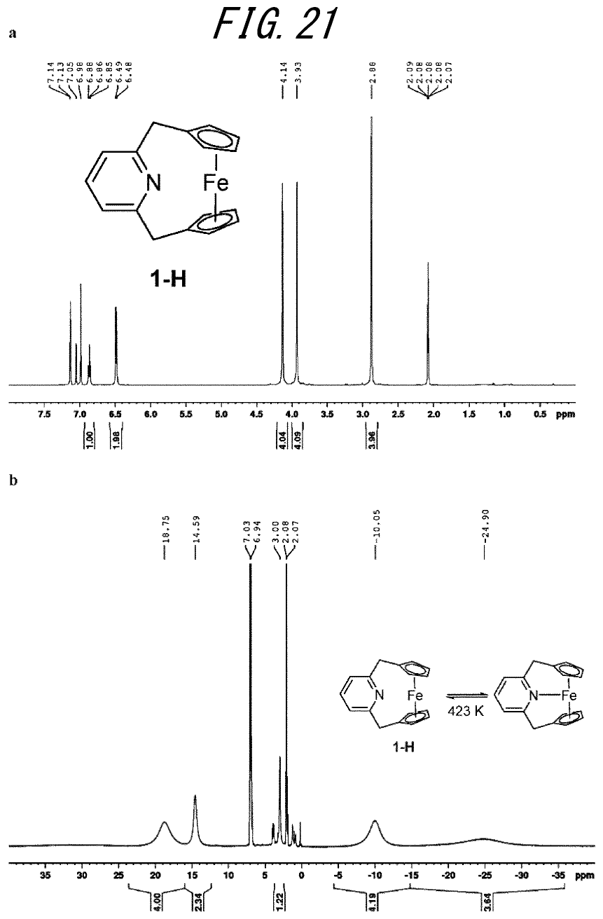

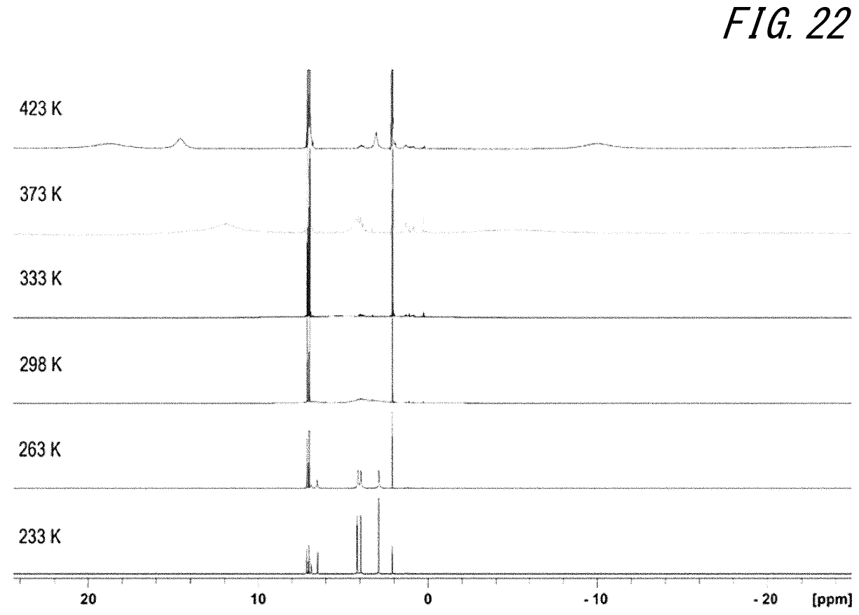

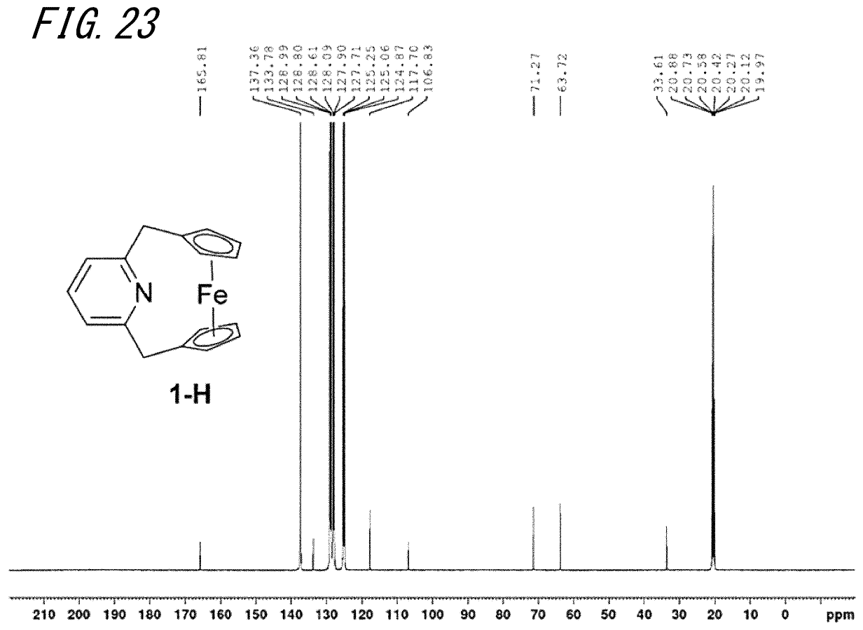

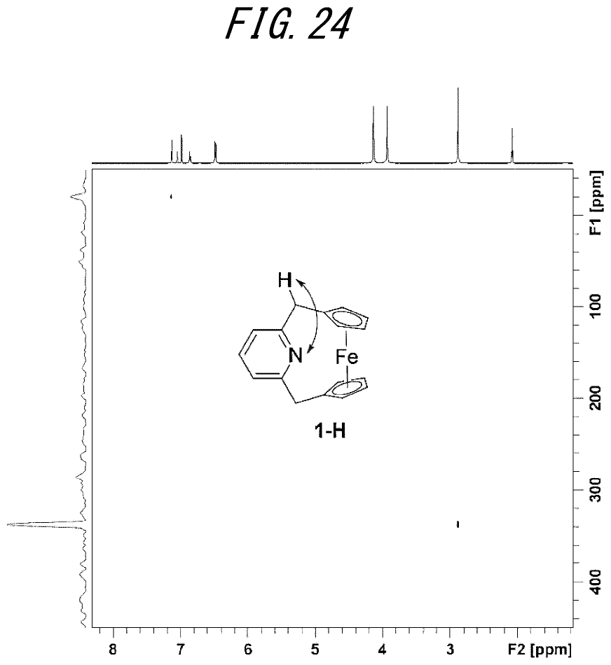

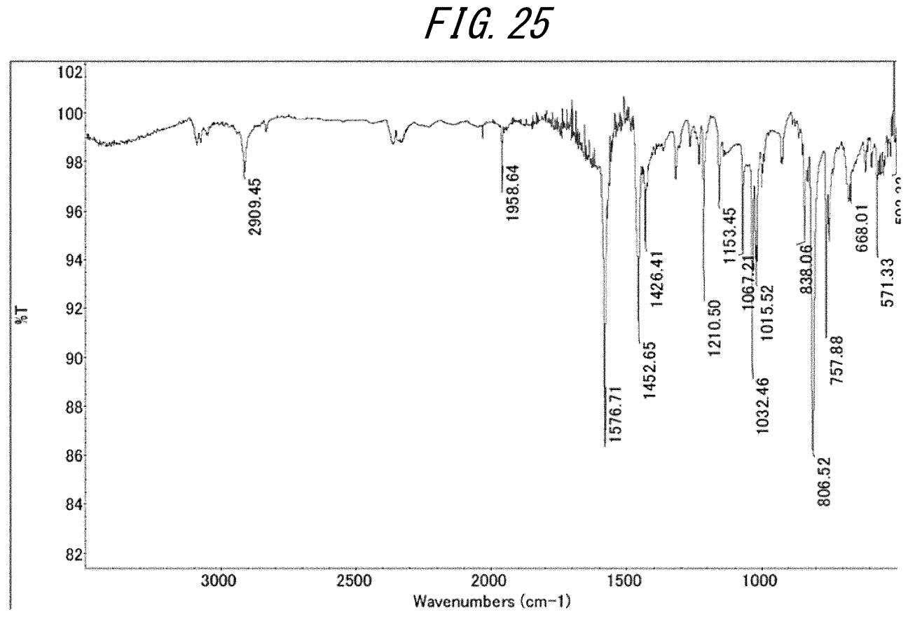

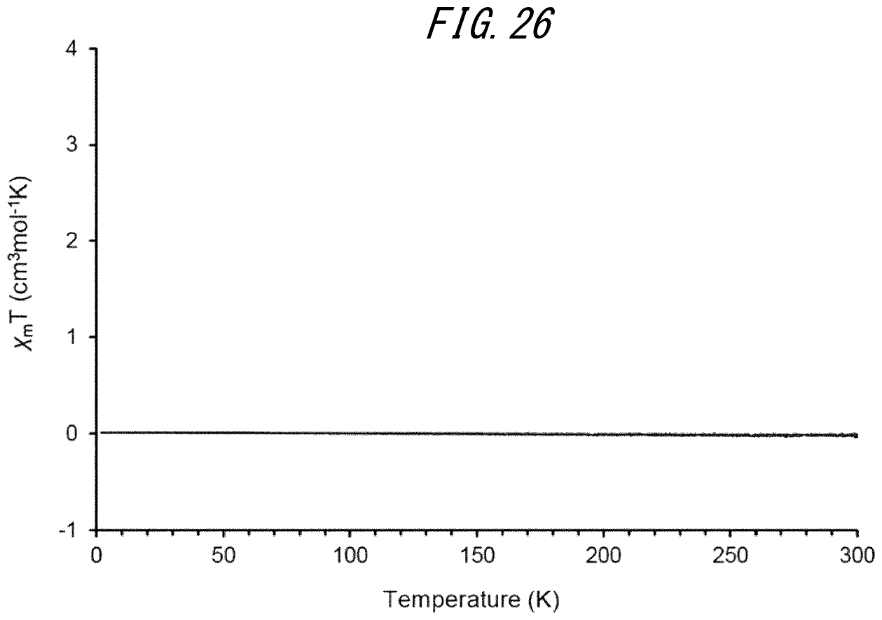

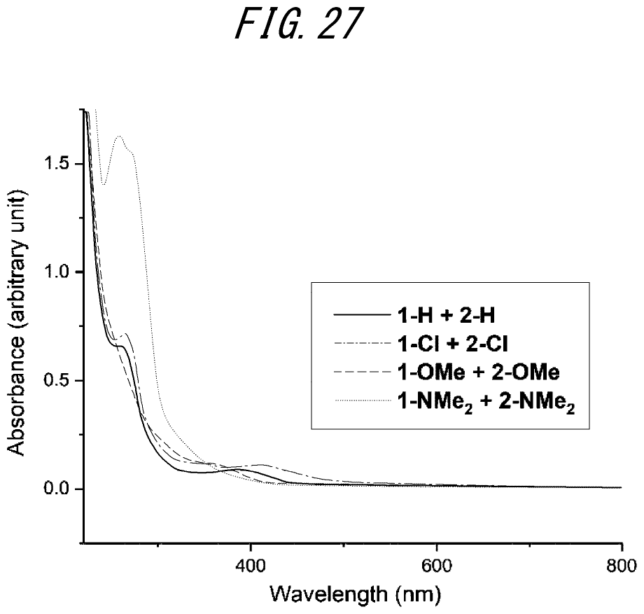

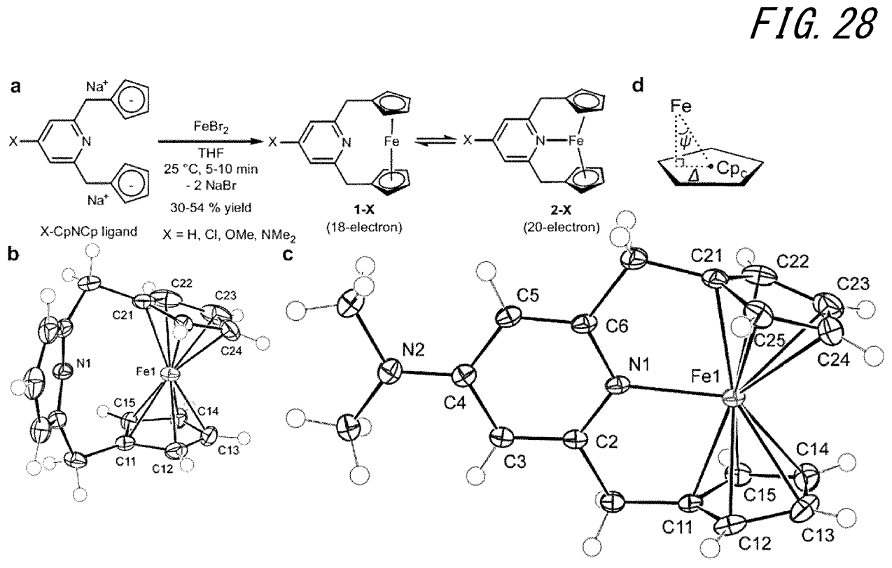

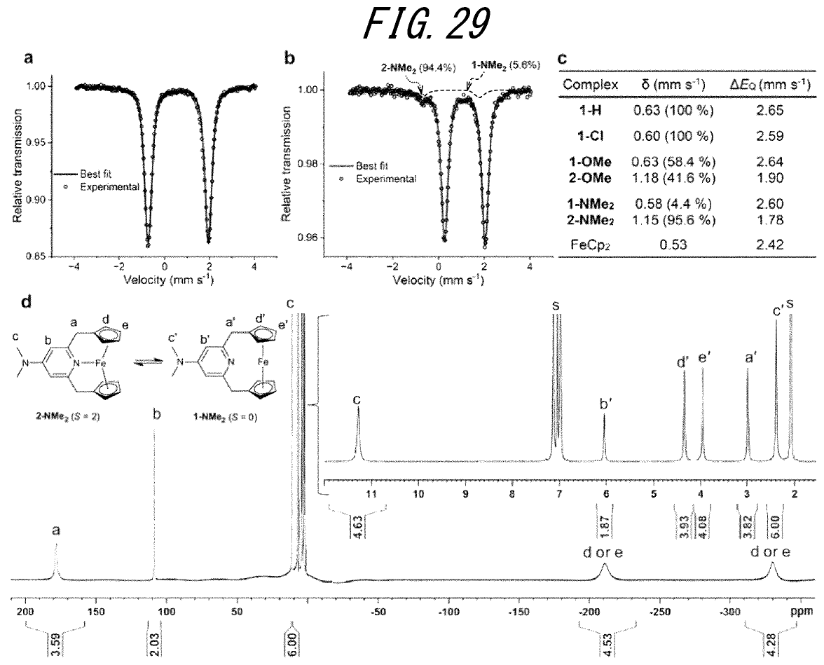

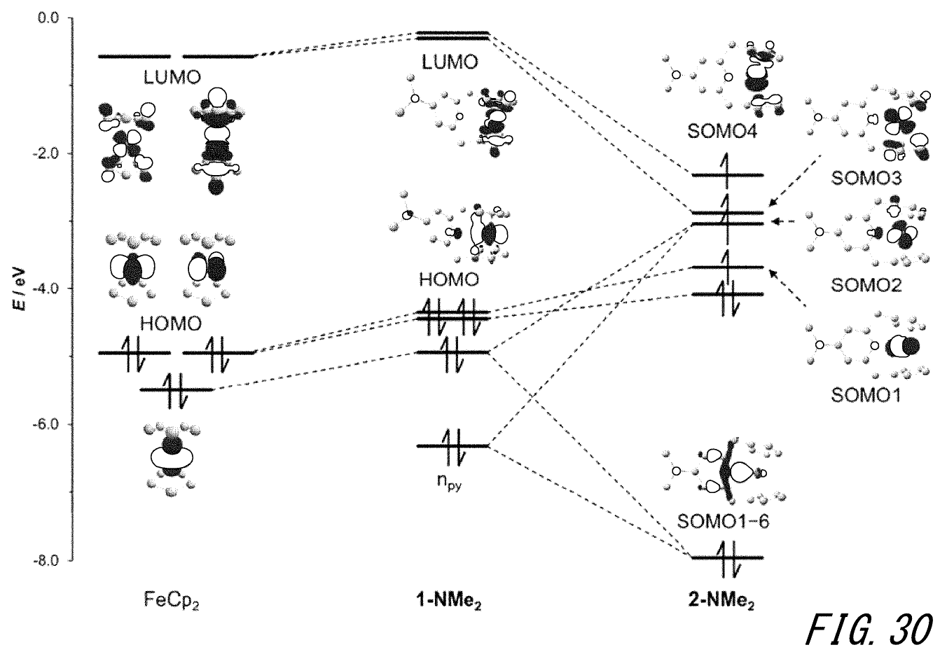

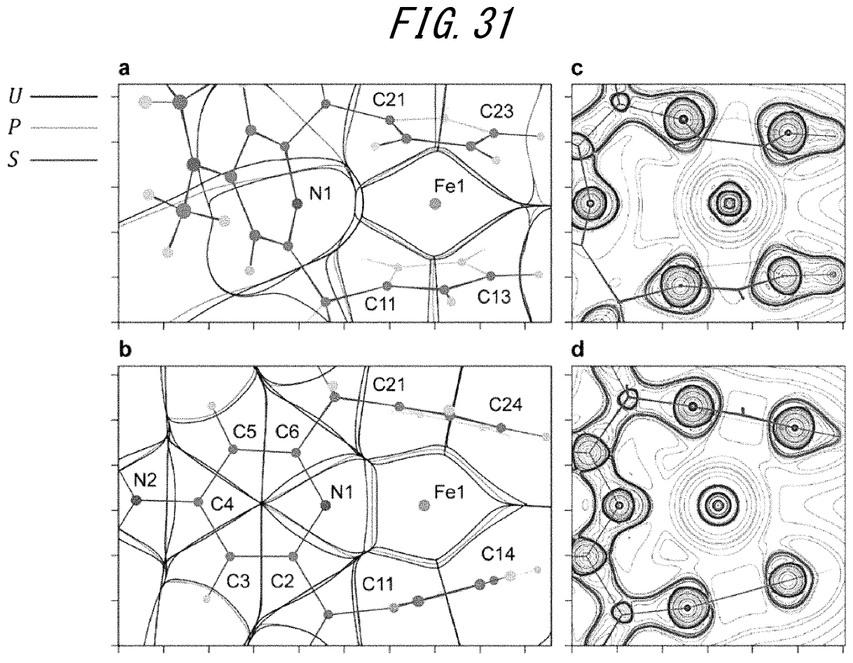

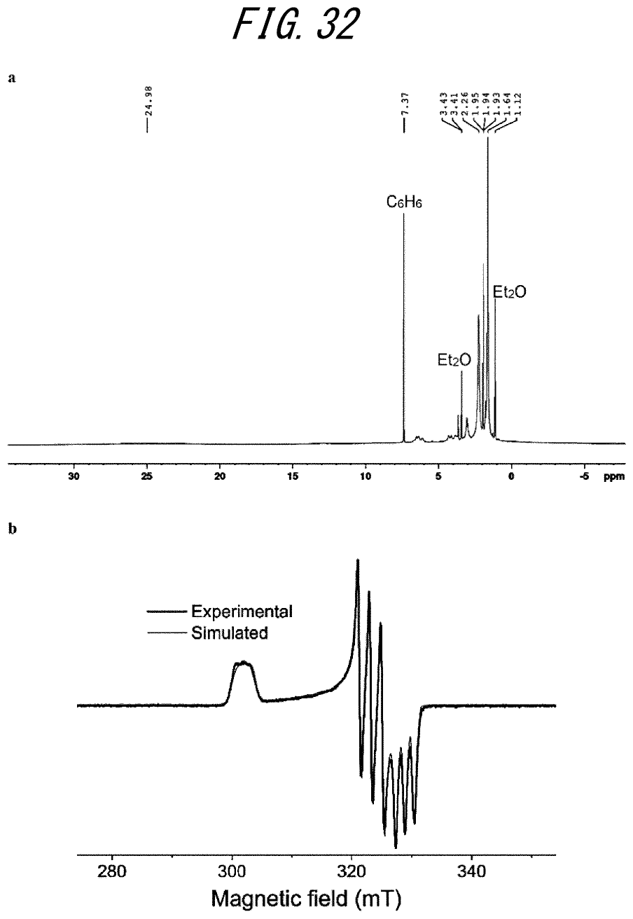

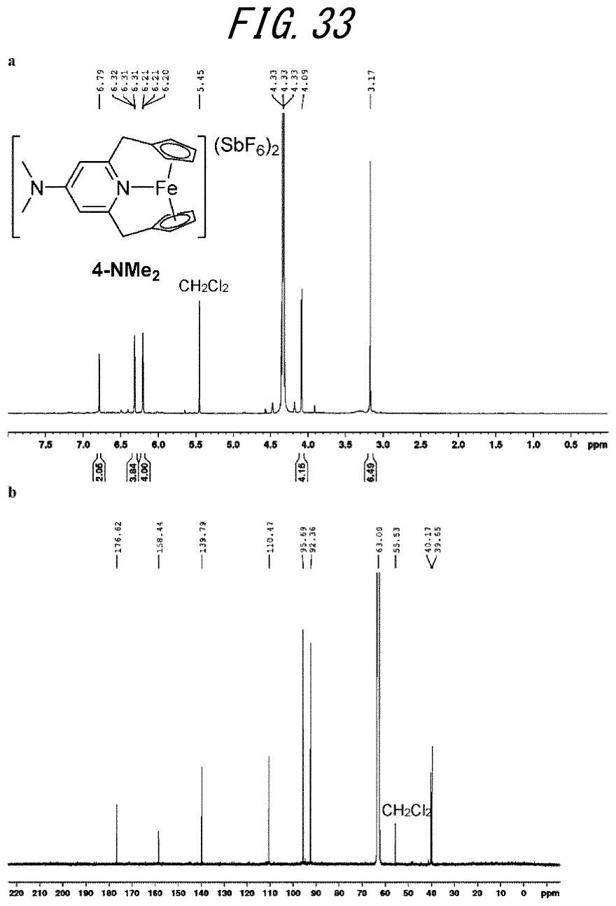

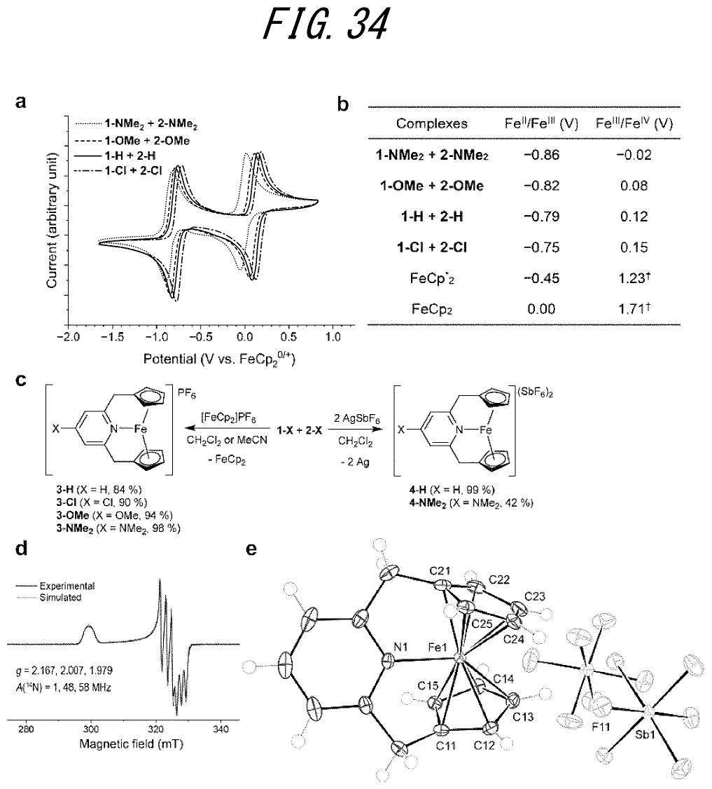

FIGS. 5-9 show ¹H, ¹³C{¹H}, ¹H-¹H COSY and ¹H-¹³C HSQC NMR, and FTIR data of 1.

¹H NMR (400.15 MHz, C₆D₆, 298 K): δ −260.2 (4H, Δv^{1/2}=1324.7 Hz, a signal from 3,4-position of C₅H₄ groups), −187.5 (4H, Δv^{1/2}=873.5 Hz, a signal from 2,5-position of C₅H₄ groups), 24.7 (1H, Δv^{1/2}=25.9 Hz, a signal from 4-position of pyridine ring), 74.9 (2H, Δv^{1/2}=49.6 Hz, a signal from 3,5-position of pyridine ring), 144.3 (4H, Δv^{1/2}=164.2 Hz, 2CH₂).

¹³C NMR (proton coupled) (125.76 MHz, C₆D₆, 298 K): δ −503.8 (br), 122.7 (br), 251.6 (d, ¹J_{CH}=159.7 Hz, a signal from 4-position of pyridine ring), 409.7 (d, ¹J_{CH}=159.7 Hz, a signal from 3,5-position of pyridine ring). Three ¹³C NMR signals are missing likely due to direct bonding of cyclopentadienyl group to paramagnetic Co.

Effective magnetic moment: μ_{eff} (Evans' method, C₆D₆, 298.1 K)=4.3 s. eff (VSM, 298.17 K)=3.99 s, Weiss constant (θ)=−7.69 K.

FTIR (Thin film, cm⁻¹): 1568 (w, C═C and C═N stretch), 1451 (m, sp³ C—H bending), 1413 (m, sp³ C—H bending), 1023 (m, sp² C—H bending), 758 (s, sp² C—H bending).

EPR (9.079 GHz, 2.5 mM toluene glass, 4.2 K): g₁, g₂, g₃=5.077, 3.172, 1.896. A₁, A₂, A₃ (⁵⁹Co)=205, 142, 293 MHz.

Elemental analysis: Calcd for C₁₇H₁₅NCo: C: 69.87, H: 5.17, N: 4.79. Found: C: 69.93, H: 5.21, N: 4.80.

HRMS (ESI/Orbitrap, [M]⁺): Calcd for C₁₇H₁₅NCo: 292.0531. Found: 292.0528.

Preparation of Partially Deuterated [Co(CpNCp)]-d₈ (1-d₈)

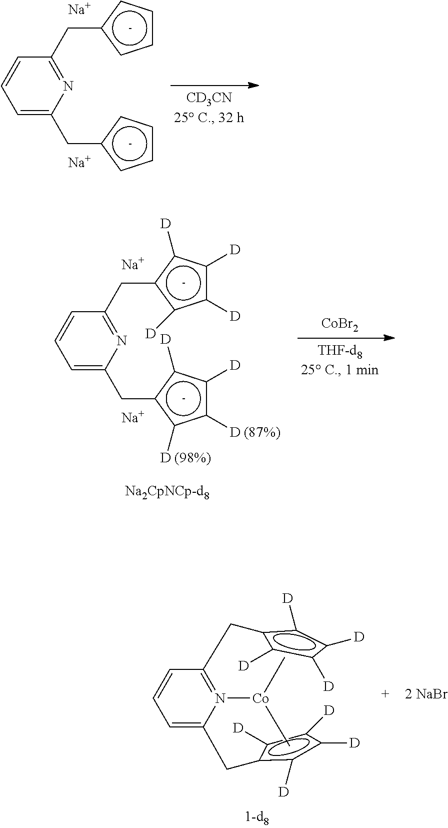

In a nitrogen glovebox, a J. Young NMR tube was charged with Na₂CpNCp (3.6 mg, 0.013 mmol) and 0.5 mL dry CD₃CN. The clear solution was then kept at 25° C., and progress of deuteration of cyclopentadienyl moiety was monitored by ¹H NMR. The deuteration of 2,5-position was faster than 3,4-position. Thus 2,5-position was deuterated 83%, whereas 3,4-position was deuterated 44% after 9 h. After 32 h, 2,5-position and 3,4-position of cyclopentadienyl groups were deuterated 98% and 87%, respectively. After 32 h, CD₃CN solvent was removed under vacuum and the product was dissolved in 0.5 mL dry THF-d₈. After this procedure extent of deuteration was changed slightly to 95% and 90% for 2,5-position and 3,4-position of cyclopentadienyl groups, respectively. To the solution was added a solid of CoBr₂ (3.4 mg, 0.016 mmol). The solution was shaken 1 min to obtain purple solution of crude product mixture. ¹H NMR of the crude mixture showed formation of 1-d₈ with deuteration of signals at −260.5 and −187.7 ppm. ¹H signals from cyclopentadienyl groups were assigned based on relative integration values of signals at −260.5 (3,4-position) and −187.7 (2,5-position) ppm, which was 0.67:1. Detection of deuterated signals by ²H NMR was not successful likely due to lower sensitivity of ²H NMR and broadening of signals at −260.5 and −187.7 ppm.

¹H NMR spectra of partially deuterated 1-d₈ was used for assignment of ¹H NMR signals from cyclopentadienyl groups.

Preparation of [Co(CpNCp)]-d₈ (1-d₈)

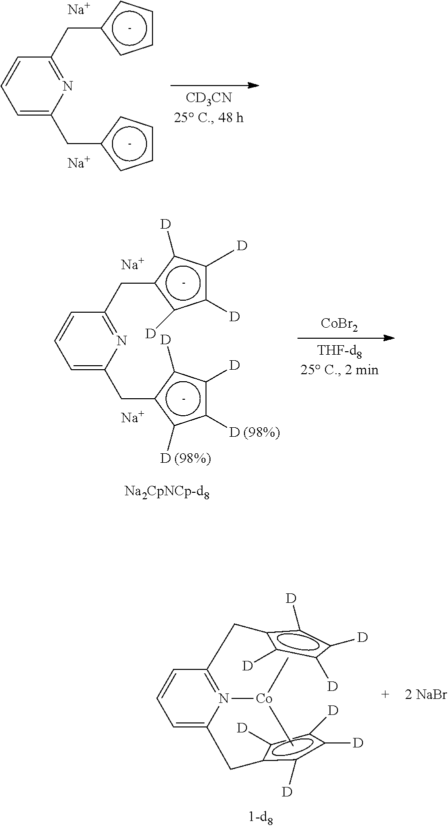

In a nitrogen glovebox, a 20 mL vial equipped with a stirring bar was charged with Na₂CpNCp (70.0 mg, 0.250 mmol) and 2.0 mL dry CD₃CN. The dark clear solution was then stirred at 25° C. for 48 h. After 48 h, aliquot of the solution was analyzed by ¹H NMR. ¹H NMR showed formation of Na₂CpNCp-d₈ with 98% deuteration at 2,5- and 3,4-positions of cyclopentadienyl groups.

HRMS (ESI/Orbitrap, [M+3H⁺-2Na⁻]⁺): Calcd for C₁₇H₁₀D₈N: 244.1936. Found: 244.1936.

CD₃CN solvent was removed under vacuum and the product was dissolved in 2 mL THF. Complete dissolution was not achieved and hence the solution was use as a suspension. In another 20 mL vial equipped with a stirring bar was added CoBr₂ (68.3 mg, 0.312 mmol) and 2 mL THF. A clear blue solution of CoBr₂ formed on stirring. To the stirred solution was added a suspension of Na₂(CpNCp)-d₈ dropwise for ca. 2 min. The vial containing Na₂(CpNCp)-d₈ was washed 3 times with 0.5 mL each of THF and the THF solution was added to the CoBr₂ solution. As soon as addition of Na₂(CpNCp)-d₈ was completed, 10 mL n-pentane was added to the solution to precipitate purple solid of byproducts, and the red-orange solution was filtered using plug of Celite, and the Celite was washed by 1:1 THF:pentane mixture. Concentration of combined solution gave red-orange crystals of 1-d₈. Yield: 36.4 mg, 48%.

### The Data for 1-d₈:

¹H NMR (400.15 MHz, C₆D₆, 298 K): δ 24.6 (1H, Δv^{1/2}=20.2 Hz, a signal from 4-position of pyridine ring), 74.6 (2H, Δv^{1/2}=44.4 Hz, a signal from 3,5-position of pyridine ring), 144.2 (4H, Δv^{1/2}=165.1 Hz, 2CH₂).

HRMS (ESI/Orbitrap, [M]⁺): Calcd for C₁₇H₇D₈NCo: 300.1033. Found: 300.1033.

The molecular structure of 1 in the crystal, obtained by precision high-resolution SC-XRD at 100 K with a reciprocal resolution sin (θmax=λ) of 1.26 angstrom⁻¹ and following multipole refinement42, supports the N-coordination of a pyridine moiety and η⁵-coordination mode of two Cp groups (FIG. 10 d). More specifically, the Co—N bond distance of 2.1998(3) angstrom is within the internuclear CoII-NPy distances in the neutral CoIIPNP pincer complexes, which are in the range from 1.974 to 2.343 angstrom.

The Co—C(Cp) distances are in the range from 2.2783(3) to 2.3292(2) angstrom with an average distance of 2.302 angstrom, and the Co-Cp centroid (Co-Cnt(Cp)) distances are 1.9607(2) and 1.9593(2) angstrom. These distances are significantly longer than those of cobaltocene (2.112 angstrom for the average of the libration-corrected Co—C(Cp) distances and ca. 1.722 angstrom for Co-Cnt(Cp)) and may indicate a weakening of the Co—C(Cp) interactions. The differences between the maximum and minimum Co—C(Cp) distances of 0.051 and 0.035 angstrom for the two Cp groups are similar to those of cobaltocene (0.033 angstrom).

The coordination mode of the Cp groups was further analyzed by the Cp ring slip parameters Δ and Ψ (FIG. 10 e). The Δ and Ψ values of complex 1 are among the smallest reported for Δ and Ψ and strongly support the η⁵-coordination mode of the two Cp groups. In comparison, the proposed 21-electron manganocene derivative, MnCp₂(dmpe), has a significantly larger deviation from the ideal η⁵-coordination mode (FIG. 10 e). The Δ and Ψ values derived from the gas-phase DFT calculations are in agreement with the experimental values, supporting that crystal packing effects are not essential for the η⁵-coordination (FIG. 10 e). The DFT optimized structure reproduces the equidistance of the Co—C(Cp) bonds with an average distance of 2.297(21) angstrom and a short Co—N distance of 2.2176 angstrom. Furthermore, the average Wiberg bond index for the Co—C(Cp) bonds of 0.15(2) is similar to that of cobaltocene (0.22(5)) as calculated at the same level of theory, and a practically uniform distribution of negative charges on the Cp rings was observed by the calculations.

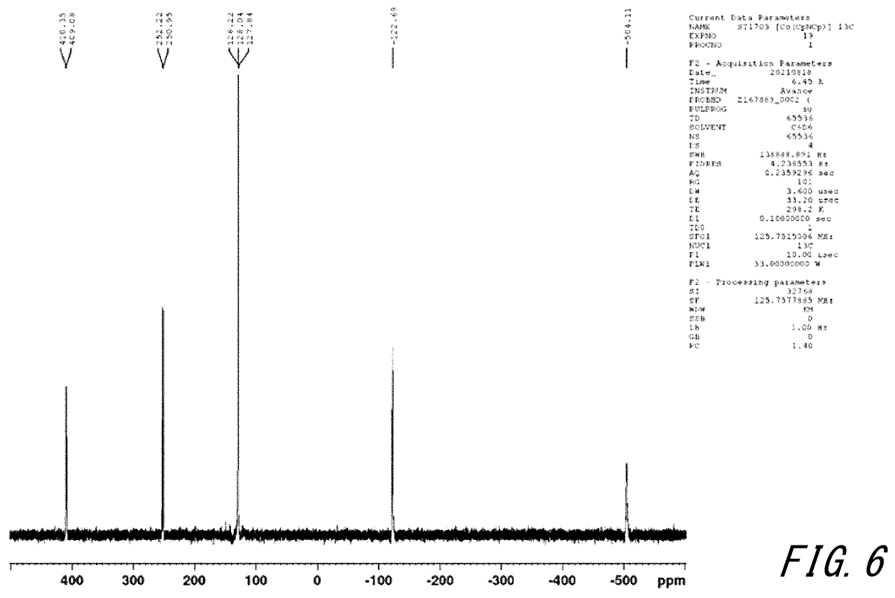

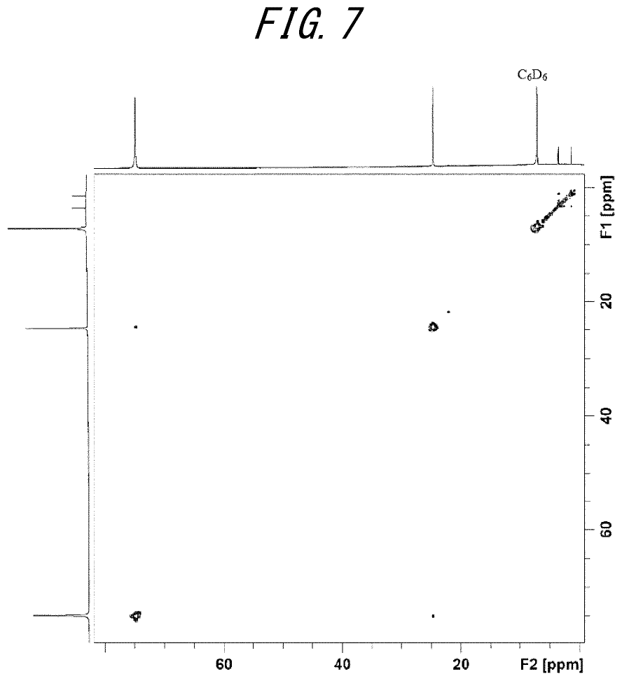

In solution, the ¹H NMR spectrum of 1 showed five signals between −260 and +144 ppm (FIG. 11 a). All the ¹H NMR signals were assigned based on selective deuteration of the Cp groups and two-dimensional NMR experiments (FIGS. 7, 8 and 9). The two broader signals at the higher field are from the Cp rings, and the three sharper signals at the lower field are from the pyridine ring and CH₂ groups of the CpNCp ligand. The ¹³C NMR spectrum shows four signals between −504 and +410 ppm (FIG. 6), and the signals are partially assigned based on two-dimensional NMR and the splitting pattern of the signals. Three ¹³C NMR signals are missing, most likely due to the close proximity of the Cp groups to the paramagnetic Co center.

Magnetic measurements conducted by the Evans NMR method (298 K, in C₆D₆) and VSM (298 K, bulk solid) showed that 1 has an effective magnetic moment μ_{eff} of 4.3 and 3.99 μ_{B} (μ_{B}: Bohr magneton) in solution and solid state, respectively, which indicates that 1 has the S=3/2 ground electron spin state. The S=3/2 ground electron spin state was further supported by continuous wave (cw)-EPR, where a large deviation of effective g-values from that of a free electron was observed due to the sizable zero-field splitting of the S=3/2 complex (FIG. 11 b). The EPR spectrum also clearly shows the presence of large ⁵⁹Co hyperfine splitting, which supports the presence of a cobalt-centered radical.

The presence of the Co—N bond in the frozen solution was supported by pulse-EPR measurements, which observed the electron spin echo envelope modulation (ESEEM) effects. The two-dimensional field-swept two-pulse and three-pulse ESEEM spectra observed at 4 K showed the nuclear modulation effects due to the N atom coupled with the Co atom, indicating the presence of bonding interaction between them. Furthermore, we applied four-pulse hyperfine sublevel correlation (HYSCORE) spectroscopy to measure the nuclear spins coupled with the Co atom. The HYSCORE spectrum (FIG. 11 c) showed the correlation peaks due to the ¹H and ¹⁴N atoms. The 1H-HYSCORE signals spreading over a frequency range of 3-4 MHz in the angular selective spectra were assigned to the protons belonging to the Cp groups. Based on the cw-EPR spectrum and the modulation effects, we determined spin-Hamiltonian parameters of 1 with S= 3/247 as well as fictitious S=½ (FIG. 11 b). The experimental tensors showed that the principal axis with the largest principal value of the ¹⁴N-hyperfine coupling (A) tensor coincides with that of the ⁵⁹Co-A tensor. This observation indicates the presence of electronic interaction between the Co and N atoms in the frozen solution.

The cyclic voltammogram of 1 showed reversible Co^{3+/2+} half-wave potential at −1.23 V (vs. FeCp₂^{+/0} in MeCN), which is 0.11 V higher or less negative than that of cobaltocene (FIG. 11 d). This change in the Co^{3+/2+} half-wave potential is not due to the introduction of the pyridinylmethyl group on each Cp ring, since such a substitution is expected to decrease the reduction potential by about 0.02 V. Thus, the N-coordination of the pyridine group unexpectedly increases the reduction potential of 1 despite the increase in formal electron count.

The experimental and computational studies strongly support the presence of the Co—N bond and two η⁵-coordinated Cp ligands, and together show that complex 1 is a formal 21-electron cobaltocene derivative (FIG. 12).

### Formation of [Co(CpNCp)]BF₄ (3) by Oxidation of 1

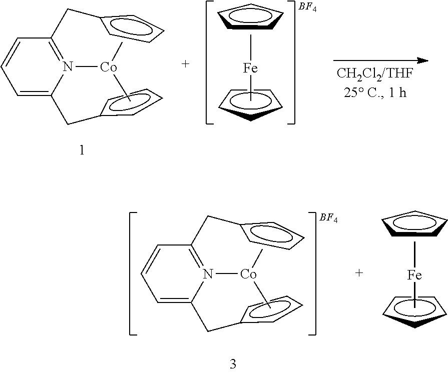

In a nitrogen glovebox, a 20 mL vial equipped with a Teflon coated stirring bar was charged with 1 (14.6 mg, 0.050 mmol), ferrocenium tetrafluoroborate (14.3 mg, 0.052 mmol) and 2 mL THF and 4 mL CH₂Cl₂. The solution was stirred at 25° C. for 10 min, and dark purple solution was obtained. The solution was filtered using plug of Celite, and the Celite was washed by CH₂Cl₂. The combined solution was concentrated to dryness, and a mixture of dark purple crystal of 3 and orange crystal of ferrocene was obtained. The solid was washed three times with diethyl ether, and then three times with THF and dried under vacuum. Yield: 18.2 mg, 100%. Broadening of ¹H signals or increase of effective magnetic moment due to formation of Co—N bond were not observed between −40 and 80° C.

FIGS. 13-18 show ¹H, ¹³C{¹H}, ¹H-¹⁵N HMBC, ¹⁹F, and ¹¹B NMR, and FTIR spectra of 3. FIG. 19 shows comparison of ¹H NMR spectra recorded at variable temperatures.

¹H NMR (500.13 MHz, CD₃CN, 298 K): δ 3.31 (4H, s, 2CH₂), 5.61 (4H, pseudo t with roofing, ³J_{HH}, ⁴J_{HH}=2.0, 2.4 Hz, 3,4-position of C₅H₄ groups), 5.64 (4H, pseudo t with roofing, ³J_{CH}, ⁴J_{CH}=2.0, 2.4 Hz, 2,5-position of C₅H₄ groups), 7.27 (2H, d, ³J_{HH}, =7.6 Hz, 3,5-position of pyridine ring), 7.72 (1H, d, ³J_{HH}, =7.6 Hz, 4-position of pyridine ring).

¹³C{¹H} NMR (125.76 MHz, CD₃CN, 298 K): δ 32.2 (s, CH₂), 77.0 (s, 3,4-position of C₅H₄ groups), 88.0 (s, 2,5-position of C₅H₄ groups), 120.9 (s, 3,5-position of pyridine ring), 123.4 (s, 1-position of C₅H₄ groups), 139.3 (s, 4-position of pyridine ring), 153.1 (s, 2,6-position of pyridine ring).

¹⁵N NMR (50.68 MHz, CD₃CN, 298 K, detected using ¹H-¹⁵N HMBC): δ 319.5 (s).

¹⁹F NMR (376.52 MHz, CD₃CN, 298 K): 6-151.76 (s, ¹⁰BF₄) and −151.82 (s, ¹¹BF₄) in ca. 2:8 integration ratio due to natural abundance of ¹⁰B and ¹¹B.

¹¹B NMR (128.38 MHz, CD₃CN, 298 K): 6-1.2 (s, BF₄).

Effective magnetic moment: μ_{eff} (Evans' method, CD₃CN, measured at 298 and 233 K)=0 μ_{B}.

FTIR (Thin film, cm⁻¹): 1592 (w, C═C and C═N stretch), 1581 (w, C═C and C═N stretch), 1463 (w, sp³ C—H bending), 1423 (w, sp³ C—H bending), 950-1150 (very strong, overlapping sp² C—H bending and B—F stretch), 866 (m, sp² C—H bending), 795 (m, sp² C—H bending).

Elemental analysis: Calcd: C: 53.87, H: 3.99, N: 3.70. Found: C: 54.22, H: 3.61, N: 3.79.

HRMS (ESI/Orbitrap, [M-BF₄]⁺): Calcd for C₁₇H₁₅NCo: 292.0531. Found: 292.0528.

The origin of the stability of 1 and the unexpected increase in the Co^{3+/2+} reduction potential were investigated by computational methods. Using DFT calculations, we were able to locate an isomer of 1 with an S=½ spin state in which the coordinate Co—N bond is broken, as a local minimum energy structure (1′, FIG. 20).

Preparation of [Co(CpNCp-NMe₂)](Co—NMe₂)

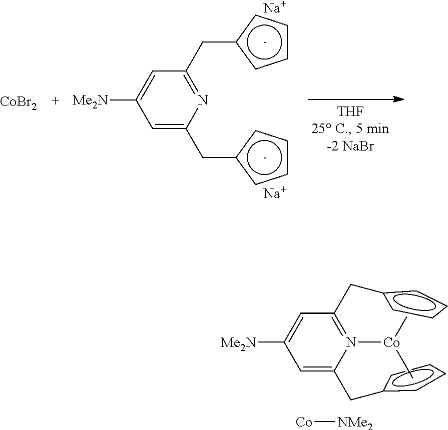

In a nitrogen glovebox, a 20 mL vial equipped with a Teflon-coated stirring bar was charged with CoBr₂ (22.8 mg, 0.10 mmol) and 4 mL THF. To the clear blue solution at 25° C. was then added NMe₂-CpNCpNa₂ (32.5 mg, 0.10 mmol) in 1 mL THF. The vial containing NMe₂-CpNCpNa₂ was washed two times with 0.5 mL each of THF and the THF solution was added to the solution of FeBr₂. After the addition, the brown suspension was stirred for 5 min and 6 mL n-pentane was added. The resulting red solution with grey precipitate was passed through a plug of Celite, and the Celite was washed three times with 1:1 THF:n-pentane mixture. The concentration of the combined THF/n-pentane solution gave a red-orange crystalline solid of Co—NMe₂. Yield: 19.2 mg, 57%. Consistent with the NMR analysis, SC-XRD measurement showed formation of the N-coordinated, formal 21-electron complex.

### The Data for Co—NMe₂:

¹H NMR (500.13 MHz, C₆D₆, 298 K): 6-255.7 (4H, Δv^{1/2}=1267 Hz, C₅H₄ groups), −185.2 (4H, Δv^{1/2}=870 Hz, C₅H₄ groups), 0.92 (6H, Δv^{1/2}=3.8 Hz, N(CH₃)₂), 81.5 (2H, Δv^{1/2}=76 Hz, 3,5-position of pyridine ring), 150.6 (4H, Δv^{1/2}=211, 2 CH₂). Assigned based on integration values and comparison to ¹H NMR spectra of previously reported S=3/2, Co(CpNCp-H) complex.

¹³C NMR (125.76 MHz, C₆D₆, 298 K): δ −498.3 (br), −176.7 (br), 60.4 (distorted q, ¹J_{C-H}=131.8 Hz, N(CH₃)₂), 284.5 (s), 358.3 (d, ¹J_{C-H}=152.7 Hz, pyridyl 2 CH). Other ¹³C NMR signals were not detectable.

FTIR (KBr pellet, cm⁻¹): 1610 (s, C═C and C═N stretch), 1536, 1417, 1383, 1024, 800, 752, 655.

HRMS (ESI/TOF, [M]⁺): Calcd for C₁₉H₂₀N₂Co₁: 335.0953. Found: 335.0966.

Preparation of [Co(CpNCp-NMe₂)]BF₄ ([Co—NMe₂]BF₄)

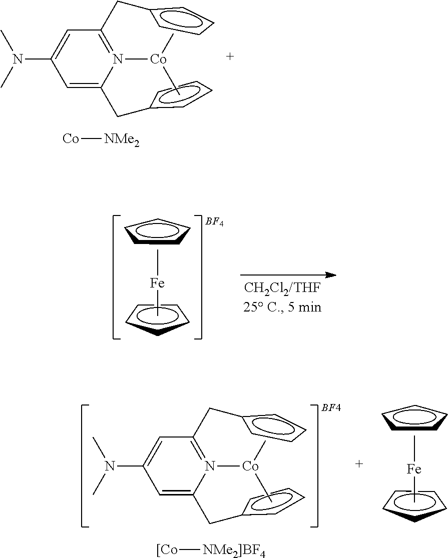

In a nitrogen glovebox, a 20 mL vial equipped with a Teflon coated stirring bar was charged with Co—NMe₂ (15.9 mg, 0.047 mmol), and 2 mL THF. To the clear red solution was then added ferrocenium tetrafluoroborate (13.1 mg, 0.048 mmol) using 4 mL CH₂Cl₂. The solution was stirred at 25° C. for 5 min, and dark purple solution was obtained. The solution was filtered using plug of Celite, and the Celite was washed by CH₂Cl₂. The combined solution was concentrated to dryness. The resulting solid was washed three times with n-pentane and dried under vacuum. Yield: 20.2 mg, 100%. Consistent with the NMR analysis, SC-XRD measurement showed formation of the N-noncoordinated, formal 18-electron complex.

### The Data for 3:

¹H NMR (500.13 MHz, CD₃CN, 298 K): δ 3.02 (6H, s, 2NCH₃), 3.10 (4H, s, 2CH₂), 5.55 (4H, broad pseudo t, 3,4-position of C₅H₄ groups), 5.60 (4H, pseudo t with roofing, ³J_{CH}, ⁴J_{CH}=2.0 Hz, 2,5-position of C₅H₄ groups), 6.53 (2H, s, 3,5-position of pyridine ring).

¹³C{¹H} NMR (125.76 MHz, CD₃CN, 298 K): δ 32.6 (s, 2CH₂), 39.9 (s, 2NCH₃), 76.7 (s, 3,4-position of C₅H₄ groups), 87.6 (s, 2,5-position of C₅H₄ groups), 103.6 (s, 3,5-position of pyridine ring), 125.4 (s, 1-position of C₅H₄ groups), 155.2 (s, 2,6-position of pyridine ring), 157.9 (s, 4-position of pyridine ring).

¹⁵N NMR (50.68 MHz, CD₃CN, 298 K, detected using ¹H-¹⁵N HMBC): δ 58.3 (s, N(CH₃)₂), 282.3 (s, pyridine N).

FTIR (Thin film, cm⁻¹): 1597 (s, C═C and C═N stretch), 1053 (very strong, overlapping sp² C—H bending and B—F stretch), 850 (m, sp² C—H bending).

HRMS (ESI/TOF, [M]⁺): Calcd for C₁₉H₂₀N₂Co₁: 335.0953. Found: 335.0961.

### Example 2

### Preparation of the Paramagnetic Complexes

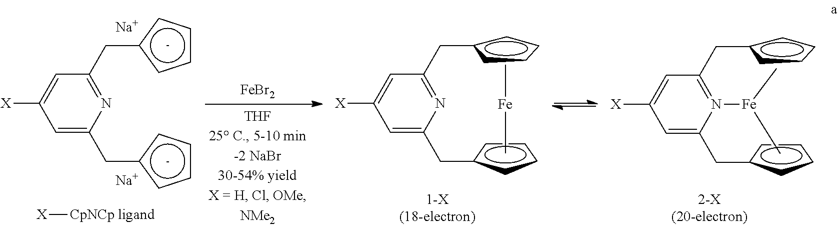

The paramagnetic complexes were prepared as follows, and the paramagnetic complexes were characterized by a number of methods.

### <Preparation of Intermediates>

### Preparation of 2,6-bis(methylenecyclopentadienyl)pyridine disodium salt (H-CpNCpNa₂)

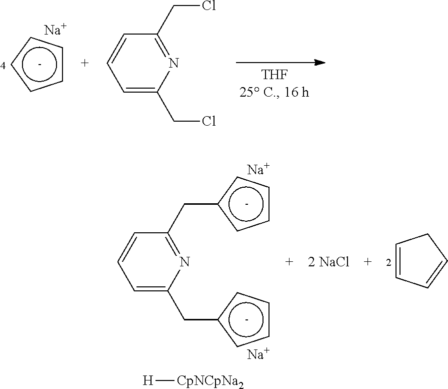

2,6-bis(methylenecyclopentadienyl)pyridine disodium salt, H-CpNCpNa₂, was prepared as follows and crystalized from concentrated THE solution at −35° C. A 20 mL vial equipped with a Teflon coated stirring bar was charged with NaCp (4.71 mL, 2.55 M THE solution, 12.0 mmol).

2,6-bis(chloromethyl)pyridine (528.1 mg, 3.00 mmol) in 6 mL THF was added to the vial dropwise for about 5 min. The solution warmed up to about 50° C. due to the exothermic reaction and white precipitate of NaCl formed. The mixture was stirred for 16 h at 25° C. The resulting yellow solution and white precipitate was filtered using a plug of Celite. The Celite was washed three times with 1 mL each of THF, and the filtered pink solution was concentrated under vacuum. White crystalline solid of the product formed on the glass wall upon concentration to about 2 mL. More product precipitated from the concentrated solution upon storing the solution at −35° C. for overnight. The red-orange supernatant was decanted and the remaining solid was washed three times with cold diethyl ether to remove unreacted NaCp and orange colored material. The resulting white solid was dried overnight under high vacuum (<0.2 mmHg) to remove coordinated THE molecules. Yield: 528.4 mg, 63%.

¹H NMR (500.13 MHz, THF-d₈, 298 K): δ 3.93 (4H, s, 2CH₂), 5.34 (4H, pseudo t, 2,5-position of C₅H₄ groups), 5.52 (4H, pseudo t, 3,4-position of C₅H₄ groups), 6.89 (2H, d, 3 J_{HH}, =7.5 Hz, 3,5-position of pyridine ring), 7.40 (1H, d, 3 J_{HH}, =7.5 Hz, 4-position of pyridine ring).

### Preparation of 4-chloro-2,6-bis(methylenecyclopentadienyl)pyridine disodium salt (Cl-CpNCpNa₂)

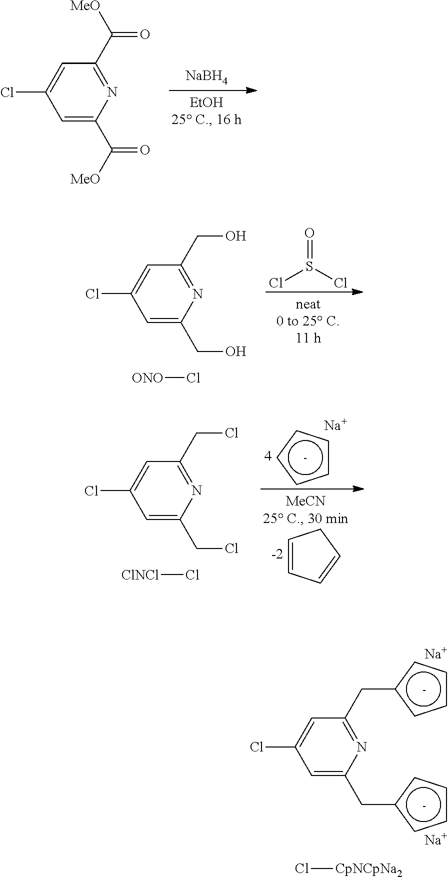

### Preparation of ONO—Cl:

A 50 mL round bottom flask equipped with a Teflon-coated magnetic stirring bar was charged with 4-chloro-2,6-pyridinedicarboxylic acid dimethyl ester (2.3026 g, 10.0 mmol, purchased from BLD Pharm) and 40 mL 99% ethanol. NaBH₄ (1.58 g, 41.8 mmol) was added to the flask at 25° C. under air. This exothermic reaction generates a large amount of H₂, so the addition of NaBH₄ should be done portion-wise in a fume hood. The solution was stirred for 16 h at 25° C. The initial red solution became a yellow solution after 16 h. The reaction was quenched by the addition of 5 mL water at 0° C. The solution was concentrated to dryness and about 50 mL of sat. Na₂CO₃ was added to the flask. The flask was equipped with a condenser, and the solution was heated at 100° C. for 1 h. The resulting biphasic mixture was extracted using EtOAc, and the EtOAc solution was dried by MgSO₄, and MgSO₄ was filtered out. The concentration of EtOAc solution gave a faint yellow solid of ONO—Cl. Yield: 1.5779 g, 91%. NMR spectra of ONO—Cl matched with the known values.

¹H NMR (400.15 MHz, CD₃OD, 298 K): δ 4.66 (4H, s, 2CH₂), 7.45 (2H, s, 3,5-position of pyridine ring).

### Preparation of ClNCl—Cl:

A 250 mL round bottom flask equipped with a Teflon-coated magnetic stirring bar was charged with ONO—Cl (1.576 g, 9.09 mmol). 12 mL thionyl chloride was added to the flask at 0° C. under air, and the solution was stirred for 11 h at 25° C. The reaction was quenched by slow addition of 20 mL water (CAUTION: exothermic reaction with a formation of HCl gas) at 0° C. followed by slow addition of sat. Na₂CO₃ (CAUTION: exothermic reaction with a formation of CO₂ gas) until the evolution of CO₂ stopped and the solution became basic. The resulting floating white solid was filtered and washed three times with water and dried in a desiccator. Yield: 1.7644 g, 92%. NMR spectra of ClNCl—Cl matched with the known values.

¹H NMR (400.15 MHz, CDCl₃, 298 K): δ 4.63 (4H, s, 2CH₂), 7.47 (2H, s, 3,5-position of pyridine ring).

### Preparation of Cl-CpNCpNa₂:

In a nitrogen glovebox, a 20 mL vial equipped with a Teflon-coated stirring bar was charged with 1.5 M NaCp (1.4 mL in MeCN, 2.1 mmol) and 2 mL MeCN. ClNCl—Cl (105.5 mg, 0.501 mmol) in 2 mL MeCN was added to the solution dropwise for 5 min, the vial containing ClNCl—Cl was washed with 1 mL MeCN, and the MeCN solution was added to the reaction mixture. The solution was stirred at 25° C. for 30 min. The reaction mixture was passed through a plug of Celite using MeCN, and the resulting yellow solution was concentrated to produce a yellow oil. Addition of ether to the oil formed a small amount of white precipitate. The addition of n-pentane to the ether solution gave more off-white solid. The solid was decanted and washed three times with 1:1 n-pentane:ether mixture and dried. Yield: 111.9 mg, 58% (contains a molecule of THF).

The data for Cl-CpNCpNa₂:

¹H NMR (500.13 MHz, THF-d₈, 298 K): δ 3.91 (4H, s, 2CH₂), 5.34 (4H, broad pseudo t, 2,5-position of C₅H₄ groups), 5.52 (4H, broad m, 3,4-position of C₅H₄ groups), 7.00 (2H, s, 3,5-position of pyridine ring).

¹³C{¹H} NMR (125.76 MHz, THF-d₈, 298 K): δ 38.7 (s, CH₂), 102.4 (s, 3,4-position of C₅H₄ groups), 103.4 (s, 2,5-position of C₅H₄ groups), 113.8 (s, 1-position of C₅H₄ groups), 118.8 (s, 3,5-position of pyridine ring), 143.2 (s, 4-position of pyridine ring), 167.2 (s, 2,6-position of pyridine ring).

¹⁵N NMR (50.68 MHz, THF-d₈, 298 K, detected using ¹H-¹⁵N HMBC): δ 294.3 (s). HRMS (ESI/TOF, [M+3H]⁺): Calcd for C₁₇H₁₇N₁Cl₁: 270.1044. Found: 270.1037.

### Preparation of 4-methoxy-2,6-bis(methylenecyclopentadienyl)pyridine disodium salt (OMe-CpNCpNa₂)

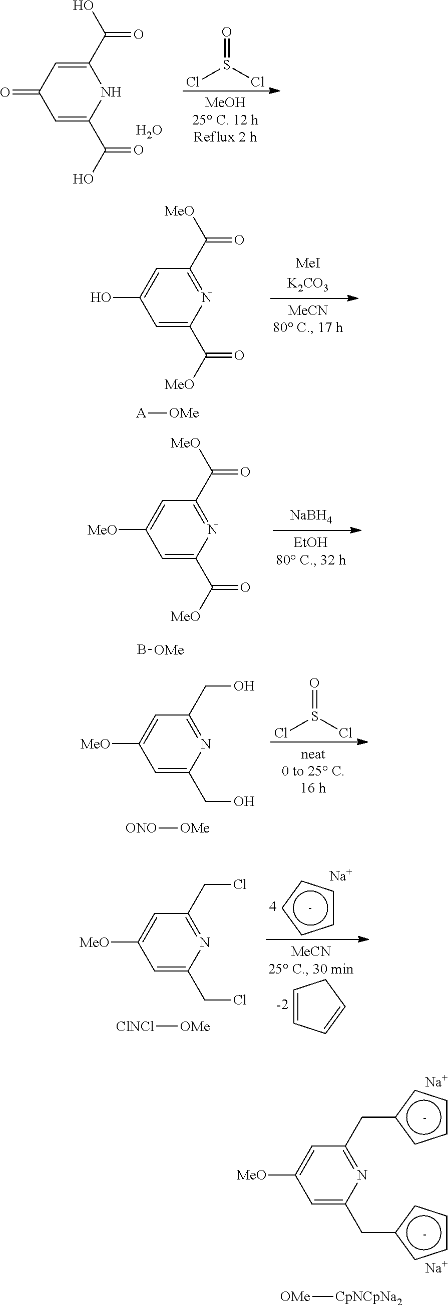

### Preparation of B—OMe:

B—OMe was prepared as follows.

A 100 mL round bottom flask equipped with a Teflon-coated magnetic stirring bar was charged with Chelidamic acid hydrate (4.0195 g, 19.9 mmol, purchased from BLD Pharm) and 40 mL methanol. 11.4 mL thionyl chloride was added dropwise to the flask at 0° C. under air, and the solution was stirred for 12 h at 25° C. The solution was refluxed for 2 h under air, cooled down to r.t., and concentrated to dryness. A dark brown solid was obtained. ¹H NMR (in DMSO-d₆) spectrum of the solid showed clean formation of A-OMe.

¹H NMR (400.15 MHz, DMSO-d₆, 298 K): δ 3.87 (6H, s, 2 COOCH₃), 7.60 (2H, s, 3,5-position of pyridine ring), OH signal merged with a water peak.

K₂CO₃ (6.91 g, 50.0 mmol), Mel (5 mL, 80 mmol), and 50 mL MeCN were then added to the flask. The solution was stirred for 17 h at 80° C. and cooled to r.t. Solid byproducts were removed by vacuum filtration. The brown solution was extracted using dichloromethane/water to remove KI, the dichloromethane layer was dried by MgSO₄, and MgSO₄ was removed by filtration. The concentration of the dichloromethane solution gave a brown solid of B—OMe. Yield: 4.3628 g, 97% (two steps). ¹H NMR (in CDCl₃) spectrum showed clean formation of B—OMe₂.

¹H NMR (500.13 MHz, CDCl₃, 298 K): δ 3.98 (3H, s, OCH₃), 4.02 (6H, s, 2 COOCH₃), 7.60 (2H, s, 3,5-position of pyridine ring), OH signal merged with a water peak.

### Preparation of ONO—OMe:

ONO—OMe was prepared using as follows.

A 50 mL round bottom flask equipped with a Teflon-coated magnetic stirring bar was charged with B—OMe (4.3633 g, 19.4 mmol), NaBH₄ (2.93 g, 77 mmol), and 50 mL 99% ethanol at 25° C. under air. The solution was stirred for 12 h at 80° C. GC-MS analysis of the crude mixture showed presence of ONO—OMe and a partially hydrogenated product. NaBH₄ (2.99 g, 79 mmol) was added to the flask and the solution was stirred for 24 h at 80° C. The reaction was quenched by the addition of about 10 mL sat. Na₂CO₃. The solution was concentrated to dryness and the solid was extracted using EtOAc, and the EtOAc solution was dried by MgSO₄, and MgSO₄ was filtered out. The concentration of EtOAc solution gave a faint yellow solid of ONO—OMe. Yield: 2.49 g, 76%.

¹H NMR (400.15 MHz, CD₃OD, 298 K): δ 3.90 (3H, s, OCH₃), 4.62 (4H, s, 2 CH₂), 6.98 (2H, s, 3,5-position of pyridine ring).

### Preparation of ClNCl—OMe:

A 1 L round bottom flask equipped with a Teflon-coated magnetic stirring bar was charged with ONO—OMe (2.49 g, 14.7 mmol). 20 mL thionyl chloride was added to the flask at 0° C. under air, and the solution was stirred for 16 h at 25° C. The reaction was quenched by the slow addition of 20 mL water (CAUTION: exothermic reaction with a formation of HCl gas) at 0° C. followed by slow addition of sat. Na₂CO₃ (CAUTION: exothermic reaction with a formation of CO₂ gas) until the evolution of CO₂ stopped and the solution became basic. The resulting floating white solid was filtered and washed three times with water and dried in a desiccator. Yield: 2.2528 g, 74%. NMR spectra of ClNCl—OMe matched with the known values.

¹H NMR (500.13 MHz, CDCl₃, 298 K): δ 3.90 (3H, s, CH₃), 4.61 (4H, s, 2CH₂), 7.00 (2H, s, 3,5-CH of the pyridine ring).

¹³C{¹H} NMR (125.76 MHz, CDCl₃, 298 K): δ 46.6 (s, CH₂), 55.6 (s, CH₃), 108.3 (s, 3,5-CH of the pyridine ring), 158.1 (s, 2,6-C of the pyridine ring), 167.6 (s, 4-C of the pyridine ring).

HRMS (ESI/Orbitrap, [M+H]⁺): Calcd for C₈H₁₀NOCl₂: 206.0134. Found: 206.0130.

### Preparation of OMe-CpNCpNa₂:

In a nitrogen glovebox, a 20 mL vial equipped with a Teflon-coated stirring bar was charged with 2.4 M NaCp (1.7 mL in THF, 4.08 mmol) and 4 mL MeCN. ClNCl—OMe (206.7 mg, 1.00 mmol) in 3 mL MeCN was added to the solution dropwise for 5 min, and the vial containing ClNCl—OMe was washed with 1 mL MeCN and the MeCN solution was added to the reaction mixture. The solution was stirred at 25° C. for 30 min. The reaction mixture was passed through a plug of Celite using MeCN, and the resulting yellow solution was concentrated to produce purple oil. The oil was washed with 4 mL ether three times and dried. Yield: 283.5 mg, 71%.

### The Data for OMe-CpNCpNa₂:

¹H NMR (500.13 MHz, THF-d₈, 298 K): δ 3.79 (3H, OMe), 3.86 (4H, s, 2CH₂), 5.31 (4H, pseudo t, 2,5-position of C₅H₄ groups), 5.48 (4H, pseudo t, 3,4-position of C₅H₄ groups), 6.50 (2H, s, 3,5-position of pyridine ring).

¹³C{¹H} NMR (125.76 MHz, THF-d₈, 298 K): δ 40.0 (s, CH₂), 55.1 (s, OMe), 103.1 (s, 3,4-position of C₅H₄ groups), 104.4 (s, 2,5-position of C₅H₄ groups), 105.7 (s, 3,5-position of pyridine ring), 115.6 (s, 1-position of C₅H₄ groups), 167.0 (s, 4-position of pyridine ring), 167.6 (s, 2,6-position of pyridine ring).

¹⁵N NMR (50.68 MHz, THF-d₈, 298 K, detected using ¹H-¹⁵N HMBC): δ 277.8 (s). HRMS (ESI/TOF, [M+3H]⁺): Calcd for C₁₈H₂₀N₁O₁: 266.1539. Found: 266.1535.

### Preparation of 4-methoxy-2,6-bis(methylenecyclopentadienyl)pyridine disodium salt (NMe₂-CpNCpNa₂)

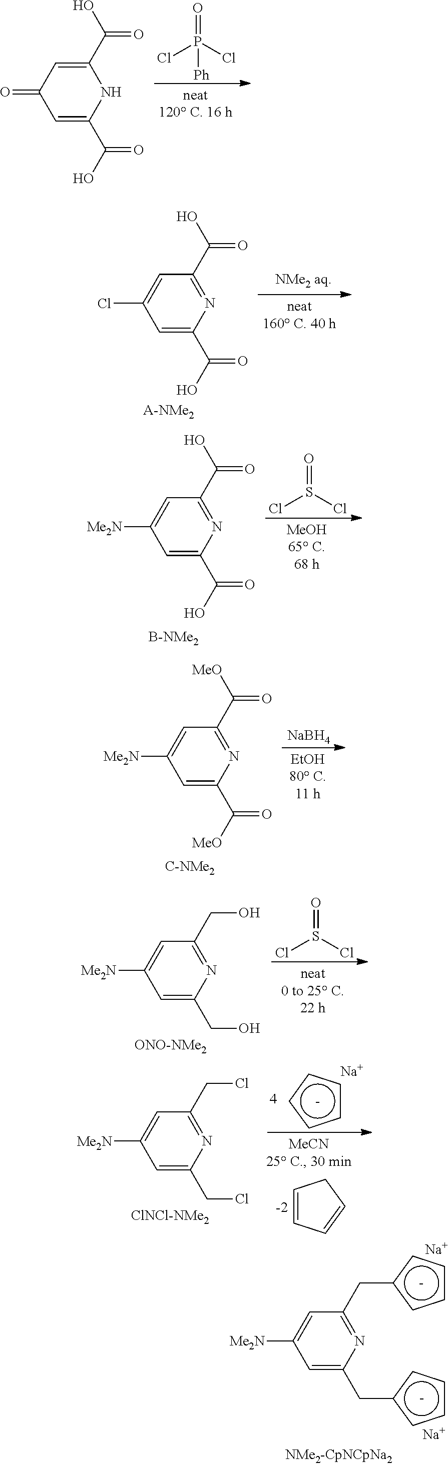

Preparation of A-NMe₂ and B—NMe₂:

A 100 mL round bottom flask was charged with chelidamic acid (5.01 g, 27.4 mmol, BLD Pharm) and PPhOCl₂ (11 mL, 78 mmol). The solution was heated at 120° C. for 16 h. The solution was cooled to 0° C. and water was added to form a chunk of solid. The solid was filtered and washed three times with water and then three times with dichloromethane. 1H NMR analysis showed formation of A-NMe₂.

¹H NMR of A-NMe₂ (400.15 MHz, DMSO-d₆, 298 K): δ 8.24 (2H, s, 3,5-CH of the pyridine ring), COOH signal merged with a water signal.

The solid was charged in a 90 mL Fisher-Porter tube and 16 mL 50% NMe₂H was added to the tube. The tube was sealed and the solution was heated at 160° C. for 40 h. The clear brown solution was transferred to a 200 mL Erlenmeyer flask and acidified by 2 mL H₂SO₄. The brown precipitate was filtered, washed with water and dichloromethane, and dried overnight. Two-step yield: 72%.

¹H NMR of B—NMe₂ (400.15 MHz, DMSO-d₆, 298 K): δ 3.29 (6H, s, NMe₂), 7.43 (2H, s, 3,5-CH of the pyridine ring), COOH signal merged with a water signal.

### Preparation of C—NMe₂:

A 100 mL round bottom flask equipped with a Teflon-coated magnetic stirring bar was charged with B—NMe₂ (2.7025 g, 12.85 mmol) and 30 mL methanol. 7.5 mL thionyl chloride was added to the flask at 0° C. under air dropwise, and the solution was stirred for 68 h at 65° C. The reaction was quenched by the slow addition of 20 mL water (CAUTION: exothermic reaction with a formation of HCl gas) at 0° C. followed by slow addition of sat. Na₂CO₃ (CAUTION: exothermic reaction with a formation of CO₂ gas) until the evolution of CO₂ stopped and the solution became basic. The resulting white solid was filtered and washed three times with water and dried in a desiccator. Yield: 1.7297 g, 56%. NMR spectra of C—NMe₂ matched with the known values.

¹H NMR (500.13 MHz, CDCl₃, 298 K): δ 3.13 (6H, s, NMe₂), 3.99 (6H, s, 2 COOCH₃), 7.51 (2H, s, 3,5-CH of the pyridine ring).

### Preparation of ONO—NMe₂:

A 250 mL round bottom flask equipped with a Teflon-coated magnetic stirring bar was charged with C—NMe₂ (2.2794 g, 9.57 mmol) and 40 mL 99% ethanol. NaBH₄ (1.45 g, 38.3 mmol) was added to the flask at 25° C. under air. The solution was stirred for 11 h at 80° C. The clear orange-red solution formed after 11 h. The reaction was quenched by the addition of 2 mL water at 0° C. The solution was concentrated to dryness, and about 30 mL sat. Na₂CO₃ was added to the flask. The flask was equipped with a condenser, and the solution was heated at 100° C. for 2 h. The resulting biphasic mixture was extracted using EtOAc, and the EtOAc solution was dried by MgSO₄, and MgSO₄ was filtered out. The concentration of EtOAc solution gave a colorless oil of ONO—NMe₂, which solidified upon keeping it in a −20° C. freezer. Yield: 1.4846 g, 85%.

### The Data for ONO—NMe₂:

¹H NMR (500.13 MHz, CDCl₃, 298 K): δ 3.03 (6H, s, NMe₂), 4.65 (4H, s, 2CH₂), 6.37 (2H, s, 3,5-CH of the pyridine ring).

¹³C{¹H} NMR (125.76 MHz, CDCl₃, 298 K): δ 39.5 (s, NMe₂), 64.6 (s, CH₂), 102.0 (s, 3,5-CH of the pyridine ring), 158.4 (s, 2,6-C of the pyridine ring), 155.8 (s, 4-C of the pyridine ring).

### Preparation of ClNCl—NMe₂:

A 250 mL round bottom flask equipped with a Teflon-coated magnetic stirring bar was charged with ONO—NMe₂ (1.4846 g, 8.15 mmol). 10 mL thionyl chloride was added to the flask at 0° C. under air, and the solution was stirred for 22 h at 25° C. The reaction was quenched by slow addition of 10 mL water (CAUTION: exothermic reaction with a formation of HCl gas) at 0° C. followed by the slow addition of sat. Na₂CO₃ (CAUTION: exothermic reaction with a formation of CO₂ gas) until the evolution of CO₂ stopped and the solution became basic. The resulting floating white solid was filtered and washed three times with water and dried in a desiccator. Yield: 1.6303 g, 91%.

### The Data for ClNCl—NMe₂:

¹H NMR (500.13 MHz, CDCl₃, 298 K): δ 3.05 (6H, s, NMe₂), 4.56 (4H, s, 2CH₂), 6.61 (2H, s, 3,5-CH of the pyridine ring).

¹³C{¹H} NMR (125.76 MHz, CDCl₃, 298 K): δ 39.5 (s, NMe₂), 47.4 (br s, CH₂), 104.8 (s, 3,5-CH of the pyridine ring), 156.1 (s, 4-C of the pyridine ring), 156.7 (s, 2,6-C of the pyridine ring).

HRMS (ESI/Orbitrap, [M+H]⁺): Calcd for C₉H₁₃N₂Cl₂: 219.0450. Found: 219.0447.

Preparation of NMe₂-CpNCpNa₂:

In a nitrogen glovebox, a 20 mL vial equipped with a Teflon-coated stirring bar was charged with 1.5M NaCp (1.4 mL in MeCN, 2.1 mmol) and 2 mL MeCN. ClNCl—NMe₂ (109.6 mg, 0.500 mmol) in 2 mL MeCN was added to the solution dropwise for 5 min, and the vial containing ClNCl—NMe₂ was washed by 1 mL MeCN and the MeCN solution was added to the reaction mixture. The solution was stirred at 25° C. for 30 min. The reaction mixture was passed through a plug of Celite using MeCN and the resulting colorless solution was concentrated to give a white solid and colorless oil. The addition of 6 mL ether to the oil formed a pink solid. The solid was decanted and washed once with 6 mL ether and dried. Yield: 149.8 mg, 85% (contains 0.5 equiv. of ether).

The Data for NMe₂-CpNCpNa₂:

¹H NMR (500.13 MHz, THF-d₈, 298 K): δ 2.96 (6H, s, NMe₂), 3.79 (4H, s, 2CH₂), 5.32 (4H, pseudo t, 2,5-position of C₅H₄ groups), 5.48 (4H, pseudo t, 3,4-position of C₅H₄ groups), 6.24 (2H, s, 3,5-CH of the pyridine ring).

¹³C{¹H} NMR (125.76 MHz, THF-d₈, 298 K): δ 39.3 (s, NMe₂), 40.3 (s, CH₂), 102.98 (s, 3,4-position of C₅H₄ groups), 103.0 (s, 3,5-CH of the pyridine ring), 104.3 (s, 2,5-position of C₅H₄ groups), 116.3 (s, 1-position of C₅H₄ groups), 156.0 (s, 4-CH of the pyridine ring), 166.0 (s, 2,6-CH of the pyridine ring).

¹⁵N NMR (50.68 MHz, 4:1 toluene-d₈:THF-d₈, 233 K, detected using ¹H-¹⁵N HMBC): δ 51.7 (s, NMe₂), 261.5 (s, pyridyl N).

HRMS (ESI/Orbitrap, [M+3H]⁺): Calcd for C₁₉H₂₃N₂: 279.1856. Found: 279.1825.

### <Preparation and Reactivity of Complexes>

### Preparation of [Fe(H-CpNCp)](1-H)

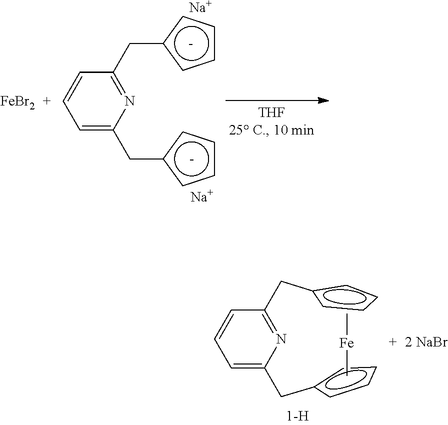

In a nitrogen glovebox, a 20 mL vial equipped with a Teflon-coated stirring bar was charged with FeBr₂ (220.6 mg, 1.05 mmol) and 10 mL THF. The solution was heated intermittently with a heat gun until a clear orange solution was obtained. A solid of H-CpNCpNa₂ (281.3 mg, 1.01 mmol) was added portion wise to the solution for about 10 min at 25° C. We added H-CpNCpNa₂ as a solid due to the low solubility of H-CpNCpNa₂ in THF. As soon as the addition of H-CpNCpNa₂ was completed, 4 mL n-pentane was added to the solution, and the resulting precipitate was removed by passing through a plug of Celite, and Celite was washed three times with ether, and the ether solution was combined to obtain dark red solution. The solution was concentrated to dryness, and the solid was extracted using ether and the ether solution was passed through a plug of Celite. The concentration of the ether solution gave dark red-brown crystals of 1-H. Yield: 158.2 mg, 54%.

FIGS. 21-27 show ¹H, ¹³C{¹H}, and ¹H-¹⁵N HMBC NMR, FTIR, VSM, and UV-Vis data of 1-H.

### The Data for 1-H:

¹H NMR (500.13 MHz, toluene-d₈, 233 K): δ 2.88 (4H, s, 2CH₂), 3.93 (4H, br s, 3,4-position of C₅H₄ groups), 4.14 (4H, br s, 2,5-position of C₅H₄ groups), 6.48 (2H, d, ³J_{HH}, =7.5 Hz, 3,5-position of pyridine ring), 6.86 (1H, d, ³J_{HH}, =7.5 Hz, 4-position of pyridine ring).

¹H NMR (500.13 MHz, toluene-d₈, 423 K under 5 bar N₂): δ −24.9 (4H, Δv^{1/2}=2871 Hz, a signal from C₅H₄ groups), −10.1 (4H, Δv^{1/2}=828 Hz, a signal from C₅H₄ groups), 3.00 (1H, Δv^{1/2}=72.5 Hz, a signal from 4-position of pyridine ring), 14.6 (2H, Δv^{1/2}=244 Hz, a signal from 3,5-position of pyridine ring), 18.7 (4H, Δv^{1/2}=887 Hz, 2CH₂).

¹³C{¹H} NMR (125.76 MHz, toluene-d₈, 233 K): δ 33.6 (s, 2CH₂), 63.7 (s, 3,4-position of C₅H₄ groups), 71.3 (s, 2,5-position of C₅H₄ groups), 106.8 (s, 1-position of C₅H₄ groups), 117.7 (s, 3,5-position of pyridine ring), 133.8 (s, 4-position of pyridine ring), 165.8 (s, 2,6-position of pyridine ring).

¹⁵N NMR (50.68 MHz, toluene-d₈, 233 K, detected using ¹H-¹⁵N HMBC): δ 337.7 (s).

Effective magnetic moment: μ_{eff} (Evans' method, toluene-d₈, without considering thermal change of solvent density)=0.69 (233 K), 0.86 (298 K), 1.8 (403 K) μ_{B}. μ_{eff} (VSM, bulk solid, 298.13 K)=0 μ_{B}.

FTIR (Thin film, cm⁻¹): 1576 (w, C═C, and C═N stretch), 1453 (m, sp³ C—H bending), 1032 (m, sp² C—H bending), 1015 (m, sp² C—H bending), 807 (s, sp² C—H bending), 758 (s, sp² C—H bending).

UV-Vis (THF, 25° C.): kmₐₓ=258 nm (E=6600 M⁻¹ cm⁻¹), 383 nm (E=900 M⁻¹ cm⁻¹).

EPR (9.079 GHz, 2.5 mM toluene glass, 4.2 K): No detectable signal from the sample.

XPS (298 K): 707.6 eV (Fe 2p^{3/2}), 720.4 eV (Fe 2p^{1/2}).

Elemental analysis: Calcd: C: 70.61, H: 5.23, N: 4.84. Found: C: 70.63, H: 5.01, N: 4.75.

HRMS (ESI/TOF, [M]⁺): Calcd for C₁₇H₁₅N₁Fe₁: 289.0548. Found: 289.0542.

Preparation of [Fe(H-CpNCp-d₈)] (1-H-d₈)

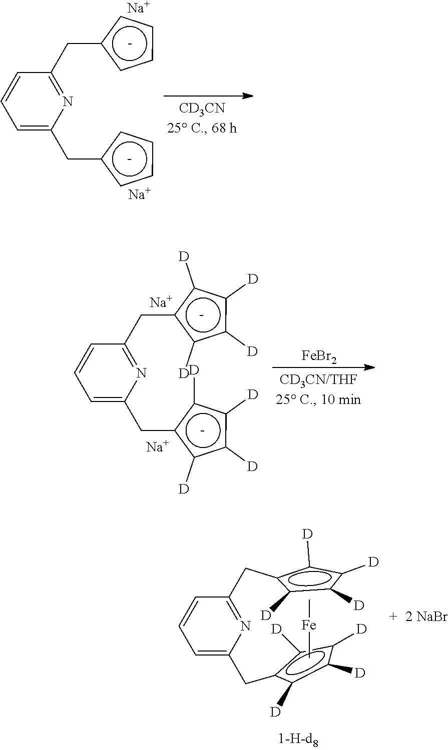

In a nitrogen glovebox, a J. Young NMR tube was charged with H-CpNCpNa₂ (5.8 mg, 0.021 mmol) and 0.50 mL CD₃CN. The solution was left standing for 68 h to achieve >98% deuteration of the cyclopentadieneyl protons. The CD₃CN solution was then added quantitatively using 1 mL THF to a solution of FeBr₂ (7.5 mg, 0.035 mmol) in 2 mL THF. The solution was stirred for 10 min, and the solvent was removed under vacuum. The resulting brown solid was extracted using ether, and the ether solution was passed through a plug of Celite. The concentration of the ether solution gave dark brown crystals of 1-H-d₈. Yield: 3.1 mg, 51%.

### The Data for 1-H-d₈:

¹H NMR (500.13 MHz, toluene-d₈, 233 K): δ 2.88 (4H, s, 2CH₂), 3.92 (4H, s, 2% residual signal from 3,4-position of C₅H₄ groups), 4.13 (4H, s, 2% residual signal from 2,5-position of C₅H₄ groups), 6.48 (2H, d, ³J_{HH}, =7.5 Hz, 3,5-position of pyridine ring), 6.86 (1H, d, ³J_{HH}, =7.5 Hz, 4-position of pyridine ring).

¹H NMR (500.13 MHz, toluene-d₈, 423 K under 5 bar N₂): δ 3.33 (1H, Δv^{1/2} not available due to overlapping with a signal from diethyl ether, a signal from 4-position of pyridine ring), 13.9 (2H, Δv^{1/2}=238 Hz, a signal from 3,5-position of pyridine ring), 17.5 (4H, Δv^{1/2}=755 Hz, 2CH₂).

HRMS (ESI/TOF, [M]⁺): Calcd for C₁₇H₇D₈N₁Fe₁: 297.1051. Found: 297.1062.

### Preparation of [Fe(Cl-CpNCp)] (1-Cl)

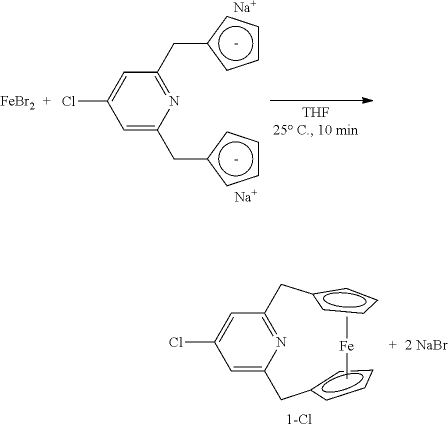

In a nitrogen glovebox, a 20 mL vial equipped with a Teflon-coated stirring bar was charged with FeBr₂ (75.2 mg, 0.349 mmol) and 8 mL THF. The solution was heated intermittently with a heat gun until a clear orange solution was obtained. To the solution at 25° C. was then added Cl-CpNCpNa₂ (106.8 mg, 0.340 mmol) in 2 mL THF dropwise for about 5 min. The vial containing Cl-CpNCpNa₂ was washed twice with 1 mL each of THF and the THF solution was added to the solution of FeBr₂. As soon as the addition of Cl-CpNCpNa₂ was completed, the dark brown suspension was concentrated to dryness, and the resulting solid was extracted with benzene. The benzene extract was passed through a plug of Celite, and the Celite was washed three times with benzene. The concentration of combined benzene solution gave dark brown needles of 1-Cl. The crystals were washed three times with n-pentane and dried. Yield: 59.7 mg, 54%.

¹H NMR (500.13 MHz, toluene-d₈, 233 K): δ 2.64 (4H, s, 2CH₂), 3.89 (4H, br t, 3,4-position of C₅H₄ groups), 4.05 (4H, br t, 2,5-position of C₅H₄ groups), 6.38 (2H, s, 3,5-position of pyridine ring).

¹³C{¹H} NMR (125.76 MHz, toluene-d₈, 233 K): δ 33.2 (s, 2CH₂), 63.8 (s, 3,4-position of C₅H₄ groups), 71.2 (s, 2,5-position of C₅H₄ groups), 106.5 (s, 1-position of C₅H₄ groups), 118.1 (s, 3,5-position of pyridine ring), 140.9 (s, 4-position of pyridine ring), 167.5 (s, 2,6-position of pyridine ring).

¹⁵N NMR (50.68 MHz, toluene-d₈, 233 K, detected using ¹H-¹⁵N HMBC): δ 333.6 (s). Effective magnetic moment: μ_{eff} (VSM, bulk solid, 298.17 K)=0 s.

FTIR (Thin film, cm⁻¹): 1566 (m, C═C, and C═N stretch), 1408 (w, sp³ C—H bending), 1021 (m, sp² C—H bending), 1015 (m, sp² C—H bending), 845 (s, sp² C—H bending), 808 (s, sp² C—H bending).

UV-Vis (THF, 25° C.): amₐₓ=264 nm (ε=7200 M⁻¹ cm⁻¹), 407 nm (F—=1100 M⁻¹ cm⁻¹).

EPR (9.079 GHz, 2.5 mM toluene glass, 4.2 K): No detectable signal from the sample.

Elemental analysis: Calcd: C: 63.10, H: 4.36, N: 4.33. Found: C: 63.49, H: 4.23, N: 4.45.

HRMS (ESI/TOF, [M]⁺): Calcd for C₁₇H₁₄N₁Cl₁Fe₁: 323.0159. Found: 323.0161.

### Preparation of [Fe(CpNCp-OMe)] (1-OMe+2-OMe)

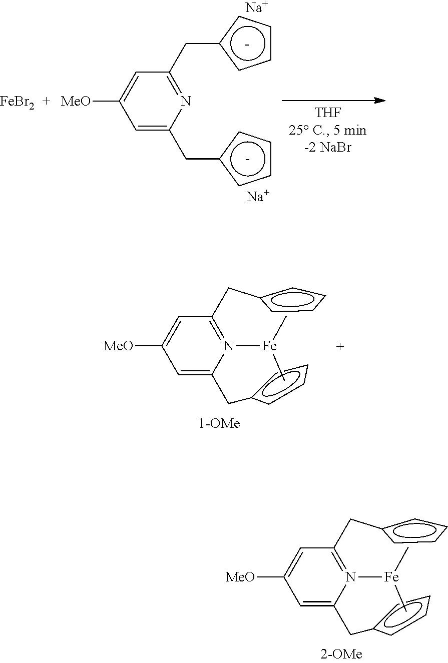

In a nitrogen glovebox, a 20 mL vial equipped with a Teflon-coated stirring bar was charged with FeBr₂ (215.1 mg, 0.997 mmol) and 12 mL THF. The solution was heated intermittently with a heat gun until a clear orange solution was obtained. To the solution at 25° C. was then added MeO-CpNCpNa₂ (283.5 mg, 0.917 mmol) in 2 mL THF dropwise for about 5 min. The vial containing MeO-CpNCpNa₂ was washed twice with 0.5 mL each of THF and the THF solution was added to the solution of FeBr₂. As soon as the addition of MeO-CpNCpNa₂ was completed, the dark purple suspension was concentrated to dryness, and the resulting solid was extracted with benzene. The benzene extract was passed through a plug of Celite, and the Celite was washed three times with benzene. The concentration of the combined benzene solution gave a dark brown solid. The solid was extracted with 4:1 n-pentane:benzene solution, and the solution was passed through a plug of Celite, and the Celite wash washed with n-pentane. The concentration of the combined n-pentane-benzene solution gave a dark brown solid of a mixture of 1-OMe and 2-OMe. Yield: 87.0 mg, 30%.

¹H NMR (500.13 MHz, toluene-d₈, 233 K, signals from 1-OMe): δ 2.85 (4H, s, 2CH₂), 3.17 (3H, s, OCH₃), 3.93 (4H, br s, 3,4-position of C₅H₄ groups), 4.24 (4H, br s, 2,5-position of C₅H₄ groups), 6.27 (2H, s, 3,5-position of pyridine ring).

¹H NMR (500.13 MHz, toluene-d₈, 233 K, signals from 2-OMe): δ −344.0 (Δv^{1/2}=2816 Hz), −195.0 (Δv^{1/2}=2971 Hz), 109.0 (Δv^{1/2}=157 Hz), 189.9 (Δv^{1/2}=101), one signal is missing likely due to overlapping with diamagnetic signals.

¹³C{¹H} NMR (125.76 MHz, toluene-d₈, 233 K): δ 33.7 (s, 2CH₂), 54.4 (s, OCH₃), 63.5 (s, 3,4-position of C₅H₄ groups), 71.0 (s, 2,5-position of C₅H₄ groups), 104.1 (s, 2CH, 3,5-position of pyridine ring), 106.8 (s, 1-position of C₅H₄ groups), 165.2 (s, 4-position of pyridine ring), 167.7 (s, 2,6-position of pyridine ring). Detection of ¹³C NMR signals from 2-OMe was not attempted.

¹⁵N NMR (50.68 MHz, toluene-d₈, 233 K, detected using ¹H-¹⁵N HMBC, a signal from 1-OMe): δ 316.0 (s). A signal form 2-OMe was not detectable.

Effective magnetic moment: μ_{eff} (VSM, bulk solid, 298.15 K)=4.88 s.

FTIR (Thin film, cm⁻¹): 3056, 2916, 1566, 1408, 1337, 1188, 1148, 1047, 1015, 853, 815, 753.

UV-Vis (THF, 25° C.): λₘₐₓ=365 nm (E=1100 M⁻¹ cm⁻¹).

EPR (9.079 GHz, 2.5 mM toluene glass, 4.2 K): No detectable signal from the sample.

Elemental analysis: Calcd: C: 67.73, H: 5.37, N: 4.39. Found: C: 67.97, H: 5.25, N: 4.46.

HRMS (ESI/TOF, [M]⁺): Calcd for C₁₈H₁₇N₁O₁Fe₁: 319.0654. Found: 319.0655.

Preparation of [Fe(CpNCp-NMe₂)] (2-NMe₂)

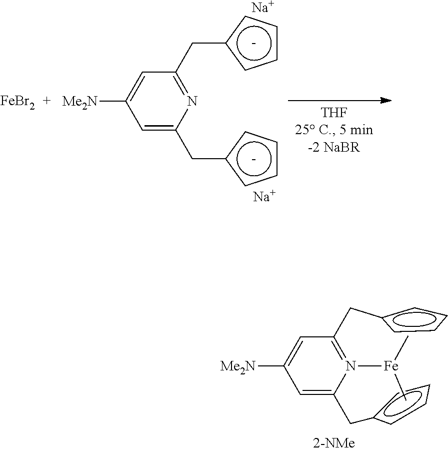

In a nitrogen glovebox, a 20 mL vial equipped with a Teflon-coated stirring bar was charged with FeBr₂ (108.3 mg, 0.50 mmol) and 10 mL THF. The solution was heated intermittently with a heat gun until a clear orange solution was obtained. To the solution at 25° C. was then added NMe₂-CpNCpNa₂ (146.5 mg, 0.45 mmol) in 2 mL THF dropwise for about 5 min. The vial containing NMe₂-CpNCpNa₂ was washed three times with 1 mL each of THF and the THF solution was added to the solution of FeBr₂. After the addition, the brown suspension was stirred for 5 min and concentrated to dryness. The resulting brown solid was extracted with benzene. The dark purple benzene extract was passed through a plug of Celite, and the Celite was washed three times with benzene. The concentration of the combined benzene solution gave an ivory/off-white solid of 2-NMe₂. Yield: 59.4 mg, 39%. This solid can be further purified by extraction with pentane or by precipitation from a hot saturated benzene solution to obtain an off-white solid of 2-NMe₂. This solid was used for Mossbauer spectroscopy and VSM measurements.

¹H NMR (500.13 MHz, toluene-d₈, 233 K, signals from 1-NMe₂): δ 2.39 (6H, s, N(CH₃)₂), 2.98 (4H, s, 2CH₂), 3.95 (4H, br s, 3,4-position of C₅H₄ groups), 4.34 (4H, br s, 2,5-position of C₅H₄ groups), 6.05 (2H, s, 3,5-position of pyridine ring).

¹H NMR (500.13 MHz, toluene-d₈, 233 K, signals from 2-NMe₂): δ −330.0 (4H, Δv^{1/2} 2560 Hz, 3,4-position of C₅H₄ groups), −210.9 (4H, Δv^{1/2}=2762 Hz, 2,5-position of C₅H₄ groups), 11.28 (6H, Δv^{1/2}=25.8 Hz, N(CH₃)₂), 108.5 (2H, Δv^{1/2}=117 Hz, 3,5-position of pyridine ring), 177.9 (4H, Δv^{1/2}=888, 2 CH₂). Assigned based on integration values and comparison to ¹H NMR spectra of previously reported S=3/2, Co(CpNCp-H) complex.

¹³C{¹H} NMR (125.76 MHz, toluene-d₈, 233 K, signals from 1-NMe₂): δ 34.2 (s, 2CH₂), 39.4 (s, N(CH₃)₂), 63.2 (s, 3,4-position of C₅H₄ groups), 70.6 (s, 2,5-position of C₅H₄ groups), 101.1 (s, 2CH, 3,5-position of pyridine ring), 106.7 (s, 1-position of C₅H₄ groups), 153.9 (s, 4-position of pyridine ring), 166.7 (s, 2,6-position of pyridine ring).

¹³C{¹H} NMR (125.76 MHz, toluene-d₈, 233 K, signals from 2-NMe₂): δ 23.9 (s, N(CH₃)₂, Confirmed by ¹H-¹³C HSQC), 231.3 (br, most likely 3,5-position of pyridine ring. It appears as broad doublet in proton-coupled ¹³C NMR). Other ¹³C NMR signals were not detectable.

¹⁵N NMR (50.68 MHz, toluene-d₈, 233 K, detected using ¹H-¹⁵N HMBC, a signal from 1-NMe₂): δ 298.6 (s). Signals form NMe₂ groups, and 2-NMe₂ were not detectable.

Effective magnetic moment: μ_{eff} (Evans' method, Toluene-d₈, 233 K)=4.83 s. μ_{eff} (VSM, 298.14 K)=4.90 s.

FTIR (KBr pellet, cm⁻¹): 3081, 2901, 1612 (s, C═C and C═N stretch), 1529, 1415, 1384, 1022, 800, 760, 742, 654.

UV-Vis (in THF, 25° C.): λₘₐₓ=258 nm (ε=16300 M⁻¹ cm⁻¹), 267 nm (F=15600 M⁻¹ cm⁻¹).

EPR (9.079 GHz, 2.5 mM toluene glass, 4.2 K): No detectable signal from the sample.

Elemental analysis: Calcd: C: 68.69, H: 6.07, N: 8.43. Found: C: 68.59, H: 5.86, N: 8.26.

HRMS (ESI/Orbitrap, [M]⁺): Calcd for C₁₉H₂₀N₂Fe₁: 332.0970. Found: 332.0966.

Preparation of [Fe(NMe₂-CpNCp-d₈)] (1-NMe₂-d₈)

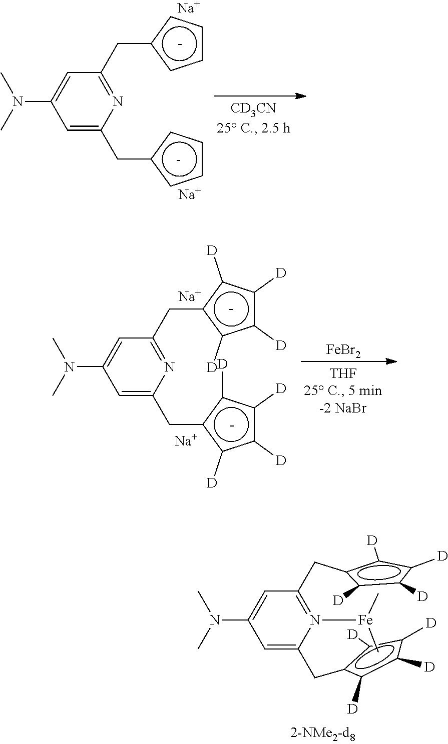

In a nitrogen glovebox, a 6 mL vial was charged with NMe₂-CpNCpNa₂ (15.9 mg, 0.049 mmol) and 0.50 mL CD₃CN. The solution was left standing for 2.5 h to achieve >95% deuteration of the cyclopentadienyl protons. FIG. 29 shows ¹H NMR spectra of NMe₂-CpNCpNa₂-d₈. CD₃CN was removed under vacuum, and the resulting pink solid was dissolved in 2 mL THF. The solution was then added dropwise to a clear yellow solution of FeBr₂ (10.9 mg, 0.051 mmol) in 4 mL THF. The vial containing NMe₂-CpNCpNa₂-d₈ was washed two times with 0.5 mL each of THF, and the THF solution was added to the solution of FeBr₂. The solution was stirred for 5 min, and the solvent was removed under vacuum. The resulting brown solid was extracted using benzene and the dark purple benzene solution was passed through a plug of Celite. The concentration of the benzene solution gave an off-white solid with yellow impurity. This solid was extracted using ˜1:10 toluene/pentane mixture. The concentration of this solution gave an off-white solid of 2-NMe₂-d₈. Yield: 7.0 mg, 42%.

The Data for 1-NMe₂-d₈ and 2-NMe₂-d₈:

¹H NMR (400.15 MHz, CD₃CN, 298 K, NMe₂-CpNCpNa₂-d₈): δ 2.99 (6H, s, N(CH₃)₂), 3.76 (4H, s, 2CH₂), 5.23 (4H, br s, 4% residual signal from 3,4-position of C₅H₄ groups), 5.42 (4H, br s, 4% residual signal from 2,5-position of C₅H₄ groups), 6.30 (2H, s, 3,5-position of pyridine ring).

¹H NMR (500.13 MHz, toluene-d₈, 233 K, signals from 1-NMe₂-d₈): δ 2.35 (6H, s, N(CH₃)₂), 2.98 (4H, s, 2CH₂), 6.02 (2H, s, 3,5-position of pyridine ring).

¹H NMR (500.13 MHz, toluene-d₈, 233 K, signals from 2-NMe₂-d₈): δ −329.4 (4H, Δv^{1/2}=2560 Hz, 3,4-position of C₅H₄ groups), −210.8 (4H, Δv^{1/2}=2762 Hz, 2,5-position of C₅H₄ groups), 11.32 (6H, Δv^{1/2}=25.8 Hz, N(CH₃)₂), 108.5 (2H, Δv^{1/2}=117 Hz, 3,5-position of pyridine ring), 177.8 (4H, Δv^{1/2}=888, 2 CH₂). Assigned based on integration values and comparison to 1H NMR spectra of previously reported S=3/2, Co(CpNCp-H) complex.

HRMS (ESI/TOF, [M]⁺): Calcd for C₁₇H₇D₈N₁Fe₁: 297.1051. Found: 297.1062.

The following is information on the resulting compounds.

The single-crystal X-ray diffraction (SC-XRD) study revealed that the Fe⋅⋅⋅N distance in 1-H is 3.0403(8) angstrom, and the nitrogen electron pair is directed away from the iron atom, while the two Cp groups are bound to Fe in the η⁵-coordination mode (FIG. 28 b). Therefore, in the crystalline phase, 1-H is a formal 18-electron complex without an Fe—N bond, reflecting the expected stability of an 18-electron complex. Consistent with this observation, the ⁵⁷Fe Mossbauer spectrum of the solid sample of 1-H at 77 K (FIG. 29 a, c) showed a doublet signal with isomer shift (6) and quadrupole splitting (ΔE_{Q}) similar to ferrocene (FIG. 29 c), and solid-state magnetic measurements by vibrating sample magnetometer (VSM) supported the formation of a diamagnetic complex. However, in a solution, extremely broad ¹H nuclear magnetic resonance (NMR) signals were observed at 25° C. (FIG. 22). Variable-temperature NMR (from −40 to 150° C.) and solution magnetic measurements by Evans' method showed the presence of a temperature-dependent equilibrium between diamagnetic and paramagnetic species. Consistent with the solid-state structure, the diamagnetic species observed at −40° C. showed a ¹⁵N NMR chemical shift indicating the absence of an Fe—N bonding interaction (FIG. 24). Whereas the ¹H NMR spectrum of the paramagnetic species recorded at 150° C. supported the C₂ᵥ molecular symmetry and indicated formation of N-coordination species.

Aiming at isolating Fe—N bonded species, we synthesized the X-CpNCp ligands with varying Lewis basicity (FIG. 28 a). When most Lewis basic NMe₂-CpNCp ligand was reacted with FeBr₂, N-coordinated complex 2-NMe₂ was isolated as an off-white solid in 39% yield. Complex 2-NMe₂ is air sensitive; however, it is stable under a nitrogen atmosphere at 25° C. for more than a year. VSM measurements confirmed the formation of high-spin, S=2 complex with an effective magnetic moment of 4.9 μ_{B} (μ_{B}: Bohr magneton) at 298 K. The SC-XRD structure of 2-NMe₂ (FIG. 28 c) revealed a significantly shortened Fe—N distance of 2.1476(10) angstrom, which is among the shortest Feu-N distances in high-spin, pyridine-based Fe^{II}PNP pincer complexes. Fe⋅⋅⋅Cp centroid (Fe⋅⋅⋅Cp_{c}) distances of 2.0383(6) and 2.0393(5) angstrom are more than 0.33 angstrom longer than those of 1-H (1.689(4)-1.709(2) angstrom) and ferrocene (1.651 angstrom), and represent the longest Fe⋅⋅⋅Cp_{c} distances in Fe^{II} ferrocene derivatives, suggesting a substantial weakening of Fe⋅⋅⋅C(Cp) interatomic interactions.

The coordination mode of the Cp groups was analyzed by the Cp ring slip parameters Δ and ψ (FIG. 28 d). λ distances of 0.112 and 0.124 angstrom and Ψ angles of 3.2° and 3.5° for the two Cp groups of 2-NMe₂, respectively, fall within the range that supports the η⁵-coordination mode. In agreement with this analysis, the Δ and Ψ values of η⁵-coordinated Cp groups in 1-H were 0.074 to 0.252 angstrom and 2.5° to 5.9°, respectively. Unlike other ferrocenophane derivatives, the Cp rings in 2-NMe₂ are tilted toward the bridging moiety of the ligand, forming a Cp_{c}⋅⋅⋅Fe⋅⋅⋅Cp_{c} angle of 145.92(3)°. This significant inward tilting corroborates the presence of an attractive interaction between the Fe and N atoms. In contrast, the bending of the Cp_{c}⋅⋅⋅Fe⋅⋅⋅Cp_{c} angle was much smaller in 1-H (about 170.6°). The ⁵⁷Fe Mossbauer spectrum of solid 2-NMe₂ at 77 K (FIG. 29 b, c) shows a doublet signal at δ=1.15 mm s⁻¹ with a trace doublet signal from N-noncoordinated complex 1-NMe₂ at δ=0.58 mm s⁻¹. Note that δ values more than 1 mm s⁻¹ are the characteristic of S=2, Fe^{II} complexes⁴¹ and consistent with the spin and oxidation state of 2-NMe₂.

In solution, the ¹H NMR spectrum recorded at −40° C. showed five broad signals between −330 and +180 ppm, consistent with the formation of paramagnetic 2-NMe₂. In addition to these signals, five sharper signals appeared in the typical diamagnetic region (0-10 ppm) of the spectrum (FIG. 29 d). Based on two-dimensional (2D) NMR experiments, selective deuteration of Cp protons, and ¹H NMR integral ratios, these signals in the paramagnetic and diamagnetic regions were assigned to N-coordinated 2-NMe₂ and N-noncoordinated 1-NMe₂, respectively. Notably, 1-NMe₂ displays a 15N NMR signal of the pyridine nitrogen at 299 ppm (233 K, in toluene-d₈), similar to the chemical shift of sodium salt of the free ligand at 262 ppm (233 K, in toluene-d₈ with THF-d₈). The ratio of 1-NMe₂ to 2-NMe₂ varies with temperature, and the exchange between the two species was confirmed by 2D ¹H-¹H exchange (EXSY) NMR. Therefore, we experimentally observed reversible formation of the formal 20-electron 2-NMe₂ via the coordination of nitrogen to the 18-electron 1-NMe₂. Thermodynamic parameters for the formation 1-NMe₂ from 2-NMe₂ (ΔH°=−1.98(3) kcal mol⁻¹, ΔS°=−8.1(1) cal mol⁻¹, and ΔG₂₉₈=0.44(4) kcal mol⁻¹ in toluene-d₈) were determined using a van't Hoff plot, indicating that high-spin 2-NMe₂ is entropically favored, similar to other spin-crossover iron complexes. The equilibrium concentration of 2-NMe₂ is higher in more polar solvent (CD₃CN>THF-d₈>toluene-d₈) at 230.2 K, likely due to the greater polarity and ionic character of the Fe⋅⋅⋅C(Cp) bonds (see below), which result in a higher molecular dipole moment of 2-NMe₂ (8.3 D compared to 4.1 D for the free 2-NMe₂ and 1-NMe₂, based on theoretical computations).

Interestingly, when the less Lewis basic OMe-CpNCp ligand was used, N-noncoordinated 1-OMe and N-coordinated 2-OMe were observed as a cocrystal in a 1:1 ratio in the asymmetric cell by SC-XRD. Consistent with this observation, the ⁵⁷Fe Mossbauer spectrum showed two sets of doublet signals corresponding to 1-OMe and 2-OMe in a 58.4:41.6 ratio, respectively.

When the least Lewis basic Cl-CpNCp ligand was used, only N-noncoordinated 1-Cl was obtained in the solid state. However, in solution, variable temperature NMR indicated the presence of reversible N-coordination. Therefore, in the solution, the coordination of the pyridine groups to the 18-electron ferrocene derivative is reversible, and the strength of coordination is tunable by the Lewis basic character of the pyridine groups.

<Estimation of Thermodynamic Parameters for the Equilibrium Between 1-NMe₂ and 2-NMe₂.>

In a nitrogen glovebox, a J. Young NMR tube was charged with a solution of 1-NMe₂ and 2-NMe₂ prepared using 3.5 mg 2-NMe₂ and 0.60 mL toluene-d₈. NMR spectra were recorded at 250.2, 245.2, 240.2, 235.2, and 230.2±0.1 K (temperatures calibrated using CD₃OD). Integral ratios between the NMe₂ group of 2-NMe₂ and the NMe₂ group of 1-NMe₂ or the CH₂ group of 1-NMe₂ were used to calculate the equilibrium ratio of 2-NMe₂ and 1-NMe₂. The ratios of 2-NMe₂:1-NMe₂ were 78:22 (in CD₃CN), 66:34 (in THF-d₈), and 44:56 (in toluene-d₈) at 230.2 K.

<Reaction Between Ferrocene and 4-dimethylaminopyridine (DMAP)>

In a nitrogen glovebox, a Wilmad medium wall quick pressure valve NMR tube (524-QPV-7) was charged with ferrocene (5.8 mg, 0.031 mmol), DMAP (3.8 mg, 0031 mmol) and 0.30 mL toluene-d₈. The tube was pressurized with 3 bar N₂, and NMR spectra were recorded at 298, 373, and 403 K (temperatures not calibrated). No significant sifting of NMR signals due to the formation of DMAP-coordinated species was observed.

The electronic structure of 2-NMe₂ was further investigated by density functional theory (DFT) calculations at the TPSSh-D4/def2-QZVPP/TPSS-D4/def2-TZVPPYZ level of theory⁴³⁻⁴⁸. Comparison of MO diagrams of ferrocene (FeCp₂), 1-NMe₂, and 2-NMe₂. is shown in FIG. 30.

The stability of 2-NMe₂ originates from the formation of the Fe—N bond and bending of the Cp⋅⋅⋅Fe⋅⋅⋅Cp fragment, facilitated by the structure of the NMe₂-CpNCp ligand. Indeed, an intermolecular reaction between ferrocene and 4-dimethyaminopyridine showed no sign of the Fe—N bond formation, even at 130° C.

### <Quantum Chemical Topology and Interatomic Interactions>

The interatomic interactions in 1-NMe₂ and 2-NMe₂, as well as the origin of the stability of the 20-electron ferrocene derivatives, were examined by analyzing the relationships between the zero-flux surfaces U, P, and S defined in the electrostatic force Fₑₛ(r), the kinetic force Fₖ(r), and the electron density gradient ∇ρ(r), respectively (FIG. 31 a, b).

### <Cyclic Voltammetry (CV) of 1-X and 2-X>

CV was measured inside a nitrogen glovebox using an ECstat-301WL potentiostat equipped with a glassy carbon working electrode (3.0 mm diameter), coiled platinum wire (0.5 mm diameter) counter electrode, and Ag/Ag⁺ reference electrode (Ag wire in 0.01 M AgNO₃ in 0.1 M [Bu₄N]PF₆ MeCN solution). The sample solution was prepared by dissolving an appropriate sample in 0.2 M [Bu₄]NPF₆ THF or 0.1 M [Bu₄]NPF₆ CH₂Cl₂ solution. All potentials are reported using FeCp₂^{0/+} couple (0 mV) as an external reference. The voltammograms were recorded starting from the open circuit potentials of each solution. Cyclic voltammograms of 1-X and 2-X in 0.2 M [Bu₄]NPF₆ THF are shown in FIG. 34 a.

### <Preparation and Reactivity of Complexes>

Preparation of [FeCp₂]PF₆

In a nitrogen glovebox, a 20 mL vial equipped with a Teflon-coated stirring bar was charged with FeCp₂ (189.8 mg, 1.02 mmol) and 2 mL dichloromethane. In a dark room, AgPF₆ (252.6 mg, 1.00 mmol) in dichloromethane 2 mL was added dropwise to the solution of FeCp₂ while stirring. The vial containing AgPF₆ was washed twice with 1 mL each of dichloromethane, and the wash was added to the FeCp₂ solution. The solution was stirred for 15 min, and was passed through a plug of Celite using MeCN. The resulting solution was concentrated to dryness. The solid was dissolved in about 2 mL MeCN, and 15 mL ether was layered on top of the MeCN solution. The slow diffusion of ether gave blue crystals of the product. The crystals were decanted, washed three times with ether, and dried to obtain dark blue crystals of the product. Yield: 279.1 mg, 84%.

### Preparation of 3-H

### Method A:

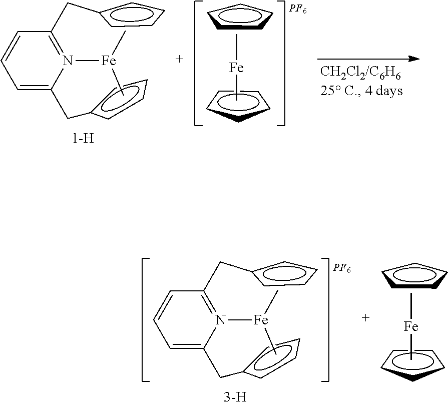

In a nitrogen glovebox, a 20 mL vial equipped with a Teflon-coated stirring bar was charged with [FeCp₂]PF₆ (34.0 mg, 0.103 mmol) and 10 mL dichloromethane. The suspension was stirred while heated intermittently by a heat gun until all [FeCp₂]PF₆ dissolved. The stirring bar was removed from the solution, and a solution of 1-H (29.0 mg, 0.100 mmol) in 10 mL benzene was layered on top of the dichloromethane layer. The bilayer solution was left standing at 25° C. for four days, resulting in the formation of dark brown needles of product and yellow solution of ferrocene. The crystals were decanted, washed three times with benzene and dried to obtain dark green crystals of the product. Yield: 36.5 mg, 84%.

### Method B:

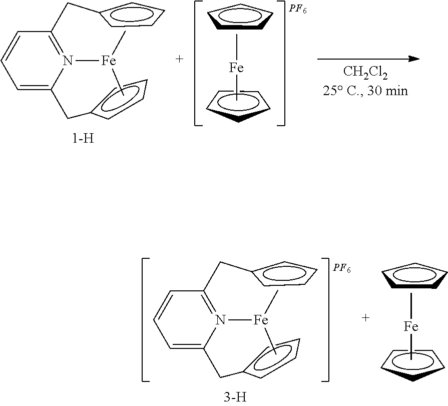

In a nitrogen glovebox, a 20 mL vial equipped with a Teflon-coated stirring bar was charged with [FeCp₂]PF₆ (34.1 mg, 0.103 mmol) and 14 mL dichloromethane. The suspension was stirred while heated intermittently by a heat gun until all [FeCp₂]PF₆ dissolved. The stirring bar was removed from the solution, and a solid of 1-H (29.0 mg, 0.100 mmol) was added to the vial. The solution was stirrer for 30 min at 25° C. The resulting dark green microcrystals were decanted, washed three times with dichloromethane, and dried to obtain the dark green powder of the product. Yield: 35.4 mg, 81%.

### The Data for 3-H:

¹H NMR (400.15 MHz, CD₃CN, 298 K): δ 9.89 (br, Δv^{1/2}=40.0 Hz), 26.5(br, Δv^{1/2}=2204 Hz).

³¹P{¹H} NMR (202.45 MHz, CD₃CN, 298 K): δ −144.6 (septet, ¹J_{PF}, =706 Hz),

¹⁹F NMR (470.54 MHz, CD₃CN, 298 K): δ 72.88 (d, ¹J_{FP}, =706 Hz), Effective magnetic moment: μ_{eff} (Evans' method, CD₃CN, 298 K)=2.0 μ_{B}.

EPR (9.071 GHz, 1.6 mM 1:1 toluene:acetone glass, 77 K): g1, g2, g3=2.163, 2.007, 1.978. A1, A2, A3 (¹⁴N)=10.8, 48.9, 38.3 MHz. A1, A2, A3 (¹Hₐ)=51.2, 0, 0 MHz. A1, A2, A3, (¹H_{b})=19.3, 0, 0 MHz.

XPS (298 K): 708.4 eV (Fe 2p^{3/2}), 721.2 eV (Fe 2p^{1/2}).

Elemental analysis: Calcd: C: 47.03, H: 3.48, N: 3.23. Found: C: 46.74, H: 3.33, N: 3.23.

HRMS (ESI/TOF, [M-PF₆]⁺): Calcd for C₁₇H₁₅N₁Fe₁: 289.0548. Found: 289.0548.

### Preparation of 3-Cl

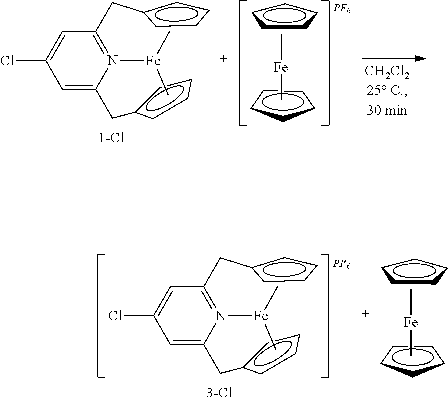

In a nitrogen glovebox, a 20 mL vial equipped with a Teflon-coated stirring bar was charged with [FeCp₂]PF₆ (33.0 mg, 0.100 mmol) and 1-Cl (33.2 mg, 0.103 mmol). To the vial was added 4 mL dichloromethane, and the solution was stirred for 30 min at 25° C. 2 mL MeCN was added to the resulting dark green solution with insoluble black precipitate. The solution was passed through a plug of Celite using MeCN. The resulting solution was concentrated to about 0.5 mL. The resulting dark green solid was partially dissolved by the addition of 3 mL dichloromethane. 10 mL of benzene was layered on top of the dichloromethane layer. The bilayer solution was left standing at 25° C. for one day, resulting in the formation of a green solid product and a yellow solution of ferrocene. The solid was decanted, washed three times with benzene, and dried to obtain the green solid of the product. Yield: 42.1 mg, 90%.

### The Data for 3-Cl:

¹H NMR (400.15 MHz, CD₃CN, 298 K): δ 27.0 (br, Δv^{1/2}=2100 Hz).

³¹P{¹H} NMR (202.45 MHz, CD₃CN, 298 K): δ −144.6 (septet, ¹J_{PF}, =706 Hz),

¹⁹F NMR (470.54 MHz, CD₃CN, 298 K): δ 72.88 (d, ¹J_{FP}, =706 Hz),

Effective magnetic moment: μ_{eff} (Evans' method, CD₃CN, 298 K)=2.2 μ_{B}.

EPR (9.079 GHz, 1.6 mM 1:1 toluene:acetone glass, 77 K): g1, g2, g3=2.168, 2.007, 1.979 MHz. A1, A2, A3 (¹⁴N)=0.9, 48.6, 38.4 MHz. A1, A2, A3 (¹Hₐ)=48.8, 0, 0 MHz. A1, A2, A3, (¹H_{b})=12.7, 0, 0 MHz.

Elemental analysis: Calcd: C: 43.58, H: 3.01 N: 2.99. Found: C: 43.37, H: 2.80, N: 3.31.

HRMS (ESI/TOF, [M-PF₆]⁺): Calcd for C₁₇H₁₄N₁Cl₁Fe₁: 323.0159. Found: 323.0150.

### Preparation of 3-OMe

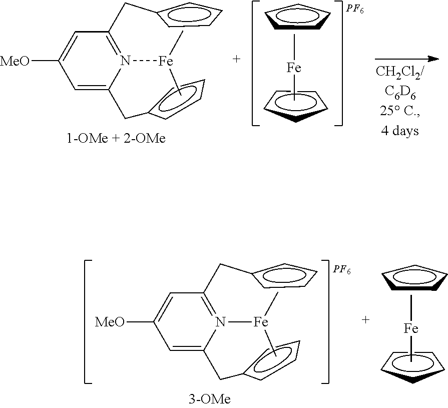

In a nitrogen glovebox, a 20 mL vial equipped with a Teflon-coated stirring bar was charged with [FeCp₂]PF₆ (22.1 mg, 0.067 mmol) and 10 mL dichloromethane. The suspension was stirred while heated intermittently by a heat gun until all [FeCp₂]PF₆ dissolved. The stirring bar was removed from the solution, and a solution of 1-OMe+2-OMe (21.2 mg, 0.066 mmol) in 10 mL benzene was layered on top of the dichloromethane layer. The bilayer solution was left standing at 25° C. for four days, resulting in the formation of dark brown crystals of product and yellow solution of ferrocene. The crystals were decanted, washed three times with benzene, and dried to obtain brown-green crystals of the product. Yield: 29.1 mg, 94%.

### The Data for 3-OMe:

¹H NMR (400.15 MHz, CD₃CN, 298 K): δ 4.19 (br, Δv^{1/2}=12.6 Hz), 26.0 (br, Δv^{1/2}=2591 Hz).

³¹P{¹H} NMR (202.45 MHz, CD₃CN, 298 K): δ −144.6 (septet, ¹J_{PF}, =706 Hz),

¹⁹F NMR (470.54 MHz, CD₃CN, 298 K): δ 72.88 (d, ¹J_{FP}, =706 Hz),

Effective magnetic moment: μ_{eff} (Evans' method, CD₃CN, 298 K)=2.5 μ_{B}.

EPR (9.078 GHz, 1.6 mM 1:1 toluene:acetone glass, 77 K): g1, g2, g3=2.158, 2.007, 1.976 MHz. A1, A2, A3 (¹⁴N)=8.9, 50.9, 40.1 MHz. A1, A2, A3 (¹Hₐ)=57.9, 0, 0 MHz. A1, A2, A3, (¹H_{b})=20.4, 0, 0 MHz.

Elemental analysis: Calcd for 3-OMe+0.2CH₂Cl₂: C: 45.43, H: 3.65, N: 2.91. Found: C: 45.50, H: 3.60, N: 2.81.

HRMS (ESI/TOF, [M-PF₆]⁺): Calcd for C₁₈H₁₇N₁O₁Fe₁: 319.0654. Found: 319.0654.

### Preparation of 3-NMe₂

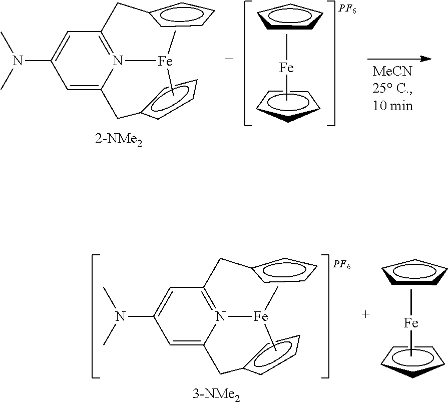

In a nitrogen glovebox, a 6 mL vial equipped was charged with [FeCp₂]PF₆ (6.8 mg, 0.021 mmol) and 2-NMe₂ (6.6 mg, 0.020 mmol). To the vial, 2 mL MeCN was added, and all the solids were dissolved. The dark brown solution was left at 25 C for 10 min, layered with benzene, and left for 4 hours. The resulting precipitate was washed by benzene and dissolved in 1 mL MeCN. The brown MeCN solution was filtered through a plug of Celite using 1 mL MeCN. The combined MeCN solution was concentrated to dryness. The brown solid was washed three times with 2 mL each of pentane and dried. Yield: 9.3 mg, 98%. Single crystals suitable for the SC-XRD analysis were obtained upon the concentration of the MeCN solution to near dryness.

FIG. 32 shows the ¹H NMR and EPR spectrum of 3-NMe₂.

¹H NMR (400.15 MHz, CD₃CN, 298 K): δ 1.64 (br, Δv^{1/2}=19.8 Hz), 2.26 (br, Δv^{1/2} 50.3 Hz), 25.0 (br, Δv^{1/2}=4056 Hz).

³¹P{¹H} NMR (202.45 MHz, CD₃CN, 298 K): δ −144.6 (septet, ¹J_{PF}, =706 Hz),

¹⁹F NMR (470.54 MHz, CD₃CN, 298 K): δ 72.88 (d, ¹J_{FP}, =706 Hz),

Effective magnetic moment: μ_{eff} (Evans' method, CD₃CN, 298 K)=1.9 s.

EPR (9.077 GHz, 1.6 mM 1:1 toluene:acetone glass, 77 K): g1, g2, g3=2.148, 2.006, 1.971 MHz. A1, A2, A3 (¹⁴N)=9.9, 53.6, 42.4 MHz. A1, A2, A3 (¹Hₐ)=59.4, 0, 0 MHz. A1, A2, A3, (¹H_{b})=11.2, 0, 0 MHz.

Elemental analysis: Calcd for 3-NMe₂: C: 47.82, H: 4.22, N: 5.87. Found: C: 47.84, H: 4.15, N: 5.98.

HRMS (ESI/TOF, [M-PF₆]⁺): Calcd for C₁₉H₂₀N₂Fe₁: 332.0971. Found: 332.0969.

Oxidation of 3-NMe₂ with 1 Equiv. [FeCp₂]PF₆ in CH₂Cl₂/Benzene

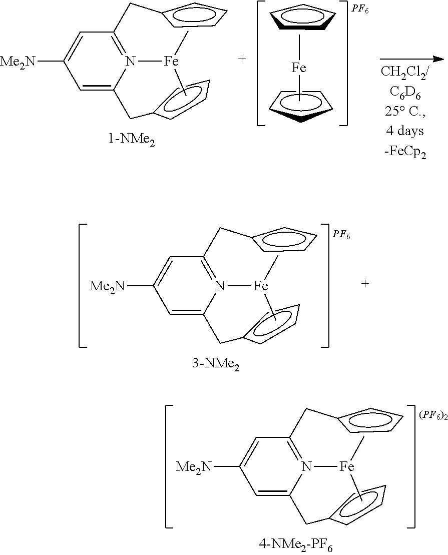

In a nitrogen glovebox, a 20 mL vial equipped with a Teflon-coated stirring bar was charged with [FeCp₂]PF₆ (33.3 mg, 0.101 mmol) and 10 mL dichloromethane. The suspension was stirred while heated intermittently by a heat gun until all [FeCp₂]PF₆ dissolved. The stirring bar was removed from the solution, and a solution of 2-NMe₂ (33.3 mg, 0.100 mmol) in 10 mL benzene was layered on top of the dichloromethane layer. The bilayer solution was left standing at 25° C. for four days, resulting in the formation of dark brown crystals, a solid of product, and a yellow solution of ferrocene. The crystals and solid were washed three times with benzene and dried to obtain the product. Yield: 25.2 mg. EPR spectrum showed the formation of 3-NMe₂, while SC-XRD analysis of the dark brown crystal showed the formation of 4-NMe₂-PF₆. No further purification and isolation of 4-NMe₂-PF₆ was attempted.

Elemental analysis: Calcd for 1/0.3 mixture of 3-NMe₂/4-NMe₂-PF₆: C: 44.69, H: 3.95, N: 5.49. Found: C: 45.01, H: 3.90, N: 5.09.

### Preparation of 4-H

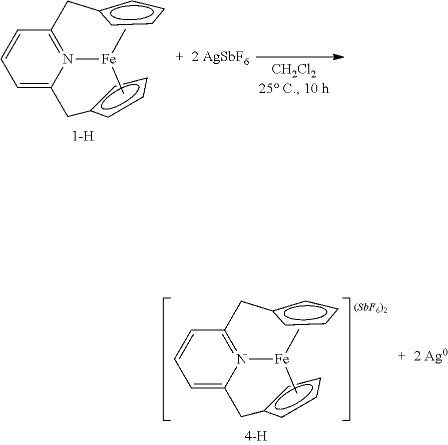

In a nitrogen glovebox, a 20 mL vial equipped with a Teflon-coated stirring bar was charged with 1-H (28.9 mg, 0.100 mmol) and 4 mL dichloromethane. To the stirring brown solution was added AgSbF₆ (84.6 mg, 0.246 mmol) using 2 mL dichloromethane at 25° C. The solution was stirred for 10 h at 25° C. in a dark room, and a colorless solution with black precipitate was formed. To the vial was added 2 mL nitromethane to extract the insoluble product. The violet solution was passed through a plug of Celite to remove the black solid of Ag⁰, and the Celite was washed three times with a 1:1 nitromethane:dichloromethane mixture. The dark violet solution was concentrated and formed a black solid of 4-H. The solid was washed three times with dichloromethane to remove excess AgSbF₆ and dried. Yield: 75.9 mg, 99%.

### The Data for 4-H:

¹H NMR (500.13 MHz, CD₃NO₂, 298 K): δ 4.38 (4H, s, 2CH₂), 6.32 (4H, br pseudo t, 3,4-position of C₅H₄ groups), 6.44 (4H, br pseudo t, 2,5-position of C₅H₄ groups), 7.56 (2H, d, ³J_{HH}, =7.9 Hz, 3,5-position of pyridine ring), 8.14 (1H, d, ³J_{HH}, =7.9 Hz, 4-position of pyridine ring).

¹³C{¹H} NMR (125.76 MHz, CD₃NO₂, 298 K): δ 40.6 (s, 2CH₂), 93.5 (s, 3,4-position of C₅H₄ groups), 96.1 (s, 2,5-position of C₅H₄ groups), 127.0 (s, 3,5-position of pyridine ring), 139.5 (s, 1-position of C₅H₄ groups), 144.4 (s, 4-position of pyridine ring), 179.1 (s, 2,6-position of pyridine ring).

¹⁵N NMR (50.68 MHz, CD₃NO₂, 298 K, detected using ¹H-¹⁵N HMBC): δ 198.1 (s).

¹⁹F NMR (470.54 MHz, CD₃NO₂, 298 K): δ 126.78 (overlapping br sextet (¹J_{F-121Sb}, =1970 Hz), and br octet (¹J_{F-123Sb}, =1050 Hz)).

XPS (298 K): 709.0 eV (Fe 2p^{3/2}), 722.0 eV (Fe 2p^{1/2}).

Elemental analysis: Calcd: C: 26.84, H: 1.99, N: 1.84. Found: C: 26.44, H: 1.85, N: 1.92.

HRMS (ESI/TOF, [M-(SbF₆)₂]⁺): Calcd for C₁₇H₁₅N₁Fe₁: 289.0548. Found: 289.0557.

### Preparation of 4-NMe₂

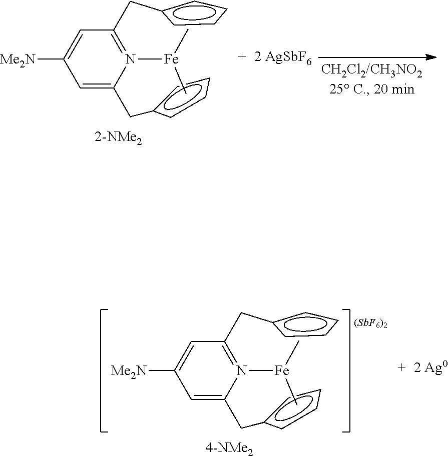

In a nitrogen glovebox, a 20 mL vial equipped with a Teflon-coated stirring bar was charged with 2-NMe₂ (17.0 mg, 0.051 mmol) and 2 mL dichloromethane. To the stirring purple solution was added AgSbF₆ (35.1 mg, 0.102 mmol) using 2 mL nitromethane at 25° C. The dark brown solution was stirred for 20 min at 25° C. in a dark room. The dark brown solution was passed through a plug of Celite to remove the black solid of Ag⁰, and the Celite was washed three times with a 1:1 nitromethane:dichloromethane mixture. The dark purple solution was concentrated to about 3 mL and layered with about 12 mL of benzene. Brown crystals of 4-NMe₂ suitable for SC-XRD analysis were obtained after 2 days. The crystals were washed three times with dichloromethane and dried to obtain 10.7 mg of 4-NMe₂. Another crop of crystals (6.6 mg) was obtained upon standing of decanted mother liquor at 25° C. Total yield: 17.3 mg, 42%.

FIG. 33 shows NMR spectra (CD₃NO₂, 298 K) of 4-NMe₂ ((a)¹H NMR (500.13 MHz). (b) ¹³C{¹H} NMR (125.76 MHz)).

### The Data for 4-NMe₂:

¹H NMR (500.13 MHz, CD₃NO₂, 298 K): δ 3.17 (6H, s, N(CH₃)₂), 4.06 (4H, s, 2CH₂), 6.21 (4H, br pseudo t, 3,4-position of C₅H₄ groups), 6.31 (4H, br pseudo t, 2,5-position of C₅H₄ groups), 6.79 (1H, s, 3,5-position of pyridine ring).

¹³C{¹H} NMR (125.76 MHz, CD₃NO₂, 298 K): δ 39.7 (s, 2CH₂), 40.2 (s, N(CH₃)₂), 92.4 (s, 3,4-position of C₅H₄ groups), 95.7 (s, 2,5-position of C₅H₄ groups), 110.5 (s, 3,5-position of pyridine ring), 139.8 (s, 1-position of C₅H₄ groups), 158.4 (s, 4-position of pyridine ring), 176.6 (s, 2,6-position of pyridine ring).

¹⁵N NMR (50.68 MHz, CD₃NO₂, 298 K, detected using ¹H-¹⁵N HMBC): δ 74.7 (s, N(CH₃)₂), 123.0 (s, pyridyl N).

¹⁹F NMR (470.54 MHz, CD₃NO₂, 298 K): δ 128.29 (br pseudo d).

Elemental analysis: Calcd: C: 28.39, H: 2.51, N: 3.49. Found: C: 28.10, H: 2.27, N: 3.30.

HRMS (ESI/TOF, [M-(SbF₆)₂]⁺): Calcd for C₁₉H₂₀N₂Fe₁: 332.0971. Found: 332.0982.

The following is information on the resulting compounds.

Intrigued by the presence of the high-lying, half-filled Fe⋅⋅⋅Cp antibonding orbitals, we investigated the redox property of the Fe(X-CpNCp) complexes using electrochemical methods. Unexpectedly, the cyclic voltammograms (CVs) of all the Fe(X-CpNCp) complexes (FIG. 34 a, b) showed two reversible oxidation events at approximately −0.8 and 0.1 V vs. FeCp₂^{0/+} in THF or CH₂Cl₂ at 23° C. Ferrocene derivatives are known to undergo reversible one-electron oxidation to Fe^{III} ferrocenium cations, but further oxidation to dicationic Fe^{IV} species requires more electron-rich Cp derivatives such as pentamethylcyclopentadienyl (Cp*) and use of some of the strongest oxidizing reagents, due to the prohibitively high oxidation potential and instability of the Fe^{IV} ferrocene dication. The species formed by the two reversible oxidations of the Fe(X-CpNCp) complexes were isolated by chemical oxidations. One-electron oxidation of the Fe(X-CpNCp) complexes with [FeCp₂]PF₆ produced the S=½, Fe^{III} complexes: 3-X (FIG. 34 c). Examination of their SC-XRD structures revealed that all the Fe^{III} complexes exhibit the nitrogen electron pairs directed toward the iron nuclei while maintaining the η⁵-coordination mode of the Cp groups. Consistent with the DFT calculations-, the Fe—N distances for 3-X (2.3785(16)-2.449(3) angstrom) are significantly longer than that of 2-NMe₂ (2.1476(10) angstrom), while the Fe⋅⋅⋅Cp_{c} distances (1.7505(9)-1.7582(9) angstrom) are significantly shorter than that of 2-NMe₂ (2.0383(6) and 2.0393(5) angstrom). The elongation of the Fe—N bonds is explained by the presence of an unpaired electron at an orbital with Fe—N antibonding character. Whereas the shortening of Fe⋅⋅⋅Cp_{c} distances are due to the absence of electrons in the Fe⋅⋅⋅C antibonding orbitals, unlike in the case of 2-NMe₂ (FIG. 30). This explanation was further supported by the presence and absence of spin density at the pyridyl nitrogen atoms and Cp carbon atoms, respectively. Additionally, the electron paramagnetic resonance (EPR) spectra of all the Fe^{III} complexes showed similar patterns, with pronounced ¹⁴N hyperfine splitting features (FIG. 34 d). This observation is consistent with the presence of spin density on the pyridyl nitrogen atoms, and bonding interactions between the Fe and N atoms. Therefore, 3-X are formal 19-electron, complexes.

To our surprise, two-electron oxidation of 1-H and 2-NMe₂ with two equivalents of AgSbF₆ formed S=0, Fe^{IV} complexes: 4-H and 4-NMe₂ (FIG. 34 c). Therefore, Fe^{III} complexes 3-X can be oxidized to Fe^{IV} at oxidation potentials near 0 V (FIG. 6b). In the crystals, 4-H and 4-NMe₂ exhibit short Fe—N distances of 2.0437(14) and 2.029(5) angstrom, respectively (FIG. 34 e). Fe⋅⋅⋅Cp_{c} distances of 4-H and 4-NMe₂ (1.732(3)-1.740(3) angstrom) are also slightly shorter than those of 3-H and 3-NMe₂, respectively. The short Fe—N and Fe⋅⋅⋅Cp_{c} distances induce significant twisting of the X-CpNCp ligands and increased bending of the Cp⋅⋅⋅Fe⋅⋅⋅Cp fragment. However, the η⁵-coordination mode of the Cp groups remains unchanged, supporting the 18-electron configuration of the Fe^{IV} complexes. Notably, oxidation of 2-NMe₂ with 1 equiv. [FeCp₂]PF₆ resulted in a mixture of the corresponding Fe^{III} and Fe^{IV} complexes, 3-NMe₂ and 4-NMe₂-PF₆, due to the combination of the low solubility of 4-NMe₂-PF₆ and the Fe^{III/IV} oxidation potential of 2-NMe₂ (−0.02 V vs. FeCp₂^{0/+}), which is lower than Fe^{II/III} oxidation potential of FeCp₂. The physical oxidation states of iron atoms in 3-H and 4-H were examined using ⁵⁷Fe Mossbauer spectroscopy, X-ray photoelectron spectroscopy (XPS), and SC-XRD. The ⁵⁷Fe Mossbauer spectra of 3-H and 4-H showed a progressive decrease in isomer shifts, 0.68 and 0.48 mm s⁻¹, respectively, consistent with the physical oxidation of iron atoms. Consistent with this observation, the XPS spectra of 1-H, 3-H, and 4-H showed an increase in Fe 2p_{3/2} binding energy from 707.6 through 708.4 to 709.0 eV upon oxidation. Finally, examination of C—C bond distances in the pyridine moieties of 1-H, 3-H, and 4-H showed no sign of oxidation of the pyridine groups. Altogether, these observations strongly support the physical Fe^{IV} oxidation states of 4-H and 4-NMe₂. Thus, the formation of the Fe—N bond expanse accessible oxidation state of ferrocene derivatives which are among the most versatile organometallic redox reagents⁶⁶. We expect this new redox chemistry of ferrocene derivatives will expand its use as redox mediator or catalyst.

1. A metallocene compound represented by formula (1): 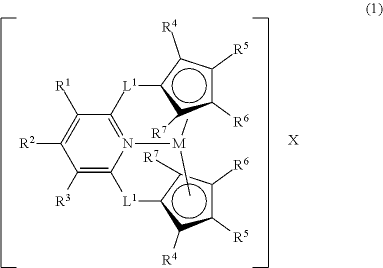
wherein,
R¹ to R⁷ are independently selected from a hydrogen atom, a halogen atom, a hydrocarbon group, and a heteroatom-containing group,
or any one of R⁴ to R⁷ attached to one of the two cyclopentadienyl rings and any one of R⁴ to R⁷ attached to the other cyclopentadienyl ring may together form a linking group,
or any adjacent two of R⁴ to R⁷ may form a ring together with the carbon atoms to which they are attached;
L¹ is a linking group;
M is selected from Co, Ni, and Fe; and
X is not present when M has an oxidation state of 2, and
X is a counter anion when M has an oxidation state of 3 or 4.

2. The metallocene compound according to claim 1 represented by formula (1-1): 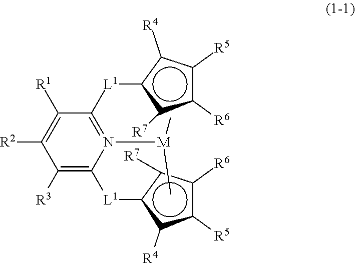
wherein,
R¹ to R⁷, L¹, and M are as defined in claim 1, and
M has an oxidation state of 2.

3. The metallocene compound according to claim 1 represented by formula (1-2): 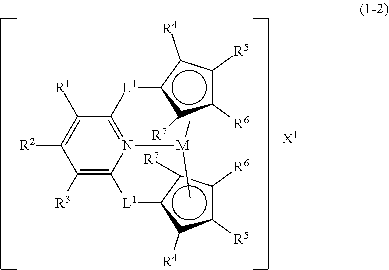
wherein,
R¹ to R⁷, L¹, and M are as defined in claim 1,
M has an oxidation state of 3,
and X¹ is An₁⁻ or ½An₂²⁻, wherein An₁⁻ is a monovalent anion and An₂²⁻ is a divalent anion.

4. The metallocene compound according to claim 1 represented by formula (1-3): 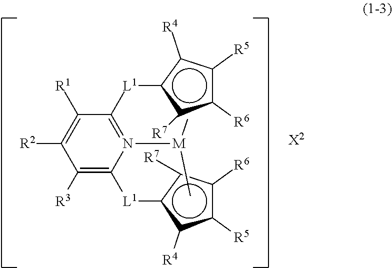
wherein,
R¹ to R⁷, L¹, and M are as defined in claim 1,
M has an oxidation state of 4,
and X² is 2An₁⁻ or An₂²⁻, wherein An₁⁻ is a monovalent anion and An₂²⁻ is a divalent anion.

5. The metallocene compound according to claim 1,
wherein each of R¹ and R³ is a hydrogen atom; and
R² is selected from a hydrogen atom, a halogen atom, a hydrocarbon group, and a heteroatom-containing group.

6. The metallocene compound according to claim 1,
wherein each of R⁴, R⁶, and R⁷ is hydrogen atom; and
R⁵ is independently selected from a hydrogen atom, a halogen atom, a hydrocarbon group, and a heteroatom-containing group.

7. The metallocene compound according to claim 1,
wherein each of R¹ to R⁷ is a hydrogen atom.

8. A catalyst comprising the metallocene compound according to claim 1.

9. An electron mediator comprising the metallocene compound according to claim 1.

10. An electrolyte for a redox flow battery comprising the metallocene compound according to claim 1.

11. A medicament comprising the metallocene compound according to claim 1 as an active ingredient.

12. A method for producing a metallocene compound comprising reacting a compound represented by formula (2) with a cyclopentadienyl salt represented by formula (3) to obtain a compound represented by formula (4), and then reacting the compound represented by formula (4) with a compound represented by formula (5) to obtain the metallocene compound represented by formula (1) as recited in claim 1, and wherein 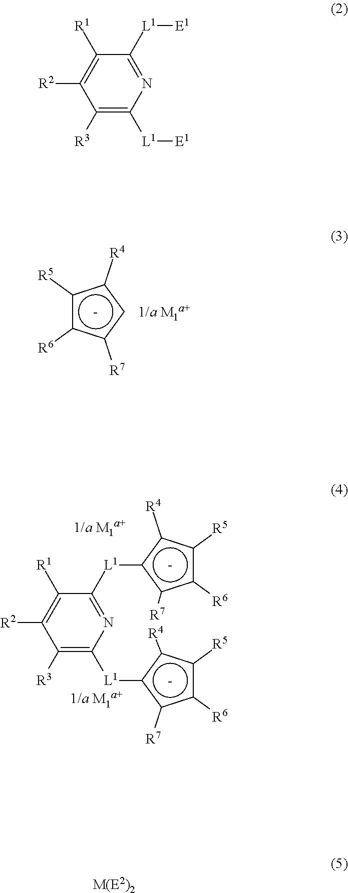
R¹ to R⁷ are independently selected from a hydrogen atom, a halogen atom, a hydrocarbon group, and a heteroatom-containing group;
M is selected from Co, Ni, and Fe;
E¹ is a leaving group;
M₁ is an alkaline metal or alkaline earth metal;
a is 1 when M₁ is an alkali metal, and 2 when M₁ is an alkaline earth metal; and
E² is a leaving group.

13. A metallocene compound represented by formula (1′): 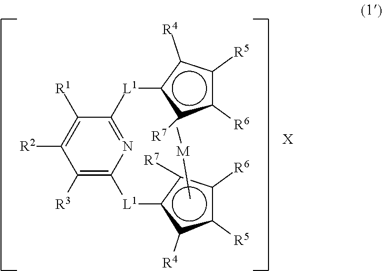
wherein,
R¹ to R⁷ are independently selected from a hydrogen atom, a halogen atom, a hydrocarbon group, and a heteroatom-containing group, or any one of R⁴ to R⁷ attached to one of the two cyclopentadienyl rings and any one of R⁴ to R⁷ attached to the other cyclopentadienyl ring may together form a linking group;
L¹ is a linking group;
M is selected from Co, Ni, and Fe; and
X is not present when M has an oxidation state of 2, and
X is a counter anion when M has an oxidation state of 3 or 4.
